(19) United States
(12) Patent Application Publication
(10) Pub. No.: US 2026/0147332 A1
(43) Pub. Date: May 28, 2026

(54) Artificial Intelligence System For Supporting Infrastructure Management Based On Heterogeneous Multimodal Input Data

(71) Applicant: Opal NexAI Inc., Marina Del Rey, CA (US)

(72) Inventors: Ryan Shahrouz Alimo, Loa Angeles, CA (US); Aniruddha Sanjay Kalkar, Loa Angeles, CA (US); Ehsan Asali, Athens, GA (US); Pranav Chaudhary, Marina Del Rey, CA (US); Debashish Jana, Marina Del Rey, CA (US); Maryam Hosseini, Marina Del Rey, CA (US); Sriram Narasimhan, Marina Del Rey, CA (US); Alison Ayumi Olmstead, Los Angeles, CA (US)

(21) Appl. No.: 19/365,110

(22) Filed: Oct. 21, 2025

Related U.S. Application Data
(60) Provisional application No. 63/709,794, filed on Oct. 21, 2024.
(60) Provisional application No. 63/815,026, filed on May 30, 2025.
(60) Provisional application No. 63/815,029, filed on May 30, 2025.

(51) Int. Cl. G05B 19/4155; G06V 10/762; G06V 10/86; G06V 20/56; G06V 20/58

(52) U.S. Cl. CPC G05B 19/4155; G06V 10/762; G06V 10/86; G06V 20/58; G06V 20/588; G05B 2219/40577

(57) ABSTRACT

Multimodal input data associated with a transportation network environment, including at least one of image data and light detection and ranging (LiDAR) data, is received. Based on an artificial intelligence (AI) component and the multimodal input data, at least one attribute set associated with at least one infrastructure asset within the transportation network environment is identified. Based on the at least one attribute set, output data associated with a multi-objective infrastructure management operation is generated. The output data is provided for display via a graphical user interface rendered by a computing device.

### CROSS-REFERENCE TO RELATED APPLICATION(S)

This application claims the benefit of U.S. Provisional Patent Application Ser. No. 63/709,794, filed Oct. 21, 2024, U.S. Provisional Patent Application Ser. No. 63/815,026, filed May 30, 2025, and U.S. Provisional Patent Application Ser. No. 63/815,029, filed May 30, 2025, the entire disclosure of each of which is hereby incorporated herein by reference.

### FIELD

This disclosure generally relates to artificial intelligence (AI)-based tools and, more specifically, to an AI system for infrastructure management support based on heterogeneous multimodal inputs.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an operating environment associated with an artificial intelligence (AI) system for supporting infrastructure management.

FIG. 2 is a block diagram of an example internal configuration of a computing device.

FIG. 3 is a block diagram of an example of an AI system for supporting infrastructure management.

FIG. 4 is a data flow diagram of an example process associated with AI-driven support for infrastructure management.

FIG. 5A, FIG. 5B, and FIG. 5C are flow diagrams of an example process associated with AI-driven support for infrastructure management.

FIG. 6 is a block diagram of another example of an AI system for supporting infrastructure management.

FIG. 7 is a data flow diagram of an example of an AI-based infrastructure mapping process associated with AI-driven support for infrastructure management.

FIG. 8 is a diagram of an example segmentation output associated with AI-driven support for infrastructure management.

FIG. 9 is a data flow diagram of an example of a process associated with AI-driven support for infrastructure management.

FIG. 10 is a diagram of an example associated with processing multimodal data associated with AI-driven support for infrastructure management.

FIG. 11 is a diagram of an example associated with AI-driven support for infrastructure management.

FIG. 12A, FIG. 12B, FIG. 12C, and FIG. 12D are diagrams showing examples of stress scenarios associated with AI-driven support for infrastructure management.

FIG. 13A, FIG. 13B, FIG. 13C, and FIG. 13D are diagrams showing examples of asset evaluation associated with AI-driven support for infrastructure management.

FIG. 14 is a diagram showing another example of asset evaluation associated with AI-driven support for infrastructure management.

FIG. 15A, FIG. 15B, FIG. 15C, and FIG. 15D are examples of a graphical user interface (GUI) provided by an AI system for supporting infrastructure management.

FIG. 16A, FIG. 16B, and FIG. 16C are examples of another GUI provided by an AI system for supporting infrastructure management.

FIG. 17A, FIG. 17B, and FIG. 17C are examples of another GUI provided by an AI system for supporting infrastructure management.

FIG. 18 is a flowchart of an example of a technique for AI-driven support for infrastructure management.

### DETAILED DESCRIPTION

The management and planning of urban transportation infrastructure rely on computer-implemented systems to handle the complexities of modern city environments. These systems often integrate diverse data sources, such as geographic information systems (GIS), traffic sensors, and asset databases, to support decision-making for maintenance, upgrades, and the implementation of initiatives such as Complete Streets, which promote multimodal accessibility and safety. However, existing computational tools face challenges in acquiring, processing, and analyzing the heterogeneous and large-scale data required for comprehensive infrastructure assessment. Dependence on disparate software platforms and data formats often leads to fragmented workflows, hindering the ability of current systems to provide a unified, real-time view of network conditions and performance.

Current computer-implemented approaches encounter specific technical hurdles in automatically and accurately characterizing infrastructure assets at the level of detail needed for effective planning and compliance verification. While image-based analysis using computer vision has advanced, these systems often struggle to extract precise geometric measurements (such as sidewalk cross-slopes, curb ramp dimensions, or pavement uplift heights) for engineering design and verifying compliance with standards such as the Americans with Disabilities Act (ADA). Conversely, systems relying solely on Light Detection and Ranging (LiDAR) data, while geometrically accurate, may lack the rich semantic context readily available in imagery, making it computationally difficult to interpret the function or condition of assets beyond their physical form. Integrating these multimodal data streams (e.g., LiDAR point clouds, panoramic imagery, video feeds, aerial data) poses computational challenges related to data alignment, fusion, and the scalable processing required for network-wide analysis.

Furthermore, existing software tools often lack the sophisticated analytical capabilities needed to support multi-objective infrastructure planning effectively. Computer systems may not adequately integrate assessments of physical asset condition with analyses of user experience factors, such as the Level of Traffic Stress (LTS) for pedestrians and cyclists, or with network-level importance metrics derived from topological analysis. Consequently, prioritizing capital improvements becomes reliant on simplified heuristics or manual review, failing to leverage computational optimization techniques that could maximize benefits across safety, accessibility, equity, and cost-effectiveness within defined budget constraints. The lack of integrated simulation or scenario modeling capabilities in many current systems also limits the ability of planners to computationally predict the impact of proposed infrastructure changes before implementation.

These technical limitations in current computer-implemented systems result in infrastructure management processes that may be inefficient, reactive, and sub-optimal. The difficulty in obtaining timely, accurate, and comprehensive data through automated computational means leads to reliance on outdated information or costly manual surveys. The inability of existing software to perform integrated, multi-objective analysis and optimization hinders strategic resource allocation, potentially leading to investments that do not yield the maximum possible improvements in safety, accessibility, or network performance. There is therefore a need for an improved computer-implemented system that overcomes these challenges by effectively integrating multimodal data acquisition, advanced AI-driven analysis for both geometric and semantic attributes, and sophisticated decision-support tools for optimized infrastructure planning and management.

The technical challenges related to assessing infrastructure deficiencies, such as substandard pavement quality, may have detrimental impacts. Poor road conditions, for example, may impose economic costs, such as those related to vehicle maintenance and accidents. The Pavement Condition Index (PCI) is a metric used to measure infrastructure quality, and distributions of PCI scores across a network may show significant variance, underscoring the variability in pavement quality that must be managed

Implementations of this disclosure address problems such as these by providing a computer-implemented system and method configured to receive and process diverse data inputs associated with transportation infrastructure, utilize artificial intelligence to extract detailed attributes of assets, generate insightful outputs for planning and management, and present these outputs to users. This approach overcomes limitations in prior systems related to fragmented data, insufficient detail in asset characterization, and inadequate analytical tools for multi-objective planning and optimization. The system integrates data acquisition, AI-driven analysis, and decision-support functionalities into a cohesive framework for managing transportation networks.

The system may be configured to receive multimodal input data. As used herein, “multimodal input data” may refer to data originating from multiple types of sensors or sources, capturing different aspects of the environment, such as geometric structure, visual appearance, or location. An example includes simultaneously collected LiDAR point clouds and camera images from a moving vehicle. In some implementations, the system may receive data sequentially from different sources or integrate sensor data with existing datasets such as aerial maps or crash records. This data is associated with a transportation network environment. As used herein, “transportation network environment” may refer to the physical and operational context of roadways, pathways, and associated infrastructure used for movement within a geographic area, including streets, sidewalks, bike lanes, intersections, and related assets. An example is an urban street grid with sidewalks, traffic signals, and bus stops. In some implementations, the transportation network environment may include rural road networks, highway systems, or specialized environments such as airport roadways or campus pathways.

Data acquisition may utilize a mobile mapping system, which, as used herein, may refer to a vehicle or platform equipped with sensors such as LiDAR, cameras, GNSS, and an IMU, configured to capture geospatial data while in motion. An example is a car with roof-mounted sensors driving city streets. Other implementations may use drones, backpack-mounted systems, or autonomous robots. As used herein, “autonomous robots” may refer to robotic devices capable of navigating and collecting sensor data within an environment with limited human intervention. Examples include sidewalk delivery robots or specialized inspection robots equipped with cameras or LiDAR. In some implementations, the system may use semi-autonomous drones or collaborative robotic swarms. Receiving data from diverse sources such as mobile mapping systems and autonomous robots addresses the challenge of acquiring comprehensive and up-to-date data across different parts of the network environment.

An artificial intelligence (AI) component may be used to identify at least one attribute set associated with at least one infrastructure asset from the multimodal input data. As used herein, an “AI component” may refer to one or more computational models, algorithms, or engines employing techniques such as machine learning, deep learning, or computer vision to perform tasks such as object recognition, segmentation, classification, or analysis. Examples include Vision Language Models (VLMs), convolutional neural networks (CNNs) for image segmentation, object detectors, or depth estimation models. In some implementations, the AI component may involve expert systems, reinforcement learning agents, or different neural network architectures. As used herein, an “attribute set” may refer to a collection of properties or characteristics identified for an infrastructure asset, describing its type, condition, dimensions, compliance status, or other features. An example for a sidewalk might include attributes for width, cross-slope, cracking severity, and obstruction presence. In some implementations, the attribute set may include attributes related to material composition, retroreflectivity, or maintenance history. As used herein, an “infrastructure asset” may refer to a physical component of the transportation network, such as a road segment, sidewalk, sign, signal, curb ramp, or bike lane. An example is a crosswalk at an intersection. In some implementations, an infrastructure asset might include street furniture, retaining walls, or drainage structures. The AI component may assess physical condition and compliance with predefined standards. This AI-driven identification facilitates detailed, consistent, and scalable extraction of asset attributes from complex sensor data.

The processing of LiDAR data may facilitate the extraction of precise geometric measurements. This extraction may be performed by applying specialized algorithms to LiDAR point clouds associated with an identified asset. For instance, a spatial clustering algorithm may group points belonging to a sidewalk slab; a plane fitting algorithm may determine the surface's orientation to calculate a running slope and a cross-slope; and a robust line fitting algorithm, such as one based on random sample consensus (RANSAC), may identify edges of the slab or an adjacent curb to determine its width, discarding outlier points. These extracted measurements provide quantitative data for verifying adherence to geometric tolerances defined in standards such as the ADA.

The system generates output data associated with a multi-objective infrastructure management operation based on the identified attribute sets. As used herein, “output data” may refer to processed information, analysis results, recommendations, or visualizations generated by the system. Examples include geography JavaScript object notation (GeoJSON) files containing asset attributes and locations, calculated LTS scores mapped to network segments, or ranked lists of proposed improvements. In some implementations, output data may involve reports, database records, or direct inputs for other planning software. As used herein, a “multi-objective infrastructure management operation” may refer to computational processes aimed at supporting decisions related to the maintenance, improvement, or planning of transportation infrastructure, considering multiple objectives such as safety, accessibility, cost-effectiveness, equity, and network efficiency. Examples include prioritizing sidewalk repairs based on condition, ADA compliance, and pedestrian volume, or allocating a budget to road resurfacing projects to maximize network-wide pavement condition improvement. In some implementations, the operation may focus on optimizing traffic signal timing for multiple modes or planning network expansions.

In some implementations, the system is further configured to emit a broad range of machine- and human-readable artefacts in addition to, or in place of, the default GeoJSON export. Illustrative examples include interactive diagrams, network-level heat-map tiles, optimization charts, tabular reports, comma-separated values (CSV) files, Portable Document Format (PDF) summaries, word-processing documents (e.g., DOCX), and raster or vector images such as JPEG, PNG, or SVG. Selecting the appropriate output modality may be automated by the tool layer based on downstream use-case metadata supplied via the interface component. For instance, a desktop GIS client might request GeoJSON, whereas a public-facing dashboard could request a pre-styled SVG schematic or chart bundle. This extensible output pipeline ensures that stakeholders receive the analytical results in the form that best supports their operational context.

Generating this output data may involve several analytical steps. An LTS score may be determined for network segments. As used herein, an “LTS score” may refer to a metric quantifying perceived comfort and safety for specific road users based on infrastructure characteristics and traffic conditions. An example is assigning a score from 1 (low stress) to 4 (high stress) to a street segment for cycling based on speed limit, lane count, and bike lane type. In some implementations, different scoring scales or additional factors may be used. A network importance score, which may be based on betweenness centrality, may be calculated. As used herein, a “network importance score” may refer to a metric quantifying the structural or functional significance of a node or edge within the transportation network topology. An example is calculating how often a road segment lies on shortest paths between pairs of locations in the network. Other implementations may generate scores based on traffic volume, connectivity degree, or proximity to services.

In some implementations, specific composite metrics may be generated to identify infrastructure that is both critical for connectivity and imposes high stress. For example, a composite score for a crosswalk (node) may be calculated as the average of associated sidewalk and bike lane LTS values, multiplied by the node's centrality score. For a sidewalk (edge), a composite metric may be calculated as the product of the sidewalk's LTS score and the corresponding Edge Betweenness Centrality (EBC) value. These composite metrics may facilitate the identification of candidates for upgrades.

These individual scores may be integrated to generate a composite prioritization score. An optimization analysis may be performed. As used herein, “optimization analysis” may refer to using mathematical algorithms to find a specific allocation of resources to achieve objectives subject to constraints. An example is determining a set of sidewalk repairs that yields a high benefit score without exceeding a total budget. Other implementations might involve heuristic optimization or simulation-based approaches. The system may generate data for scenario modeling. As used herein, “scenario modeling” may refer to simulating effects of potential infrastructure changes on metrics such as safety, accessibility, or traffic flow. An example is visualizing a predicted change in an LTS score if a road diet is implemented. Other implementations could involve agent-based modeling or microsimulation. The output may relate to user behavior analysis, near-miss incident detection, or resilience modeling.

In some implementations, the system may be configured to dynamically construct a knowledge graph to serve as a structured representation of the transportation network and its associated assets. The knowledge graph may integrate asset conditions and attributes, organizing extracted information from multimodal data sources into a relational structure. In some implementations, the system may be configured to construct a knowledge graph that encodes entities representing infrastructure assets, their extracted attribute sets, and derived performance metrics. These performance metrics may include, but are not limited to, Level of Traffic Stress (LTS) scores, network importance scores, and condition indices. This dynamic construction facilitates the organization and integration of diverse data, moving beyond simple data extraction to create an intelligent and searchable model of the infrastructure environment. The knowledge graph may be queried to generate a context-aware recommendation for infrastructure maintenance, hazard mitigation, or capital investment prioritization, among other examples.

The generated output data is provided for display via a graphical user interface (GUI) rendered by a computing device. As used herein, a “graphical user interface” may refer to a visual interface through which users may interact with the system's data and functionalities. Examples include interactive maps showing color-coded asset conditions, dashboards with summary charts, tables for asset management, or visual tools for designing and comparing scenarios. In some implementations, the GUI might involve voice interfaces, augmented reality displays, or integrations with existing GIS software dashboards. The GUI may include interactive maps, dashboards, asset management interfaces, or scenario modeling interfaces. In some implementations, an interactive chatbot may be configured to receive queries from a user using natural language. Providing analytical results through an intuitive GUI makes the insights accessible and actionable for planners and engineers.

To describe some implementations in greater detail, reference is first made to examples of hardware and software structures used to implement a system for AI-driven support for infrastructure management.

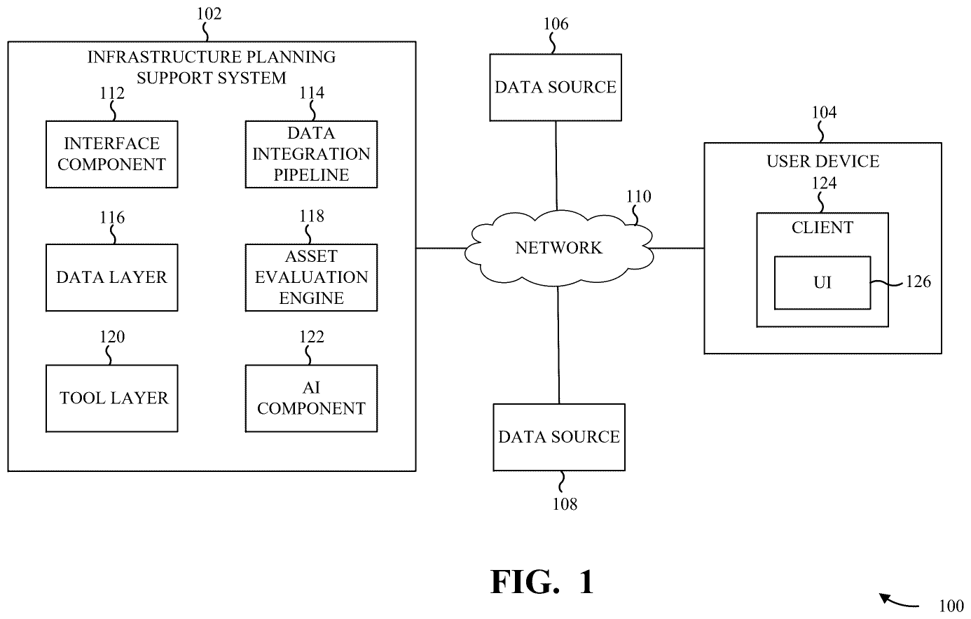

FIG. 1 is a block diagram of an example of an operating environment 100 associated with an AI system for supporting infrastructure management. The operating environment 100 may include an infrastructure planning support system 102, a user device 104, a data source 106, a data source 108, and a network 110. These components may interact to facilitate the collection, processing, analysis, and visualization of data related to transportation infrastructure assets.

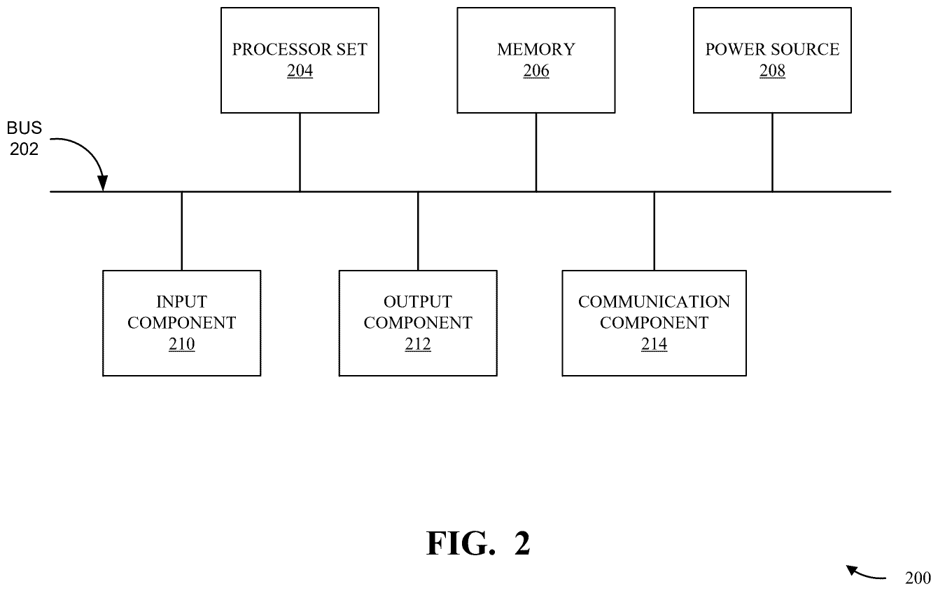

The infrastructure planning support system 102 may be configured as a central processing and analysis hub within the operating environment 100. The infrastructure planning support system 102 may be implemented as one or more servers, a cloud computing platform, or a distributed network of computing devices, such as the computing device 200 shown in FIG. 2. The infrastructure planning support system 102 may be configured to receive multimodal input data associated with a transportation network environment, the multimodal input data comprising at least one of image data and LiDAR data, from sources such as the data source 106 and the data source 108. The infrastructure planning support system 102 may utilize an AI component to identify attribute sets associated with infrastructure assets based on the received multimodal input data and generate output data associated with a multi-objective infrastructure management operation.

The infrastructure planning support system 102 may interact with other components in the operating environment 100. For example, the infrastructure planning support system 102 may communicate with the data source 106 and the data source 108 via the network 110 to receive input data. The infrastructure planning support system 102 may communicate with the user device 104 via the network 110, providing output data for display and receiving user requests or inputs. Internally, various components within the infrastructure planning support system 102, such as data pipelines, evaluation engines, and AI components, may interact to process data and generate planning insights.

In some implementations, the infrastructure planning support system 102 may be deployed entirely within a cloud computing environment, leveraging scalable resources for data storage and computation. For example, the infrastructure planning support system 102 may utilize cloud-based AI services and distributed databases. In some implementations, parts of the infrastructure planning support system 102 may operate on edge computing devices closer to the data sources, performing initial processing before transmitting data to a central system. In some implementations, the infrastructure planning support system 102 may be implemented as a dedicated hardware appliance or an on-premises server cluster within an organization's data center.

The user device 104 may be a computing device utilized by a user, such as a transportation planner or engineer, to interact with the infrastructure planning support system 102. The user device 104 may be, be similar to, include, or be included in various types of computing hardware, such as a desktop computer, a laptop computer, a tablet computer, or a smartphone, such as the computing device 200 shown in FIG. 2. The user device 104 may be configured to render a graphical user interface for displaying output data received from the infrastructure planning support system 102 and for accepting user input.

The user device 104 may interact with the infrastructure planning support system 102 via the network 110. The user device 104 may transmit user requests, such as queries for specific asset information or parameters for scenario modeling, to the infrastructure planning support system 102. In return, the user device 104 may receive output data, including analysis results, visualizations such as interactive maps or dashboards, and recommendations, from the infrastructure planning support system 102 for presentation to the user.

In some implementations, the user device 104 may execute a dedicated client application, such as a web browser or a native application, to facilitate communication with the infrastructure planning support system 102 and render the graphical user interface. For example, a web-based client application may run within a browser on the user device 104, providing access to the system's functionalities without requiring local installation. In some implementations, the user device 104 may possess local processing capabilities to perform certain tasks, such as preliminary data visualization or input validation, before communicating with the infrastructure planning support system 102.

The data source 106 represents a source from which the infrastructure planning support system 102 may obtain input data. The data source 106 may be, be similar to, include, or be included in various systems or repositories providing relevant information about the transportation network environment. This may include sensors, databases, or external services. The data source 106 may provide multimodal input data, which may include image data, LiDAR data, or other sensor readings. For example, the data source 106 may provide satellite imagery, aerial imagery, depth sensor measurements, RGB-D camera data, thermal camera data, or stereo camera data.

The data source 106 may interact with the infrastructure planning support system 102, such as via the network 110 or through direct data transfer mechanisms. The infrastructure planning support system 102 may request or receive data streams or batches from the data source 106 for processing and analysis. The data source 106 may be, be similar to, include, or be included in the data source 108.

In some implementations, the data source 106 may be a database containing existing GIS data, aerial imagery, traffic volume counts, crash records, or demographic information. In some implementations, the data source 106 may be a mobile mapping system, such as a vehicle equipped with LiDAR sensors and cameras, capturing detailed geospatial data of road infrastructure. In some implementations, the vehicle may be an autonomous vehicle or a semi-autonomous vehicle, traveling along a street collecting data on-the-fly. For example, the data source 106 could provide time-synchronized LiDAR point clouds and panoramic images collected during a survey drive. In some implementations, the data source 106 may be an autonomous robot, such as a sidewalk delivery robot, equipped with sensors capturing hyperlocal data about pedestrian pathways. In some implementations, the mobile mapping system may include a system such as a Kaarta Stencil Pro, which may be configured to utilize a LIDAR sensor, panoramic cameras, and a GNSS receiver to capture raw spatial data. The system may process this data, in some implementations, using a LOAM-derived algorithm.

In some implementations, data captured by autonomous robots, such as sidewalk delivery robots, may be referred to as a “sidewalk-level data capture modality”. This modality may involve capturing sensor data from a low-profile, ground-level perspective directly on pedestrian pathways, as opposed to data captured from a vehicle on the roadway. This approach may facilitate the acquisition of high-resolution data focused on pedestrian infrastructure. This sidewalk-level data capture modality may be valuable for filling gaps in pedestrian infrastructure data, especially in areas inaccessible to vehicles, and may provide sharp close-range detail to improve the verification of pedestrian clearways. In some implementations, data pre-processing within the data integration pipeline 114 may apply tighter alignment rules for data originating from slow-moving robots, as their lower operational speeds may, in at least some cases, contribute to GPS drift.

The data source 108 represents another source from which the infrastructure planning support system 102 may obtain input data. Similar to the data source 106, the data source 108 may be, be similar to, include, or be included in various systems providing transportation-related information. The data source 108 facilitates integration of information from multiple origins, and, in some implementations, offering complementary data types or covering different geographic areas or time periods compared to the data source 106. The data source 108 may interact with the infrastructure planning support system 102 via the network 110 or other data transfer methods, providing additional input data for the system's analysis. The data source 108 may be, be similar to, include, or be included in the data source 106.

In some implementations, if the data source 106 provides mobile mapping data, the data source 108 may provide access to publicly available datasets, such as OpenStreetMap data, census data, or official crash databases. For example, the data source 108 could be a government portal offering downloadable GIS layers of sidewalk geometries or traffic analysis zones. In some implementations, the data source 108 may represent a real-time data feed, such as live traffic camera streams or weather information services. In some implementations, the data source 108 may be a repository of historical maintenance records or asset condition reports.

In some implementations, the data source 108 may represent a third-party data partner, such as a commercial vendor or an operator of an autonomous fleet. For example, data may be received from mobile-street-mapping platforms operated by external partners, providing supplemental LiDAR and panoramic imagery to expand geographic coverage into new markets or cover streets not surveyed by a primary mapping vehicle. In some implementations, point clouds from such commercial vendors may be integrated into the data integration pipeline 114 following data format standardization.

In some implementations, the data source 108 may include cars, trucks, vans, buses, motorcycles, bikes, scooters, humans, drones, wheeled robots, legged robots or any number of other implementations of moving devices capable of collecting data. In some implementations, the data source 108 may include autonomous driving vehicles or robotaxis. These fleets may be equipped with sophisticated sensors and may provide continuous data capture, which may facilitate scaling data collection efforts and reduce the need for extensive ground runs by a primary data collection team. In some implementations, the data source 108 may include fixed sensor networks, such as traffic camera networks operated by a third party. Anonymized feeds from these cameras may be used to refine movement patterns or support dynamic Level of Traffic Stress (LTS) calculations, providing time-of-day context.

The usefulness of comprehensive data may extend to different temporal conditions. For example, stakeholder feedback from transportation professionals may indicate that sidewalk safety is a critical concern and that data collection must include nighttime data, as a significant number of accidents may occur after dark. Furthermore, the visibility of infrastructure assets, such as the reflectivity of crosswalk markings, may be a relevant attribute for assessing safety, particularly for nighttime visibility.

The network 110 may facilitate communication between the various components of the operating environment 100. The network 110 may be, be similar to, include, or be included in one or more interconnected networks, such as the internet, a local area network (LAN), a wide area network (WAN), a cellular network, or a combination thereof. The network 110 facilitates the transfer of data and commands between the infrastructure planning support system 102, the user device 104, the data source 106, and the data source 108.

The network 110 may serve as a communication backbone, which may facilitate the infrastructure planning support system 102 to ingest data from the data source 106 and the data source 108. It may facilitate the interaction between the user device 104 and the infrastructure planning support system 102, for users to send requests and receive analytical results and visualizations. In some implementations, the network 110 may utilize standard internet protocols (e.g., TCP/IP, HTTP/S) for communication between components. For example, the user device 104 might access the infrastructure planning support system 102 via a web browser over the internet. In some implementations, dedicated or private network links may be used, particularly for transferring large volumes of sensor data from the data source 106 or the data source 108 to the infrastructure planning support system 102. In some implementations, wireless communication technologies (e.g., 5G, Wi-Fi) may be employed, especially for mobile mapping systems or autonomous robots acting as data sources.

As shown in FIG. 1, the infrastructure planning support system 102 includes an interface component 112, a data integration pipeline 114, a data layer 116, an asset evaluation engine 118, a tool layer 120, and an AI component 122. In some implementations, two or more of the interface component 112, the data integration pipeline 114, the data layer 116, the asset evaluation engine 118, the tool layer 120, and the AI component 122 may be integrated into a single component. In some implementations, one or more of the interface component 112, the data integration pipeline 114, the data layer 116, the asset evaluation engine 118, the tool layer 120, and the AI component 122 may be implemented using any number of computing devices such as the computing device 200 shown in FIG. 2. For example, one or more of the interface component 112, the data integration pipeline 114, the data layer 116, the asset evaluation engine 118, the tool layer 120, and the AI component 122 may be distributed among a number of computing devices, which may operate in a cloud environment or as microservices.

The interface component 112 may be configured to manage communications between the infrastructure planning support system 102 and external entities. The interface component 112 may be implemented as a set of application programming interfaces (APIs), a web server frontend, or a message broker system, which may run on hardware similar to the computing device 200 shown in FIG. 2. The interface component 112 may be configured to receive requests from the user device 104 and route them to appropriate internal components, such as the asset evaluation engine 118 or the tool layer 120. It may be configured to receive incoming data streams or files from the data source 106 and the data source 108 and pass them to the data integration pipeline 114. Furthermore, the interface component 112 may format and transmit output data generated by the system back to the user device 104.

The interface component 112 may interact with the network 110 to communicate with the user device 104, the data source 106, and the data source 108. Internally, the interface component 112 may interact with the data integration pipeline 114 to initiate data processing, with the asset evaluation engine 118 and the tool layer 120 to forward analysis or planning requests, or with the data layer 116 to query status or retrieve results.

In some implementations, the interface component 112 may include authentication and authorization mechanisms to control access to the system's functionalities and data. For example, it might use API keys or user login credentials. In some implementations, the interface component 112 may provide different APIs tailored for different types of interactions, such as a REST API for user requests and a high-throughput data ingestion API for sensor data. In some implementations, the interface component 112 may include load balancing or request queuing features to manage high volumes of traffic.

The data integration pipeline 114 may be configured to process the raw multimodal input data received from the data source 106 and the data source 108. The data integration pipeline 114 may be implemented as a series of software modules or services, and may be orchestrated using workflow management tools and executing on computing resources like the computing device 200 shown in FIG. 2. Its functions may include data cleaning, such as removing noise or errors, standardization, such as converting data to consistent formats and units, synchronization, such as aligning data from different sensors based on timestamps, and fusion, such as combining information from multiple modalities, e.g., projecting camera image data onto LiDAR point clouds. The data integration pipeline 114 receives multimodal input data associated with a transportation network environment.

The data integration pipeline 114 may receive raw data forwarded by the interface component 112, originating from the data source 106 and the data source 108. The data integration pipeline 114 provides the processed, cleaned, and integrated data to the data layer 116 for storage and subsequent access by other components.

In some implementations, the data integration pipeline 114 may perform geo-referencing or coordinate transformations to have all data aligned within a common spatial framework. For example, it might apply LiDAR Odometry and Mapping (LOAM) algorithms or use RTK corrections for precise positioning. For example, a LOAM algorithm may be configured to minimize drift and computational complexity by utilizing two integrated processes. A high-frequency odometry algorithm may be used to estimate LiDAR velocity with coarse accuracy, while a low-frequency mapping process performs fine alignment of the point cloud data for precise registration. This combination may facilitate the efficient processing of large datasets and support near real-time mapping, correcting for motion-induced distortions without relying solely on high-accuracy inertial measurements.

In some implementations, a LiDAR Simultaneous Localization and Mapping (SLAM) routine derived from LOAM may be applied within the data integration pipeline 114. This routine may be configured to match edge features and plane features between consecutive LiDAR sweeps to calculate a rigid-body transform for every time step. This transform matrix may then be fused with RTK fixes from a GNSS receiver. This fusion process may facilitate the generation of a globally referenced point cloud, for example, in State Plane meter coordinates. This approach may be used to maintain accumulated drift below a predefined threshold, such as 5 centimeters over multi-kilometer runs, and to provide that the resulting point cloud aligns accurately with external survey benchmarks or aerial orthophotos.

In some implementations, the data integration pipeline 114 may perform preliminary feature extraction or data reduction, such as downsampling point clouds or extracting frames from video, before storing the data in the data layer 116. In some implementations, the data integration pipeline 114 may operate as a batch process for historical data or as a real-time stream processing system for live sensor feeds.

In some implementations, particularly when scaling operations to multiple geographic regions or integrating data from third-party fleets, the data integration pipeline 114 may be configured for auto-scaling. This may involve launching pre-processing tasks in parallel to manage an exponential increase in raw data files from diverse sources. This architecture may facilitate the efficient integration of data from multiple roaming crews or partner fleets, reducing the time required to process large-scale datasets.

An auto-scaling configuration may involve dynamically allocating computational resources, such as virtual machines or processing containers, based on the volume of incoming data. For example, as multiple partner fleets upload data batches concurrently, the system may automatically provision a separate instance of the data integration pipeline 114 for each batch. These instances may then operate in parallel to perform the necessary pre-processing tasks, which may include data cleaning, standardization, geo-referencing, and sensor fusion. This parallel execution may prevent ingestion bottlenecks and provide that the large-scale, heterogeneous data is processed and stored in the data layer 116 in a timely manner, rather than being queued serially.

The data layer 116 may serve as a central repository for storing various types of data within the infrastructure planning support system 102. The data layer 116 may be implemented using one or more database technologies, file systems, or data warehousing solutions, hosted on persistent storage associated with computing resources like the computing device 200 shown in FIG. 2. It may store raw input data, data processed by the data integration pipeline 114, attribute sets identified by the AI component 122, results generated by the asset evaluation engine 118 and the tool layer 120, and metadata and configuration information. The output data may be formatted as at least one Geography JavaScript Object Notation (GeoJSON) file stored in the data layer 116.

The data layer 116 may interact with multiple components. It may receive processed data from the data integration pipeline 114. It may provide data to the asset evaluation engine 118, the tool layer 120, and the AI component 122 for analysis and processing. The data layer 116 may store the results and outputs generated by these components. The interface component 112 may interact with the data layer 116, for example, to retrieve data requested by the user device 104.

In some implementations, the data layer 116 may utilize a spatial database capable of efficiently storing and querying geo-referenced data such as point clouds, trajectories, and asset locations. For example, PostgreSQL with PostGIS extensions could be used. In some implementations, the data layer 116 may employ a data lake architecture to store large volumes of raw sensor data alongside structured analytical results. In some implementations, the data layer 116 may include indexing mechanisms optimized for spatial and temporal queries to facilitate efficient data retrieval.

The asset evaluation engine 118 may be configured to perform specific analyses on the infrastructure assets based on their identified attributes. The asset evaluation engine 118 may be implemented as a collection of software modules or algorithms, which may run on computing resources like the computing device 200 shown in FIG. 2. The asset evaluation engine 118 may be configured to identify, based on an AI component and the multimodal input data, at least one attribute set associated with at least one infrastructure asset. It may calculate condition scores, assess compliance with standards, using attributes including precise geometric measurements, calculate LTS scores, determine network importance scores, e.g., using betweenness centrality, or generate composite prioritization scores by combining multiple factors. The asset evaluation engine 118 generates output data associated with a multi-objective infrastructure management operation.

The asset evaluation engine 118 may retrieve attribute data for infrastructure assets from the data layer 116 or directly from the AI component 122. The results generated by the asset evaluation engine 118, such as scores or compliance status, may be stored back into the data layer 116 or passed to the tool layer 120 for further use in planning operations.

In some implementations, the asset evaluation engine 118 may implement specific, published methodologies for calculating metrics like LTS scores or PCIs. For example, it might follow LADOT procedures for LTS calculation, and may be enhanced with additional factors identified by the AI component 122. In some implementations, the asset evaluation engine 118 may incorporate rule engines to evaluate compliance based on extracted attributes and predefined standards, e.g., ADA slope and width requirements. In some implementations, the asset evaluation engine 118 may use graph algorithms to calculate network importance scores based on topology data stored in the data layer 116.

The tool layer 120 may encompass higher-level planning and decision-support functionalities built upon the data and evaluations provided by other components. The tool layer 120 may include software modules for optimization, simulation, scenario modeling, or reporting, executing on computing resources like the computing device 200 shown in FIG. 2. It may be configured to generate output data associated with a multi-objective infrastructure management operation, such as generating recommendations for capital improvements or simulating the impact of design changes.

The tool layer 120 may receive inputs such as asset conditions, prioritization scores, and network data from the data layer 116 and the asset evaluation engine 118. The outputs of the tool layer 120, such as optimized budget allocations, scenario simulation results, or generated reports, may be stored in the data layer 116 or sent via the interface component 112 to the user device 104.

In some implementations, the tool layer 120 may include an optimization engine configured to perform an optimization analysis, for example, using Mixed-Integer Linear Programming (MILP) to generate a ranked list of recommended capital improvements based on composite scores and budget constraints. In some implementations, the tool layer 120 may include a simulation module for generating data for simulating scenarios representing potential changes, e.g., adding a bike lane, and determining the impact on metrics like LTS or safety. In some implementations, the tool layer 120 may include functionalities for user behavior analysis, near-miss incident detection, emergency response enhancement, or resilience modeling.

In some implementations, the tool layer 120 may incorporate analyses related to crash severity and environmental hazards. The system may be configured to process historical crash data, joining fatality and injury counts to specific road segments. This data may inform safety analyses and be used within the optimization analysis with an objective to minimize crash severity across the network. Furthermore, the tool layer 120 may assess route-level risks based on vulnerability to catastrophic events. For example, road segments, such as hillside streets, may be rated based on hazard levels associated with natural events, including, but not limited to, landslides from earthquakes or rainfall, or wildfire threats.

In some implementations, the multi-objective optimization performed by the tool layer 120 may be configured to maximize the overall well-being of the population in a specific area. Equity factors may be integrated into the determination of a road segment's “importance,” which may then be fused with traffic stress (e.g., LTS) metrics to create a composite score used in an optimization formulation, such as an MILP model. The tool layer 120 may also support adaptive weighting models for the asset scoring system. These models may be configured to account for demographic data, pedestrian traffic volume, and equity considerations to provide that the resulting scores accurately reflect the most pressing accessibility needs. In some implementations, the tool layer 120 may utilize deep learning frameworks to prioritize resilient and equitable road retrofitting. This analysis may be used to minimize travel disruption and welfare loss for low-income commuters, for example, when managing risks such as earthquake-induced landslides.

The tool layer 120 may be configured to execute graph-based reasoning and querying operations on the knowledge graph. These operations may be used to infer hidden relationships between assets, detect systemic vulnerabilities (such as identifying critical assets that, if failing, would disproportionately impact accessibility), and identify high-impact intervention targets across the transportation network. For example, a graph-based inference operation may identify all non-compliant curb ramps that provide the sole access to essential services for a neighborhood with a high Social Vulnerability Index.

In some implementations, the tool layer 120 may leverage the dynamic construction of a knowledge graph to enhance emergency management capabilities. The knowledge graph, alongside simulation models, may be used to estimate emergency response effectiveness or enhance resilience to events such as wildfires through predictive simulations. This approach may facilitate the analysis of network vulnerabilities and the optimization of response strategies based on a comprehensive, integrated representation of the transportation network and its assets.

The AI component 122 may represent the artificial intelligence capabilities of the infrastructure planning support system 102. The AI component 122 may be implemented as one or more machine learning models, deep learning networks, or other AI algorithms, hosted on specialized hardware, such as GPUs or TPUs, or general computing resources like the computing device 200 shown in FIG. 2. The AI component 122 is used for identifying, based on the multimodal input data, at least one attribute set associated with at least one infrastructure asset. This may involve tasks like image segmentation, object detection, depth estimation, and vision language model (VLM)-based analysis for determining contextual attributes or assessing condition and compliance. In some implementations, the AI component 122 may include any number of different types of models including, for example, computer vision models, 3D reconstruction & mapping models, tracking & motion analysis models, geospatial alignment & registration models, anomaly/condition assessment models, multi-modal fusion models, action-event recognition models, surface defect and texture analysis models, optical character recognition (OCR) models, sign text models, symbol recognition models, 3D point cloud segmentation models, classification models, topological graph understanding models, or scene understanding models, among other examples.

The AI component 122 may receive processed multimodal input data from the data integration pipeline 114 or retrieve data stored in the data layer 116. The output of the AI component 122, comprising identified attribute sets, including features, classifications, condition assessments, compliance status, and geometric measurements, may be provided to the asset evaluation engine 118 for further analysis or stored in the data layer 116.

In some implementations, the AI component 122 may include a VLM, e.g., Gemini, configured via prompt engineering or fine-tuning for transportation asset analysis. For example, the VLM might analyze an image of a curb ramp and, guided by a prompt including ADA standards, assess its compliance attributes. In some implementations, the AI component 122 may utilize RAG to dynamically access and incorporate external knowledge, e.g., updated regulations, into its analysis. In some implementations, the AI component 122 may include separate CV models for specific tasks, such as a Mask2Former model for semantic segmentation of street scenes and a YOLO model for detecting signs or pavement markings.

In some implementations, a strategy of dynamic contextual augmentation may be used to mitigate biases or false positives in VLM classification. This may involve refining prompt engineering through multi-stage reasoning and incorporating auxiliary metadata into the model's reasoning framework. This auxiliary metadata may include, but is not limited to, the time of day or weather conditions at the time of data capture. This additional context may facilitate the AI component's ability to disambiguate complex visual cues.

As shown in FIG. 1, the user device 104 includes a client 124. In some implementations, the client 124 may be integrated with other components of the user device 104. In some implementations, the client 124 may be implemented using any number of computing devices such as the computing device 200 shown in FIG. 2.

The client 124 may be a software application executing on the user device 104. The client 124 may be, be similar to, include, or be included in applications such as a web browser, a native mobile app, or a desktop GIS application extension, utilizing resources described in connection with the computing device 200 shown in FIG. 2. The client 124 is configured to facilitate interaction between the user and the infrastructure planning support system 102. It may send user requests to the system and receive and render the output data provided by the system. The client 124 renders the graphical user interface.

The client 124 may interact with the interface component 112 of the infrastructure planning support system 102 via the network 110. It may receive output data from the infrastructure planning support system 102 and passes it to the UI 126 for display. It may capture user input via the UI 126 and transmit corresponding requests to the infrastructure planning support system 102.

In some implementations, the client 124 may be a thin client, primarily configured for rendering the UI 126 and relaying interactions, with most processing occurring on the infrastructure planning support system 102. For example, a web browser acts as a client by rendering HTML and executing JavaScript received from a server. In some implementations, the client 124 may be a thick client with more local processing capabilities, caching data or performing some analysis locally on the user device 104. In some implementations, the client 124 may integrate directly with other software on the user device 104, such as GIS or CAD tools.

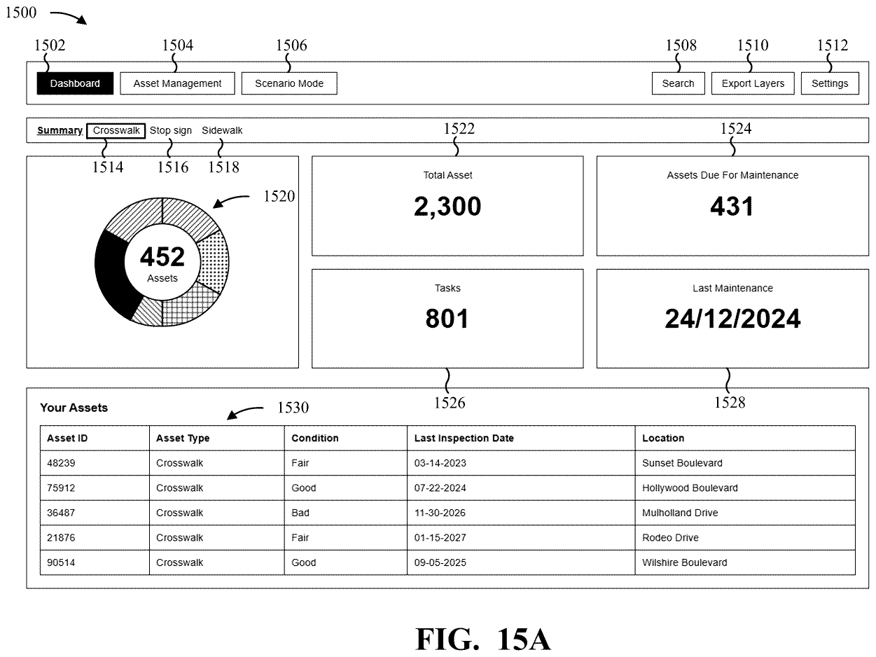

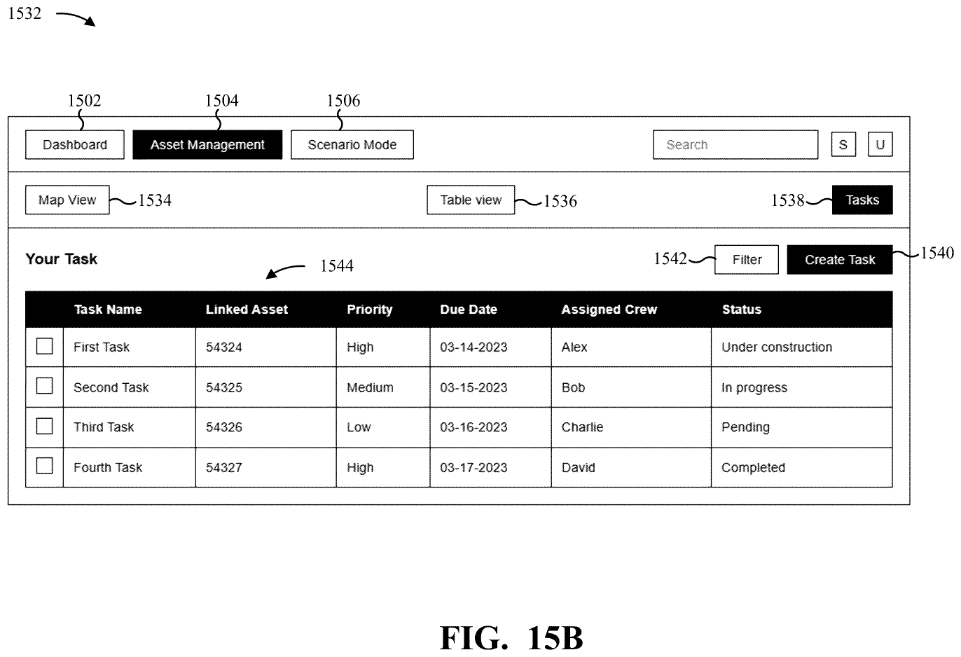

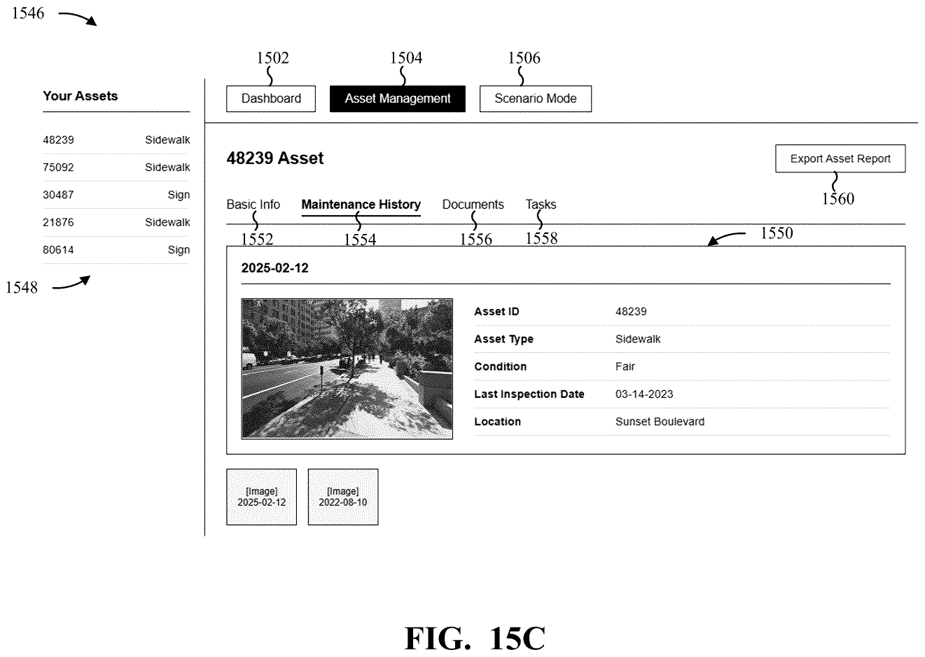

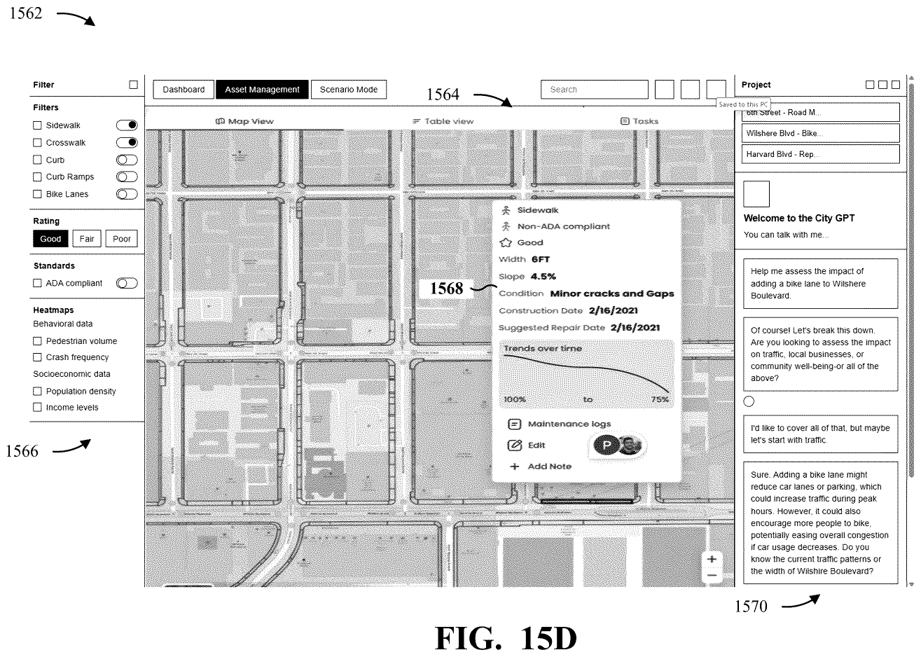

As shown in FIG. 1, the client 124 includes a UI 126. In some implementations, the UI 126 may be integrated with other components of the client 124 or the user device 104. In some implementations, the UI 126 may be implemented using any number of computing devices such as the computing device 200 shown in FIG. 2. The UI 126 is the graphical user interface rendered by the client 124 on the user device 104. The UI 126 provides the visual means for the user to interact with the system, view data, and access functionalities. It provides the output data for display. Examples of the UI 126 may be, be similar to, include, or be included in the interfaces shown in FIG. 15A through FIG. 17C. The UI 126 may interact directly with the client 124, receiving data to display and capturing user actions, e.g., clicks, text input, to be processed by the client 124 or sent to the infrastructure planning support system 102.

In some implementations, the UI 126 may include an interactive map component for visualizing geospatial data, which may facilitate users to pan, zoom, and query assets displayed on the map. For example, assets might be color-coded based on condition or compliance status. In some implementations, the UI 126 may include a dashboard presenting performance indicators and summary statistics through charts and graphs. In some implementations, the UI 126 may include interfaces for scenario modeling, which may facilitate users to visually define infrastructure changes and see simulated impacts. In some implementations, the graphical user interface includes an interactive chatbot configured to receive user queries and provide information based on the output data. In some implementations, the dashboard may be configured to track the operational status and location of multiple data collection crews or sensor kits, including partner or third-party fleets, to coordinate large-scale mapping efforts across different regions.

In operation, the infrastructure planning support system 102 may receive multimodal input data from the data source 106 and the data source 108 via the network 110. The data integration pipeline 114 may process this data, storing it in the data layer 116. The AI component 122 may analyze data from the data layer 116 to identify attribute sets for infrastructure assets. The asset evaluation engine 118 may use these attributes to calculate scores and assess conditions or compliance, storing results in the data layer 116. The tool layer 120 may use these evaluations and scores to perform optimization or simulation, generating planning outputs stored in the data layer 116. The user device 104, via the client 124 and the UI 126, may send requests through the network 110 to the interface component 112, which retrieves relevant output data, which may be processed by the asset evaluation engine 118 or the tool layer 120 from the data layer 116, and sends it back for display on the UI 126.

FIG. 2 is a block diagram of an example internal configuration of a computing device 200 configured to perform functions described herein. The computing device 200 may be, be similar to, include, or be included in an apparatus for performing one or more methods, processes, algorithms, operations, tasks, and/or techniques, as described herein. The computing device 200 may be, be similar to, include, or be included in, the operating environment 100 shown in FIG. 1, among other examples. The computing device 200 includes a bus 202 that interconnects various components or units, such as a processor set 204, a memory 206, a power source 208, an input component 210, an output component 212, and a communication component 214, among other examples. One or more of the memory 206, the power source 208, the input component 210, the output component 212, or the communication component 214 can communicate with the processor set 204 via the bus 202.

The processor set 204 may be a central processing unit, such as a microprocessor, and may include single or multiple processors having single or multiple processing cores. The processor set 204 may include another type of device, or multiple devices, configured for manipulating or processing information. For example, the processor set 204 may include multiple processors interconnected in one or more manners, including hardwired or networked. The operations of the processor set 204 may be distributed across multiple devices or units that can be coupled directly or across a local area or other suitable type of network. The processor set 204 may include a cache, or cache memory, for local storage of operating data or instructions. The processor set 204 is implemented in hardware, firmware, or a combination of hardware and software. In some implementations, the processor set 204 includes one or more processors capable of being programmed to perform a function.

The processor set 204 may include one or more chiplets, chips, system-on-chips (SoCs), network-on-chips (NoCs), chipsets, packages, or devices that individually or collectively constitute or include the processor set. The processor set may include a processor (or “processing”) circuitry in the form of one or multiple processors, microprocessors, processing units (such as CPUs), GPUs, neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor set”).

One or more of the processors of the processor set 204 may be individually or collectively configurable or configured to perform various operations described herein. In some implementations, a single processor may perform all of the operations described as being performed by the one or more processors. In some implementations, a group of processors collectively configurable or configured to perform a set of operations may include a first set of (one or more) processors configurable or configured to perform a first operation of the set and a second processor configurable or configured to perform a second operation of the set, or may include the group of processors all being configured or configurable to perform the set of operations. The first set of processors and the second set of processors may be the same set of processors or may be different sets of processors.

The memory 206 includes one or more memory components, which may each be volatile memory or non-volatile memory, that individually or collectively constitute a memory system. The memory system may include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory,” “the memory system,” or “the memory circuitry”). The memory 206 may include non-transitory memory, transitory memory, or a combination thereof. Volatile memory may include RAM (e.g., a dynamic RAM (DRAM) module, such as a double data rate (DDR) synchronous DRAM (SDRAM)). Non-volatile memory may include a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices. The memory 206 may be referred to as one or more computer-readable media. A computer-readable medium may include any storage unit (or multiple storage units) that store data or instructions that are readable by a processing system. A computer-readable medium may include, for example, at least one of a data repository, a data storage unit, a computer memory, a hard drive, a disk, or a random access memory.

One or more of the memories may be coupled (for example, operatively coupled, communicatively coupled, electronically coupled, or electrically coupled) with one or more of the processors of the processor set 204 and may individually or collectively store processor-executable instructions (e.g., code such as software) that, when executed by one or more of the processors, may configure or otherwise cause one or more of the processors to perform various functions or operations described herein. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise.

In some implementations, the executable instructions may include application data or an operating system, among other examples. The executable instructions may include one or more application programs, which may be loaded or copied, in whole or in part, from non-volatile memory to volatile memory to be executed by the processor set 204. For example, the executable instructions may include instructions for performing techniques described in this disclosure. In some implementations, the application data may include functional programs, such as computational programs, analytical programs, or database programs, among other examples. The operating system may be, for example, Microsoft Windows®, Mac OS X®, or Linux®; an operating system for a mobile device, such as a smartphone or tablet device; or an operating system for a non-mobile device, such as a mainframe computer.

Reference to “one or more memories” should be understood to refer to any one or more memories of a corresponding device, such as the memory described in connection with FIG. 2. For example, operation described as being performed by, or data described as being stored on, one or more memories can be performed by, or stored on, respectively, the same subset of the one or more memories or different subsets of the one or more memories. Additionally or alternatively, in some examples, one or more of the processors may be preconfigured to perform various functions or operations described herein without requiring configuration by software. For example, the memory 206 may include data or instructions that are hard-wired into the processing system.

In the description herein, language describing a system, an apparatus, or a device as taking an action (such as performing, determining, initiating, receiving, calculating, deciding, computing, processing, etc.) is to be understood as describing that some appropriate component of the system, apparatus, or device is taking the action. As used herein, the term “component” is intended to be broadly construed as hardware and/or a combination of hardware and software.

An “engine” refers to a component constructed, programmed, configured, or otherwise adapted to perform a specific function or set of functions. The term engine as used herein means a tangible device, component, or arrangement of components implemented using hardware, such as by an ASIC or field-programmable gate array (FPGA), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. As used herein, the term “model” encompasses its plain and ordinary meaning. A model may include, among other things, one or more engines which receive an input and compute an output based on the input.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a GPS location unit. In some examples, the peripheral devices may include a temperature sensor for measuring temperatures of components of the computing device 200, such as the processor set 204.

The communication component 214 may include an interface for facilitating a connection or link to a network. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 can communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

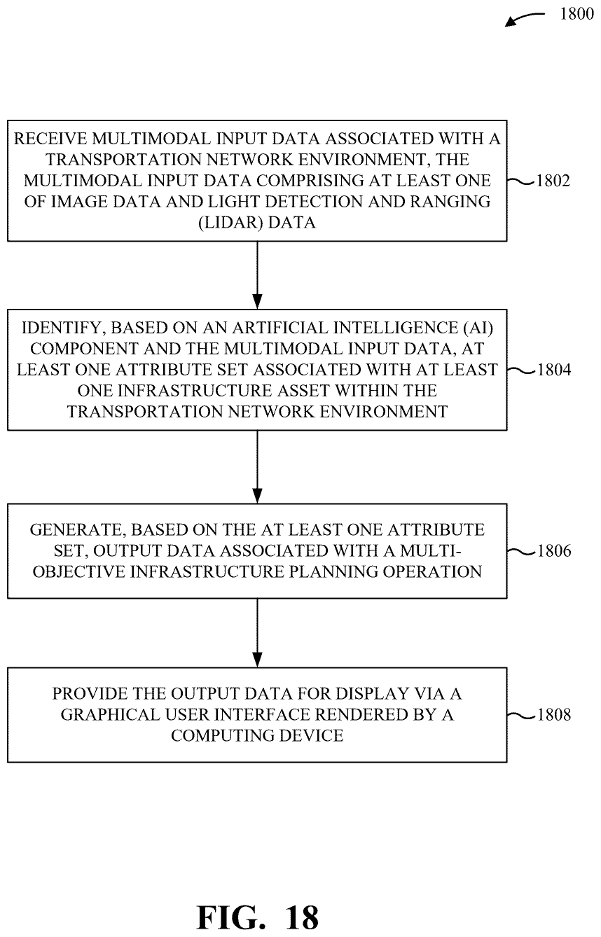

The processor set 204 may implement one or more techniques or perform one or more operations associated with AI-driven support for infrastructure management, as described in more detail elsewhere herein. For example, the processor set 204 may perform or direct operations of, for example, technique 1800 of FIG. 18 or other techniques as described herein (alone or in conjunction with one or more other processors). The memory 206 may store data and program codes for the computing device 200. In some examples, the memory 206 may include a non-transitory computer-readable medium storing a set of instructions (for example, code or program code). The memory 206 may include one or more memories, such as a single memory or multiple different memories (of the same type or of different types). For example, the set of instructions, when executed (for example, directly, or after compiling, converting, or interpreting) by the processor set 204, may cause the processor to cause the computing device 200 to perform technique 1800 of FIG. 18 or other techniques as described herein. In some examples, executing instructions may include running the instructions, converting the instructions, compiling the instructions, and/or interpreting the instructions, among other examples.

The number and arrangement of components shown in FIG. 2 are provided as an example. The computing device 200 may include additional components, fewer components, different components, or differently arranged components than those shown in FIG. 2. Additionally, or alternatively, a set of components (e.g., one or more components) of the computing device 200 may perform one or more functions described as being performed by another set of components of the computing device 200.

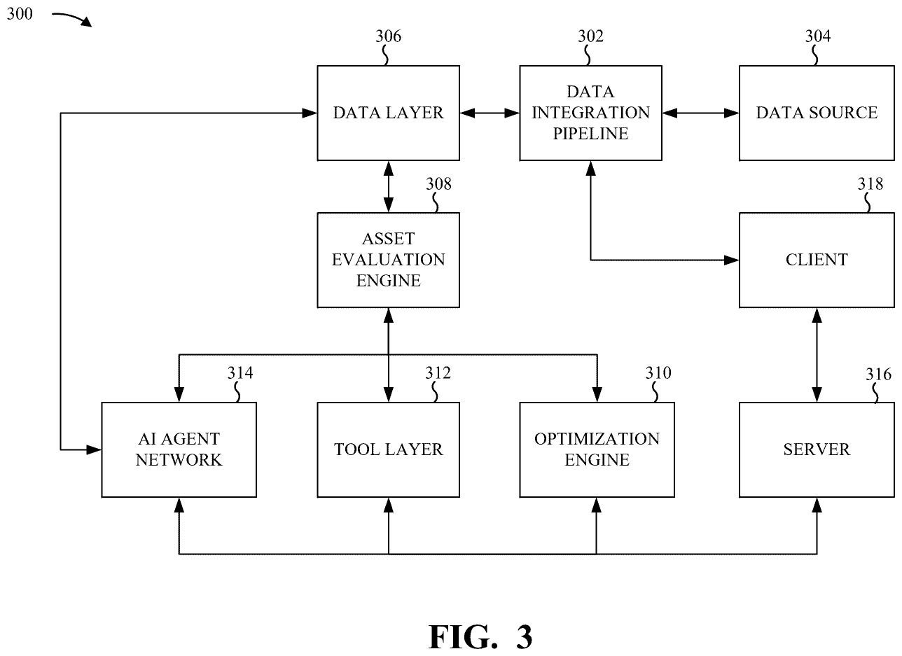

FIG. 3 is a block diagram of an example of an AI system 300 for supporting infrastructure management. The AI system 300 may be, be similar to, include, or be included in the infrastructure planning support system 102 shown in FIG. 1. The AI system 300 includes a data integration pipeline 302, a data source 304, a data layer 306, an asset evaluation engine 308, an optimization engine 310, a tool layer 312, an AI agent network 314, a server 316, and a client 318. These components may operate collaboratively to receive multimodal input data, process and analyze the data using AI techniques, facilitate infrastructure planning operations, and interact with users or other systems.

The data integration pipeline 302 may be configured to receive, process, and consolidate multimodal input data from various sources. The data integration pipeline 302 may be, be similar to, include, or be included in the data integration pipeline 114 shown in FIG. 1. It may be implemented using software modules, running within a cloud environment or on dedicated servers like the computing device 200 shown in FIG. 2, designed for data transformation, cleaning, standardization, and fusion. The data integration pipeline 302 may be configured to handle heterogeneous data types, including image data, LiDAR point clouds, GIS data, and sensor readings, preparing them for storage and analysis within the AI system 300.

The data integration pipeline 302 may receive raw or partially processed data from the data source 304. It may perform operations such as noise filtering on LiDAR data, correcting image distortions, synchronizing data streams based on timestamps, performing coordinate transformations, and fusing data modalities, e.g., projecting image pixels onto LiDAR points. The processed and integrated data may then be forwarded to the data layer 306 for persistent storage and access by other components, such as the asset evaluation engine 308.

In some implementations, the data integration pipeline 302 may utilize parallel processing techniques or distributed computing frameworks, e.g., Apache Spark, to handle large volumes of input data efficiently. For example, processing terabytes of mobile mapping data may involve distributing tasks across multiple computing nodes. In some implementations, the data integration pipeline 302 may incorporate data validation checks to have the quality and integrity of the input data verified before it enters the analytical stages. This might include checking for missing values, verifying coordinate system consistency, or identifying sensor anomalies.

The data source 304 represents an origin for the multimodal input data processed by the AI system 300. The data source 304 may be, be similar to, include, or be included in the data source 106 or the data source 108 shown in FIG. 1. It may encompass a wide range of systems, sensors, or repositories, such as mobile mapping systems, including vehicles or autonomous robots equipped with LiDAR and cameras, dashboard cameras, aerial imaging platforms (e.g., drones, satellites), fixed sensors (e.g., traffic cameras), existing databases (e.g., GIS repositories, government open data portals like Geohub LA, crash databases, census data), or real-time data feeds. The data source 304 provides the raw or foundational information upon which the infrastructure assessment and planning operations are based.

The data source 304 may interact directly with the data integration pipeline 302, transmitting data streams or batches for processing. This interaction might occur over a network connection, similar to the network 110 in FIG. 1, or via physical media transfer depending on the nature and location of the data source 304. The data provided by the data source 304 constitutes the multimodal input data associated with the transportation network environment.

In some implementations, the data source 304 may be a fleet of vehicles equipped with sensors, continually, periodically, or in response to a trigger event collecting data as they traverse the transportation network. For example, autonomous delivery vehicles or municipal service vehicles could act as mobile data collection platforms. In some implementations, the data source 304 may be an Application Programming Interface (API) providing access to third-party data services, such as real-time traffic conditions or weather data. In some implementations, multiple distinct data sources may feed into the data integration pipeline 302, requiring sophisticated fusion techniques.

The data layer 306 may function as a centralized repository for storing and managing all relevant data within the AI system 300. The data layer 306 may be, be similar to, include, or be included in the data layer 116 shown in FIG. 1. It may be implemented using databases, such as spatial databases like PostGIS, data lakes, file systems, or cloud storage solutions, supported by hardware like the computing device 200 shown in FIG. 2. The data layer 306 stores raw input data, processed data from the data integration pipeline 302, attribute sets identified for infrastructure assets, analysis results, e.g., condition scores, LTS scores, compliance assessments, outputs from the optimization engine 310, and models or configurations used by the AI agent network 314. Output data may be stored as GeoJSON files within the data layer 306.

The data layer 306 may serve as an intermediary, interacting with multiple components within the AI system 300. It receives processed data from the data integration pipeline 302. It provides data inputs to the asset evaluation engine 308, the optimization engine 310, the tool layer 312, and the AI agent network 314. Results generated by these components may be stored back into the data layer 306. The data layer 306 may provide data to the server 316 for delivery to the client 318.

In some implementations, the data layer 306 may incorporate version control mechanisms to track changes in infrastructure data over time. For example, it might store historical snapshots of asset conditions or network topology. In some implementations, the data layer 306 may implement robust indexing strategies, e.g., spatial R-trees, temporal indexing, to facilitate efficient querying and retrieval of large datasets based on location, time, or asset attributes. Data governance policies and access control mechanisms might be managed within or applied to the data layer 306.

In some implementations, road importance and impact may be governed by specific equity-related factors. These factors may include, but are not limited to, the mode of transportation used, accessibility, the age and income of affected populations, a Social Vulnerability Index (SVI), or job sectors. The system may also be configured to incorporate data related to legislation to identify the locations of disadvantaged and low-income communities. This data may be used to provide additional consideration for walkability and alternative transportation modes in those areas.

To enrich decision-support capability, the system may dynamically construct, store in the data layer 306, and maintain a transportation-network knowledge graph that semantically links each identified infrastructure asset, its extracted attribute set, and derived performance metrics. The derived performance metrics may include, without limitation, LTS scores, network-importance values, or condition indices. The knowledge graph serves as a unifying data fabric that enables relational reasoning across otherwise disjoint multimodal sources, thereby exposing interdependencies among roadway, sidewalk, and crosswalk elements, supporting inference of latent asset conditions, and facilitating adaptive prioritization during capital-improvement planning.

The asset evaluation engine 308 may be configured to analyze the processed data to assess the characteristics and condition of infrastructure assets. The asset evaluation engine 308 may be, be similar to, include, or be included in the asset evaluation engine 118 shown in FIG. 1. It may include software modules implementing algorithms for calculating condition scores, evaluating compliance against standards, e.g., ADA, estimating metrics such as LTS, determining network importance, and generating composite scores for prioritization, executing on hardware like the computing device 200 shown in FIG. 2. The asset evaluation engine 308 transforms raw attributes into meaningful assessments for planning.

The asset evaluation engine 308 retrieves processed data, including identified asset attribute sets, from the data layer 306. It may receive inputs or parameters from the AI agent network 314 or the tool layer 312. The outputs of the asset evaluation engine 308, such as calculated scores, e.g., condition, compliance, LTS, importance, composite, may be stored back into the data layer 306 and may be utilized by the optimization engine 310 or presented to the user via the client 318 through the server 316.

In some implementations, the asset evaluation engine 308 may utilize machine learning models, which may be part of the AI agent network 314, trained to predict asset degradation rates or remaining service life based on current condition attributes. For example, a model could predict pavement deterioration based on cracking patterns and traffic volume. In some implementations, the asset evaluation engine 308 may dynamically adjust scoring weights based on user-defined priorities or equity considerations derived from demographic data accessible via the data layer 306. The asset evaluation engine 308 might prioritize assets in underserved neighborhoods even if their physical condition score is marginally better than assets elsewhere.

The optimization engine 310 may be configured to perform optimization analyses to support decision-making in infrastructure management, particularly regarding resource allocation. The optimization engine 310 may be, be similar to, include, or be included in functionalities within the tool layer 120 shown in FIG. 1. It may be implemented using mathematical optimization solvers, e.g., MILP solvers like Gurobi or CPLEX, or heuristic algorithms, e.g., genetic algorithms, running on computing resources such as the computing device 200 shown in FIG. 2. The optimization engine 310 may find optimal or near-optimal solutions for allocating limited budgets to capital improvement projects based on defined objectives, e.g., maximizing network benefit, minimizing risk, and constraints. Performing an optimization analysis may generate a ranked list of recommended capital improvements.

The optimization engine 310 may retrieve data from the data layer 306, including asset condition scores, prioritization metrics, composite scores from the asset evaluation engine 308, project costs, or budget constraints, among other examples. It may interact with the tool layer 312 to incorporate outputs from scenario modeling or other planning tools. The results of the optimization, such as recommended project lists or budget allocations, may be stored in the data layer 306 and may be presented to the user via the server 316 and client 318.

In some implementations, the optimization engine 310 may support multi-objective optimization, facilitating users to explore trade-offs between competing goals like maximizing safety improvements versus minimizing costs. For example, it might generate a Pareto front of non-dominated solutions. In some implementations, the optimization engine 310 may incorporate uncertainty or risk analysis, considering factors like the probability of asset failure or the variability in project costs. Stochastic optimization techniques could be employed in such cases.

For example, the optimization engine 310 may implement a sequential MILP optimizer that incorporates expert feedback. In each iteration the optimizer proposes a candidate set of infrastructure upgrades that satisfy budget constraints B and maximize a multi-objective score f(x). A domain expert assigns a preference ranking P to the candidate. The system then updates the optimization weight vector w using a Bayesian preference-learning algorithm and resolves the MILP with w′, generating a new candidate until convergence of P or attainment of a termination threshold.

For example, the optimization engine 310 may implement a sequential MILP optimizer that incorporates expert feedback. In each iteration, the optimizer proposes a candidate set of infrastructure upgrades that satisfy budget constraints B and maximize a multi-objective score f(x). A domain expert assigns a preference ranking P to the candidate. The system may then update the optimization weight vector w using a Bayesian preference-learning algorithm and resolve the MILP with w′, generating a new candidate until convergence of P or attainment of a termination threshold. In managing a transportation network environment, allocation of limited budgets may be performed to maximize network performance. Some implementations include a sequential optimization framework that integrates human expert feedback into an optimal road budget allocation process. This approach may be based on an MILP model for road network upgrades and may extend the model with a feedback loop to capture factors such as local context, community sentiment, or strategic priorities. The objective may be to maximize the benefit of the transportation network by prioritizing roads that have high network importance scores and high traffic stress. Constraints may include a budget limit, representing a total available budget for road improvements or maintenance, and a minimum or maximum allocation, for example, constraints on amounts that may be allocated to individual roads. To facilitate comparison, network importance scores and traffic stress values may be normalized to a common scale, for example, from 0 to 1. This operation may account for differences in measurement scales and facilitate aggregation. A composite score may be determined for each road that reflects both network importance and traffic stress. A weighted sum approach may be implemented, where weights are assigned based on a relative priority of importance versus traffic stress. The weights may be selected by a decision maker. For example, a weight of 0.5 may be selected to provide the same weight to the importance and the level of traffic stress. The composite score for each road i may combine its normalized importance and traffic stress values using a weighted sum.

For example, to facilitate comparison, network importance scores and traffic stress values may be normalized to a common scale, for example, from 0 to 1. This operation accounts for differences in measurement scales and facilitates aggregation:

$$Normalized {Importance}_{i} = \frac{Importance {Value}_{i} - Min Importance}{Max Importance - Min Importance}$$

$$and$$

$$Normalized Traffic {Stress}_{i} = \frac{Traffic Stress {Value}_{i} - Min Stress}{Max Stress - Min Stress}$$

A composite score may be determined for each road that reflects both network importance and traffic stress. A weighted sum approach may be implemented, where weights are assigned based on the relative priority of importance versus traffic stress. The weights may be selected by a decision maker. For example, a weight of 0.5 may be selected to provide the same weightage to the importance and the level of traffic stress. The composite score for each road i may combine its normalized importance and traffic stress values using a weighted sum:

$$Composite {Score}_{i} = ( w \times Normalized {Importance}_{i} ) + ( ( 1 - w ) \times Normalized Traffic {Stress}_{i} ) ,$$

where, w=weight for importance (e.g., 0.7), 1−w=weight for traffic stress (e.g., 0.3), Normalized Importance ᵢ=Normalized importance value for road i, and Normalized Traffic Stress ¿=Normalized traffic stress value for road i. The underlying MILP model determines the optimal set of upgrades (maintenance or construction) for each road and each user type (pedestrian, cyclist, motorist) under regional and city-wide budget constraints. The components of the model may include indices and sets such as i∈I: roads; j∈J: regions; u∈U: road user types, where U={pedestrian, cyclist, motorist}; and m∈M: upgrade methods, where M={maintenance, construction}. Each road i may be associated with a region j(i)∈J. The parameters may include sᵢ: composite score for road i (combining normalized importance and traffic stress); c_{i,u,m}: cost of applying upgrade m for user u on road i; Bⱼ: budget allocated to region j; and B: total city-wide budget, with Σ_{j∈j}Bⱼ≤B.

The model may include the following decision variables:
X_{i,u,m}∈{0,1}: Equals 1 if upgrade m is applied for user u on road i; 0 otherwise; and
yᵢ∈{0,1}: Equals 1 if at least one upgrade is performed on road i; 0 otherwise.
   An objective function, designed to maximize the overall benefit of the network may be expressed as:
   Maximize Z=Σ_{i∈I}sᵢsᵢyᵢ,
   and this function may be subject to a number of constraints such as:
1. Regional Budget Constraints:

$${\sum }_{i : j ( i ) = j} {\sum }_{u ∈ U} {\sum }_{m ∈ M} {c}_{i , u , m} {X}_{i , u , m} \leq {B}_{j} ∀ j ∈ J$$

2. City-Wide Budget Constraint:

$${\sum }_{j ∈ J} {\sum }_{i : j ( i ) = j} {\sum }_{u ∈ U} {\sum }_{m ∈ M} {c}_{i , u , m} {X}_{i , u , m} \leq B$$

3. Mutual Exclusivity for Upgrades:

$${X}_{i , u , maintenance} + {X}_{i , u , construction} \leq 1 ∀ i ∈ I , ∀ u ∈ U$$

4. Linking Road-Level Decision Variable:

$${y}_{i} \leq {\sum }_{u ∈ U} {\sum }_{m ∈ M} {X}_{i , u , m} ∀ i ∈ I$$

$${\sum }_{u ∈ U} {\sum }_{m ∈ M} {X}_{i , u , m} \leq 6 {y}_{i} ∀ i ∈ I$$

To incorporate expert judgment on the allocation of budgets across regions, for example, to address unquantified factors, a sequential optimization procedure may include a number of operations. A first operation may include generation of candidate regional budget allocations. For example, given the fixed total budget B, the procedure involves generating a set of candidate allocations

$$\{ {B}_{j}^{t} \}$$

for each region j in iteration t. These candidates reflect different possible splits of the overall budget across regions. For each candidate set

$$\{ {B}_{j}^{t} \} ,$$

the procedure involves solving the MILP formulation described above. Each solution yields a candidate decision vector

$$\{ {X}_{i , u , m}^{t} , {y}_{i}^{t} \}$$

and the corresponding optimal objective value Z^{t}.

The procure may include presenting the candidate solutions, along with the regional budget allocations and corresponding network upgrade decisions, to a human expert. The expert may assess each solution based on factors not captured in the MILP (e.g., local political considerations, emergency routes, or community impact) and provide feedback in the form of a score or ranking. The system may use a Learning-to-Rank approach or a large language model or small language model to process the expert feedback. This model may be configured to learn the expert's implicit preferences and adjust an auxiliary preference function P({Bⱼ}) that reflects the desirability of a candidate regional allocation. The process may be iterated, generating new candidate allocations, solving the MILP, collecting expert feedback, and updating the preference function P({Bⱼ}). With each iteration, the system gradually learns to predict the expert's preferences. Once the preference model stabilizes, the system can autonomously generate and select regional budget allocations that align with both the quantitative metrics and the expert's qualitative insights.

The sequential optimization with a human-in-the-loop feedback loop may facilitate the integration of expert judgment into a quantitative framework. This may be performed by learning from expert feedback, which accounts for factors the MILP model may not include. The feedback loop may provide for continual improvement, so the model adapts to changing priorities and contextual nuances over time. The approach may provide a decision-making process where experts may observe and influence allocation outcomes. Once trained, the integrated model may operate with a degree of autonomy, offering decisions that reflect both quantitative analysis and expert insights. This sequential optimization methodology presents a framework for addressing complexities of budget allocation in road network management. By combining an MILP foundation with an adaptive human-in-the-loop component, the model may be suited to navigate both quantifiable and qualitative challenges inherent in decision-making. Following this systematic approach, decision-makers may allocate budgets to roads that provide a high overall benefit to the network. This may facilitate efficient use of resources, improved network performance, and enhanced resilience to traffic stress. Regular updates and monitoring may further refine the process, providing for long-term sustainability and adaptability to changing conditions.
In some implementations, a “weakest-link” aggregation may be employed when generating a route-level risk score. In this configuration, the risk value assigned to a candidate route equals the maximum risk value among the constituent roadway segments forming the route. This ensures that a single high-risk segment dominates the route score, reflecting real-world cyclist or pedestrian behaviour where avoidance of any dangerous segment is paramount

The tool layer 312 represents a suite of functionalities that support various aspects of infrastructure planning and analysis beyond basic asset evaluation and optimization. The tool layer 312 may be, be similar to, include, or be included in the tool layer 120 shown in FIG. 1. It may include modules for scenario modeling, simulation, reporting, user behavior analysis, near-miss detection, emergency response planning, or resilience analysis, implemented as software components running on hardware like the computing device 200 shown in FIG. 2. The tool layer 312 provides advanced analytical capabilities that leverage the data and assessments generated by other parts of the AI system 300.

The tool layer 312 may interact extensively with the data layer 306, retrieving data for analysis and storing results. It may receive inputs from the asset evaluation engine 308, e.g., condition scores to use in simulations, and provide inputs to or receive outputs from the optimization engine 310, e.g., simulating the impact of an optimized plan. The tool layer 312 may interact with the AI agent network 314, utilizing AI models for predictive analysis or simulation tasks. Outputs from the tool layer 312 may be visualized or made available to the user via the server 316 and client 318.

In some implementations, the tool layer 312 may include a scenario modeling module that facilitates users to define hypothetical changes to the infrastructure, e.g., adding bike lanes, changing signal timing, and simulates the potential impacts on traffic flow, safety metrics, e.g., predicted crash rates, or LTS scores. For example, a traffic microsimulation tool could be integrated. In some implementations, the tool layer 312 may include tools for analyzing sensor data, such as from the data source 304, to detect near-miss incidents between vehicles, cyclists, or pedestrians, providing insights into high-risk locations not captured by crash data alone.

The AI agent network 314 represents the collection of AI models and components used throughout the AI system 300 for various analysis and prediction tasks. The AI agent network 314 may be, be similar to, include, or be included in the AI component 122 shown in FIG. 1. This may include VLMs, CV models, e.g., segmentation, detection, depth, LLMs, predictive models, and may include specialized agents for tasks like reasoning or simulation, utilizing hardware like GPUs or TPUs within computing devices like the computing device 200 shown in FIG. 2. The AI agent network 314 provides the intelligence for extracting attributes, assessing conditions, making predictions, and interacting with users.

The AI agent network 314 interacts heavily with the data layer 306, retrieving input data, e.g., images, LiDAR, attributes, for processing and storing model outputs or derived features. It provides identified attribute sets and initial assessments to the asset evaluation engine 308. Models within the AI agent network 314 might be invoked by the tool layer 312 for tasks like prediction within simulations. In some implementations including a chatbot, the AI agent network 314 may process user queries and generate responses delivered via the server 316 and client 318.

In some implementations, the AI agent network 314 may include models trained or fine-tuned for identifying transportation infrastructure assets and their defects from multimodal sensor data. For example, a CNN might be trained to detect and classify different types of pavement cracks from images. In some implementations, the AI agent network 314 may incorporate models capable of performing predictive analytics, such as forecasting future asset deterioration or predicting crash probabilities based on infrastructure attributes and historical data.

In some implementations the AI agent network 314 includes a retrieval-augmented compliance engine configured to dynamically obtain external regulatory guidance at inference-time. The compliance engine may be configured to crawl authoritative sources (e.g., the latest U.S. Department of Transportation (DOT) Manual on Uniform Traffic Control Devices (MUTCD) or the ADA Accessibility Guidelines (ADAAG)) and store text passages within a vector database. Given an attribute set for an infrastructure asset, the retrieval-augmented compliance engine may execute a semantic similarity search over the vector database, retrieve the k most relevant passages, and supply them as additional context to a large-language-model (LLM) or VLM prompt. The combined context may provide a mechanism by which the LLM/VLM can reason over current rules and provide a compliance determination that automatically reflects the most recent regulatory updates.

In some implementations, the AI agent network 314 may implement a compliance engine using model context protocol (MCP) or an API. MCP is a standard for integrating external services into AI systems, enabling applications to invoke methods of those services via an API. It is designed to be language- and platform-agnostic, allowing for integration with any service. For example, the compliance engine might invoke methods of external services related to ADA compliance. An API enables the MCP implementation to access and invoke an external service and receives the corresponding response. The API may translate the MCP response into machine code for execution. In some implementations, other techniques for invoking external services might be implemented.

The regulatory database may be refreshed according to a predefined schedule (e.g., nightly) or triggered by detected publication changes. In some implementations, the compliance engine uses an Approximate-Nearest-Neighbors (ANN) algorithm to identify the k most relevant passages for each asset attribute. For example, the search may use an ANN over 768-dimensional sentence embeddings generated by a model such as Sentence-BERT. Caching of frequent queries and passage rankings may improve performance and reduce latency.

The server 316 may act as an intermediary between the components of the AI system 300 and the client 318. The server 316 may be, be similar to, include, or be included in functionalities within the interface component 112 shown in FIG. 1. It could be implemented as one or more application servers, web servers, or API gateways, running on hardware such as the computing device 200 shown in FIG. 2. The server 316 may handle requests from the client 318, orchestrate interactions with backend components, e.g., the data layer 306, the asset evaluation engine 308, the optimization engine 310, the tool layer 312, and the AI agent network 314, format responses, and manage user sessions and authentication.

The server 316 communicates with the client 318, such as over a network like the network 110 in FIG. 1, receiving requests and sending back data or interface updates. It interacts with the various backend engines and layers to fulfill client requests, retrieving data, initiating analyses, or triggering operations.

In some implementations, the server 316 may host a web application backend, serving HTML, CSS, JavaScript, and data APIs to a browser-based client 318. For example, it might use frameworks like Node.js, Django, or Flask. In some implementations, the server 316 may expose a set of RESTful APIs that the client 318 consumes to interact with the system's functionalities. Security functions, like handling user logins and enforcing access controls based on roles or permissions, may reside within the server 316.

The client 318 represents the user-facing application or interface through which users interact with the AI system 300. The client 318 may be, be similar to, include, or be included in the client 124 shown in FIG. 1, running on a user device 104. It could be a web application running in a browser, a standalone desktop application, a mobile app, or a plugin for existing GIS software, utilizing resources of a device like the computing device 200 shown in FIG. 2. The client 318 is configured for rendering the graphical user interface, accepting user input, and communicating with the server 316 to retrieve data and initiate actions.

The client 318 interacts primarily with the server 316 over a network. It sends user-generated requests, e.g., panning a map, submitting a query, defining a scenario, to the server 316 and receives data, e.g., map tiles, asset details, analysis results, from the server 316 to display to the user through its rendered GUI.

In some implementations, the client 318 may be a feature-rich web application built with modern JavaScript frameworks, e.g., React, Angular, or Vue.js, utilizing mapping libraries, e.g., Mapbox GL JS or Leaflet, to provide interactive visualizations of geospatial data. For example, it could display assets on a map, facilitate users to click on them to view details, and provide tools for filtering or querying data. In some implementations, the client 318 might incorporate sophisticated data visualization components for displaying charts, dashboards, and scenario comparison interfaces. It could include the interface for interacting with an AI chatbot, which may be integrated with the AI agent network 314 via the server 316.

In operation, a user might interact with the client 318, e.g., a web application. The client 318 sends requests to the server 316. The server 316 orchestrates the required actions, which may involve querying the data layer 306, invoking the asset evaluation engine 308, running the optimization engine 310, utilizing tools from the tool layer 312, or engaging the AI agent network 314. Data might initially come from the data source 304, processed by the data integration pipeline 302, and stored in the data layer 306. Results are passed back through the server 316 to the client 318 for display. For example, a user could request an optimization analysis; the client 318 sends the request to the server 316, which triggers the optimization engine 310 using data from the data layer 306, which may be scored by the asset evaluation engine 308, and the resulting ranked list is sent back to the client 318 for display.

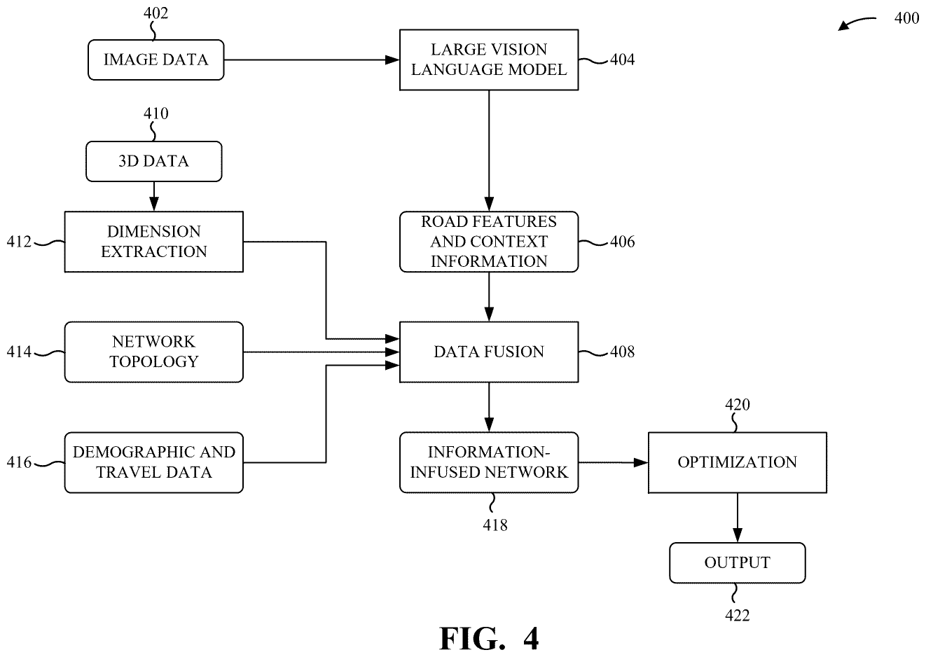

FIG. 4 is a data flow diagram of an example process 400 associated with AI-driven support for infrastructure management. The process 400 illustrates the flow of data and the transformations performed by various components, within systems like the infrastructure planning support system 102 shown in FIG. 1 or the AI system 300 shown in FIG. 3, to generate outputs for infrastructure planning and management. The process 400 may begin with receiving various forms of input data, including image data 402 and 3D data 410, processing this data through AI models and extraction techniques, fusing it with contextual information like network topology 414 and demographic and travel data 416, and ultimately performing an optimization 420 to generate the output 422.

The image data 402 represents visual information captured from the transportation network environment. The image data 402 may be, be similar to, include, or be included in the multimodal input data received by the processor set. The image data 402 may be obtained from various sources, such as cameras integrated into a mobile mapping system, similar to the data source 106 or the data source 304, or from other repositories like aerial imaging platforms or traffic monitoring cameras. The image data 402 provides semantic context about infrastructure assets and their surroundings.

The image data 402 may serve as an input to AI components, such as the large vision language model 404, for identifying infrastructure assets and determining their attributes. For example, the image data 402 may depict sidewalks, crosswalks, street signs, pavement markings, and their visual condition. The image data 402 may be processed by computer vision models for tasks like segmentation or object detection prior to or in conjunction with analysis by the large vision language model 404.

In some implementations, the image data 402 may include panoramic images, standard perspective images, video frames, or thermal images. For instance, panoramic images captured by a mobile mapping system provide a 360-degree view, while video frames facilitate temporal analysis. In some implementations, the image data 402 may be pre-processed, such as by a data integration pipeline, to enhance quality, correct distortions, or extract relevant frames before being fed into the large vision language model 404.

The large vision language model 404 represents an AI component configured to process and interpret both visual and textual information. The large vision language model 404 may be, be similar to, include, or be included in the AI component 122 shown in FIG. 1 or the AI agent network 314 shown in FIG. 3. This model may be based on architectures such as Google's Gemini or OpenAI's GPT-4σ, capable of understanding complex scenes depicted in the image data 402 and extracting relevant features or context based on prompts or internal training. The large vision language model 404 may be used in identifying attribute sets associated with infrastructure assets.

The large vision language model 404 receives the image data 402 as input. Based on this input, and, in some cases, guided by specific prompts or incorporating external knowledge, e.g., via RAG, the large vision language model 404 generates road features and context information 406. This output represents the identified attributes of infrastructure assets depicted in the image data 402, such as asset type, condition assessment, or compliance-related features.

In some implementations, the large vision language model 404 may be fine-tuned on datasets specific to transportation infrastructure to improve its accuracy in identifying relevant assets and attributes. For example, the large vision language model 404 might be trained to recognize different types of crosswalk markings or ADA-compliant curb ramp features. In some implementations, the large vision language model 404 may interact with other AI components, such as segmentation models providing object masks, to focus its analysis on specific regions within the image data 402.

The road features and context information 406 represent the structured data output generated by the large vision language model 404. This data structure encapsulates the identified attribute sets associated with infrastructure assets within the transportation network environment, derived from the analysis of the image data 402. The road features and context information 406 may include details about asset type, e.g., sidewalk, sign, condition, e.g., ‘good’, ‘fair’, ‘poor’, presence of cracks, compliance status, e.g., ADA compliant/non-compliant, and other contextual details observed in the imagery.

The road features and context information 406 serve as an input to the data fusion 408 process. The road features and context information 406 provides the semantic understanding extracted from visual data, which is then integrated with geometric data from the dimension extraction 412 and other contextual data sources such as the network topology 414 and the demographic and travel data 416.

In some implementations, the road features and context information 406 may be represented in a standardized format like JSON or GeoJSON, associating attributes with specific asset instances identified in the image data 402. For example, a JSON object might describe a detected crosswalk, including its type, marking condition, surface condition, and the presence of accessible pedestrian signals (APS). In some implementations, this data structure may include confidence scores provided by the large vision language model 404 for its classifications or assessments.

The data fusion 408 represents the operation where information from multiple sources is integrated to create a unified and enriched representation of the transportation network. This operation may be performed by software modules within the infrastructure planning support system 102 or the AI system 300, possibly utilizing database operations, spatial joins, or algorithmic integration techniques on hardware like the computing device 200 shown in FIG. 2. The data fusion 408 operation combines the semantic information derived from imagery (e.g., the road features and context information 406), geometric measurements from the dimension extraction 412 based on the 3D data 410, network structure from the network topology 414, and socio-economic or travel patterns from the demographic and travel data 416.

In some implementations, the data fusion 408 operation may represent the process of populating or updating the knowledge graph. This involves performing semantic integration, where extracted and enriched features, such as sidewalk condition assessments, are intelligently linked to a topological network graph, which may be derived from sources such as OpenStreetMap. This association explicitly links identified assets to specific road segments or intersections within the knowledge graph, which in turn facilitates powerful network-based analytical capabilities, including, but not limited to, sophisticated route planning, connectivity analysis, or detailed accessibility modeling.

The data fusion 408 operation receives inputs from multiple streams: the road features and context information 406, the dimension extraction 412, the network topology 414, and the demographic and travel data 416. The output of the data fusion 408 operation is the information-infused network 418, which represents a comprehensive dataset integrating these diverse aspects. In some implementations, the data fusion 408 operation may involve spatially joining asset attributes from 406 and 412 to corresponding segments or nodes in the network topology 414. For example, sidewalk condition attributes could be linked to specific road centerline segments. In some implementations, the data fusion 408 may involve aggregating data, such as calculating average asset conditions or total pedestrian volumes within specific geographic zones defined by the demographic and travel data 416.

In some implementations, the data fusion 408 operation may represent the process of populating or updating a knowledge graph. This involves performing semantic integration to semantically link the entities (such as assets, attributes, and metrics) within the knowledge graph. This linking may be based on spatial proximity, functional connectivity, or causal relationships learned from the multimodal data. For example, extracted and enriched features, such as sidewalk condition assessments, may be intelligently linked to a topological network graph, which may be derived from sources such as OpenStreetMap. This association explicitly links identified assets to specific road segments or intersections within the knowledge graph, which in turn facilitates powerful network-based analytical capabilities, including, but not limited to, sophisticated route planning, connectivity analysis, or detailed accessibility modeling.

The 3D data 410 represents geometric information about the transportation network environment, which may be captured using sensors like LiDAR. The 3D data 410 may be, be similar to, include, or be included in the multimodal input data received by the processor set, the LiDAR data. The 3D data 410 may be acquired concurrently with the image data 402 by a mobile mapping system or obtained from other sources providing three-dimensional spatial information. The 3D data 410 primarily provides precise measurements of the physical structure of infrastructure assets and the surrounding terrain.

The 3D data 410 serves as the input to the dimension extraction 412 operation. The 3D data 410 contains the raw point clouds or other 3D representations from which specific geometric measurements, such as width, height, or slope, are derived for identified infrastructure assets.

In some implementations, the 3D data 410 may be pre-processed, e.g., by the data integration pipeline 114 or 302, involving cleaning, filtering, and geo-referencing before being used for the dimension extraction 412. For example, noise reduction and ground filtering may be applied to LiDAR point clouds. In some implementations, the 3D data 410 might be derived from photogrammetric reconstruction using multiple images rather than direct LiDAR scanning.

The dimension extraction 412 represents the process of deriving specific geometric measurements from the 3D data 410. This operation may be performed by algorithms implemented in software modules, within the infrastructure planning support system 102 or the AI system 300, running on hardware like the computing device 200 shown in FIG. 2. The dimension extraction 412 operation applies techniques such as spatial clustering, plane fitting, and edge detection, e.g., using RANSAC-based line fitting, to the 3D data 410 to quantify attributes like width, length, height, slope, cross-slope, and uplift dimensions of infrastructure assets. Extracting precise geometric measurements may be part of identifying the attribute set for an asset.

The dimension extraction 412 operation receives the 3D data 410 as input. The output of the dimension extraction 412 operation, including the calculated precise geometric measurements, is provided as an input to the data fusion 408 operation. These measurements are used for assessing compliance with standards such as ADA and for engineering design considerations.

In some implementations, the dimension extraction 412 operation may be coupled with asset identification performed by the AI component, e.g., the large vision language model 404 or other segmentation models. For example, segmentation masks projected onto the 3D data 410 might define the points belonging to a specific asset for which dimensions need to be extracted. In some implementations, the dimension extraction 412 may automatically flag measurements that fall outside acceptable ranges defined by relevant standards.

The network topology 414 represents the structural layout and connectivity of the transportation network. This data may be sourced from existing GIS databases, OpenStreetMap, or derived from the collected sensor data, by the data source 106 or the data source 108. The network topology 414 may define road segments as edges and intersections as nodes and how they connect, forming the graph structure of the network. Calculating a network importance score may be based on a topological analysis of the network topology 414.

The network topology 414 serves as a foundational layer input to the data fusion 408 operation. Asset attributes and analytical results, such as LTS scores, may be associated with specific elements (e.g., edges or nodes) of the network topology 414, facilitating network-level analysis and visualization.

In some implementations, the network topology 414 may include attributes for each segment or node, such as road classification, e.g., arterial, residential, posted speed limits, or number of lanes. In some implementations, separate network topologies may be maintained for different transportation modes, e.g., a pedestrian network including sidewalks and crosswalks or a cycling network including bike lanes and paths.

The demographic and travel data 416 represents contextual information about the population and travel patterns within the transportation network environment. This data may be obtained from sources like the U.S. Census Bureau, travel demand models, public transit agencies, or anonymized mobility data providers, via the data source 108. The demographic and travel data 416 may include information on population density, income levels, age distribution, vehicle ownership, transit usage, pedestrian volumes, or commute patterns associated with specific geographic areas.

The demographic and travel data 416 is provided as an input to the data fusion 408 operation. This information may be used to provide context for infrastructure assessments, support equity analysis in planning, or inform the weighting of factors in prioritization scores. For example, LTS scores or condition assessments might be weighted higher in areas with high pedestrian volumes or vulnerable populations.

In some implementations, the demographic and travel data 416 may be aggregated to specific geographic units, such as census tracts or traffic analysis zones, and spatially joined to the network topology 414 during the data fusion 408. In some implementations, real-time or near-real-time travel data, such as floating car data or transit vehicle locations, might be incorporated to provide dynamic context.

The information-infused network 418 represents the integrated dataset resulting from the data fusion 408 operation. This data structure combines the network topology with detailed attributes for each segment or node, including asset characteristics, such as type, condition, compliance, geometry from 406 and 412, analytical scores, such as LTS or importance from the asset evaluation engine 118 or 308, and relevant demographic or travel context from 416. The information-infused network 418 serves as the comprehensive foundation for subsequent planning and decision-making operations. The information-infused network 418 is the output of the data fusion 408 operation and the primary input to the optimization 420 operation. The information-infused network 418 contains the synthesized information needed to evaluate trade-offs and prioritize improvements across the network. For instance, the information-infused network 418 might indicate the importance of resurfacing a sidewalk or upgrading bike lanes based on the number of bicyclists, rider density, or impact to pedestrian volumes. In some implementations, the information-infused network 418 may be stored in the data layer as a graph database or a set of spatially referenced tables. For example, road segments might have associated attributes for PCI, calculated pedestrian LTS, cyclist LTS, betweenness centrality, and adjacent population density. In some implementations, the information-infused network 418 may be dynamically updated as new input data becomes available or as analyses are refined.

The optimization 420 represents the multi-objective infrastructure management operation where planning decisions, such as budget allocation for capital improvements, are determined algorithmically. This operation may be performed by the optimization engine 310 or equivalent functionality within the tool layer 120 or 312, using techniques like MILP or heuristics. The optimization 420 operation may find a set of actions, e.g., which road segments to upgrade, that satisfy objectives, e.g., maximizing overall benefit derived from composite scores, while adhering to constraints, e.g., available budget. Generating output data may include performing an optimization analysis.

The optimization 420 operation takes the information-infused network 418 as its main input, leveraging the integrated data and scores to evaluate potential improvement projects. The result of the optimization 420 operation is the output 422, which may include a ranked list of recommended projects, an optimized budget allocation plan, or similar decision-support information. In some implementations, the optimization 420 operation may facilitate user interaction to adjust objectives, constraints, or weighting factors and see the resulting impact on the recommended plan. For example, a planner could explore the trade-off between prioritizing safety improvements versus maximizing accessibility enhancements. In some implementations, the optimization 420 may incorporate feedback loops, involving human expert review of candidate solutions to refine preferences or constraints, as described in the context of sequential optimization.

The output 422 represents the final result generated by the process 400, intended for use by transportation planners, engineers, or other stakeholders. The output 422 may be, be similar to, include, or be included in the output data associated with the multi-objective infrastructure management operation. The output 422 encapsulates the actionable insights derived from the integrated data and analysis, such as prioritized lists of infrastructure projects, recommended budget allocations, scenario simulation results, or compliance reports. This output 422 may be formatted for presentation to the user, via a graphical user interface. The output 422 may be stored in the data layer 116 or 306 or made available through the server for retrieval and usage by the user device 104 or the client 318. The output 422 is generated by the optimization 420 operation or other analytical modules within the tool layer 120 or 312. This output 422 may be stored in the data layer 116 or 306 and provided to the user device 104 or the client 318 for display.

In some implementations, the output 422 may be provided as interactive visualizations within a GUI, such as a map highlighting recommended project locations color-coded by priority, or charts showing projected budget expenditures versus expected benefits. For example, the output data may be provided for display via a graphical user interface rendered by a computing device. In some implementations, the output 422 may be generated as formal reports in standard formats, e.g., PDF, documenting the analysis methodology, results, and recommendations. In some implementations, the output 422 may be exported in formats compatible with other planning or asset management systems, such as GeoJSON files or database tables.

In summary, the process 400 depicts a data flow where the image data 402 is analyzed by the large vision language model 404 to produce the road features and context information 406. Separately, the 3D data 410 undergoes the dimension extraction 412. These results, along with the network topology 414 and the demographic and travel data 416, are combined in the data fusion 408 to create the information-infused network 418. This integrated network serves as input for the optimization 420, which generates the output 422 for infrastructure planning support.

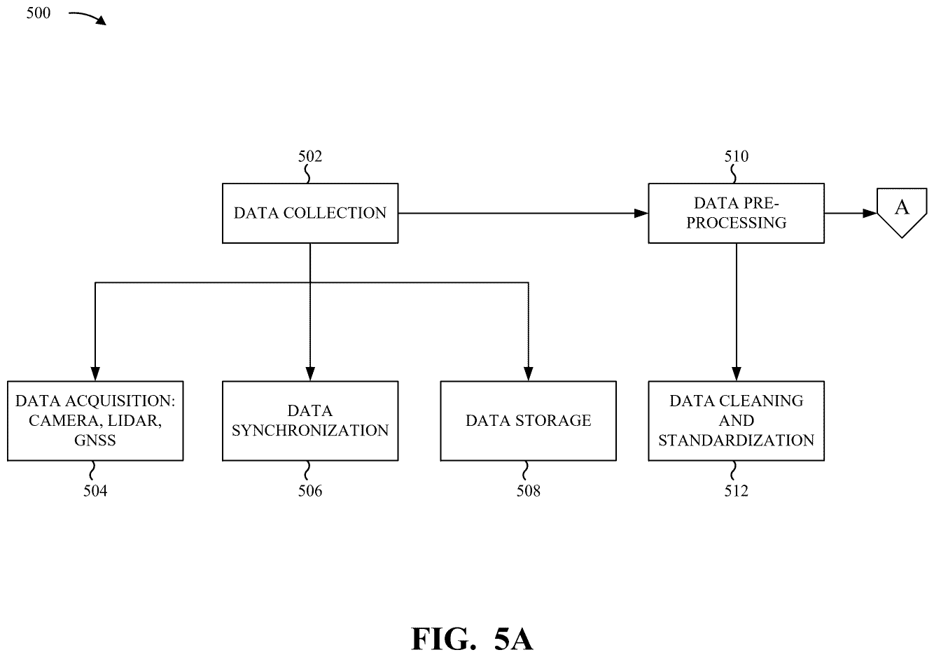

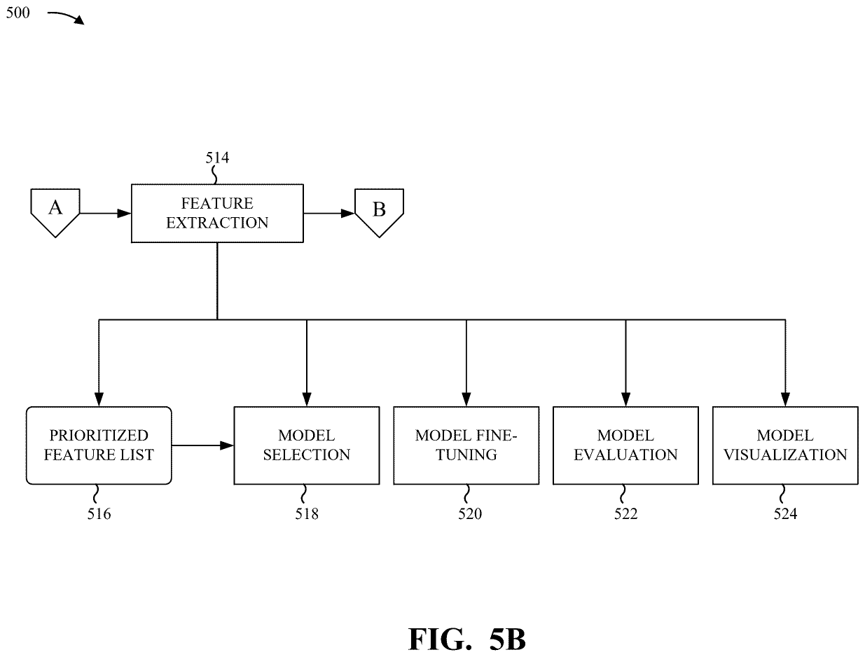

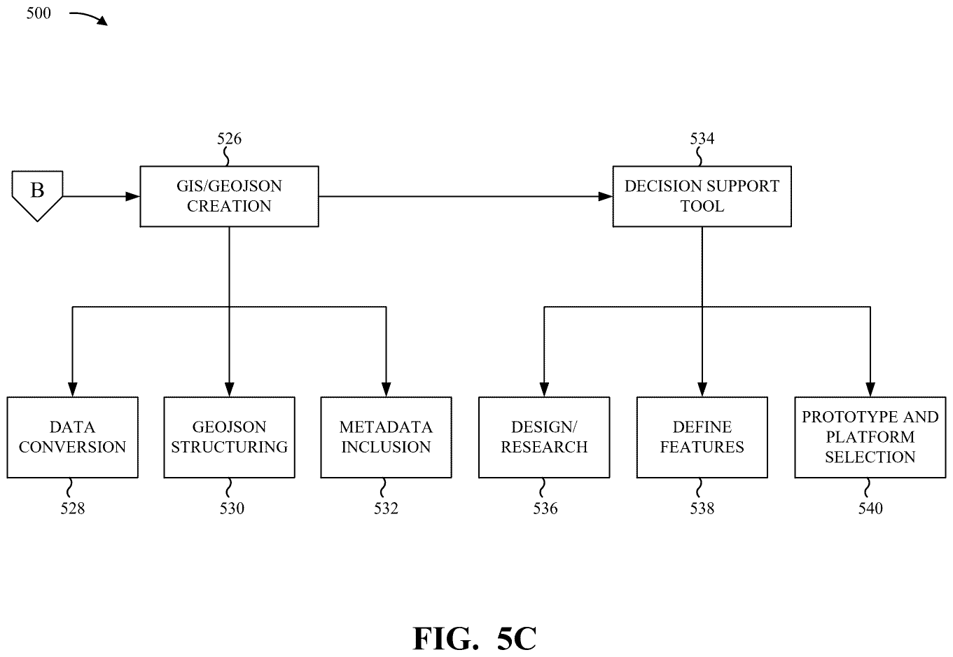

FIG. 5A through FIG. 5C are flow diagrams of an example process 500 associated with AI-driven support for infrastructure management. The process 500 may illustrate operations involved in data acquisition, processing, feature extraction, model management, data formatting, and decision support, executed by systems like the infrastructure planning support system 102 or the AI system 300.

Referring to FIG. 5A, the process 500 may commence with a data collection operation 502. This operation may include receiving multimodal input data associated with a transportation network environment. The multimodal input data may originate from various sensors or data sources. The data collection operation 502 may provide inputs to subsequent operations, including a data acquisition operation 504, a data synchronization operation 506, a data storage operation 508, and a data pre-processing operation 510.

The process 500 may include a data acquisition operation 504. This operation may specify the types of sensors utilized during the data collection operation 502. As illustrated, a data acquisition operation 504 may involve the use of cameras, LiDAR sensors, and Global Navigation Satellite System (GNSS) receivers. This combination may facilitate the capture of both image data and LiDAR data, providing visual context and precise geometric measurements. Data acquired during this operation may be provided to the data synchronization operation 506 and the data storage operation 508. In some implementations, the data acquisition operation 504 may also utilize lightweight camera and LiDAR sensor packs mounted on other platforms, such as small electric bikes or scooters, to capture data in dense urban cores or narrow alleys inaccessible to larger vehicles.

The process 500 may include a data synchronization operation 506. This operation may receive inputs from the data collection operation 502 and the data acquisition operation 504. The data synchronization operation 506 may involve aligning data streams captured by different sensors, such as based on timestamps or other correlation methods. This operation may be part of having multimodal data captured concurrently, such as images and LiDAR scans, accurately related to each other in time and space.

The process 500 may include a data storage operation 508. This operation may receive data from the data collection operation 502 and the data acquisition operation 504. The data storage operation 508 may involve saving the collected and acquired raw or processed data into a persistent repository, such as the data layer 116 or the data layer 306. This may facilitate subsequent retrieval and analysis.

The process 500 may include a data pre-processing operation 510. This operation may receive data from the data collection operation 502. The data pre-processing operation 510 may involve initial operations to prepare the raw data for further analysis, including format conversion, preliminary filtering, or data organization. The output of the data pre-processing operation 510 may be provided to the data cleaning and standardization operation 512 and may serve as an intermediate output, represented by connection point A.

The process 500 may include a data cleaning and standardization operation 512. This operation may receive pre-processed data from the data pre-processing operation 510. The data cleaning and standardization operation 512 may involve further refinement of the data, including removing noise or errors, correcting inconsistencies, and converting data into uniform formats or units. This operation may contribute to having data quality and consistency verified before detailed analysis. This operation may be part of a data integration pipeline 114 or 302. The process continues via connection point A, which represents the output from the data pre-processing operation 510.

Referring now to FIG. 5B, the process 500 continues from connection point A, receiving the output from the data pre-processing operation 510. This pre-processed data serves as input to a feature extraction operation 514. The feature extraction operation 514 may involve identifying, based on an AI component like the AI component 122 or the AI agent network 314, specific characteristics or attributes within the processed multimodal input data. This operation may identify at least one attribute set associated with at least one infrastructure asset. Features extracted may include geometric properties, visual characteristics, or condition indicators of infrastructure assets. The output of the feature extraction operation 514 may be provided to several subsequent operations, including prioritized feature list 516, a model selection operation 518, a model fine-tuning operation 520, a model evaluation operation 522, and a model visualization operation 524. The feature extraction operation 514 may produce an output represented by connection point B.

The process 500 may include generating a prioritized feature list 516. This operation may receive input from the feature extraction operation 514. The prioritized feature list 516 may involve ranking or selecting the extracted features based on their relevance or importance for subsequent modeling or analysis tasks. This list may guide the model selection operation 518.

The process 500 may include a model selection operation 518. This operation may receive inputs from the feature extraction operation 514 and the prioritized feature list 516. The model selection operation 518 may involve choosing appropriate AI or machine learning models, from the AI component 122 or the AI agent network 314, based on the types of features extracted and the specific analytical goals, such as classification, segmentation, or prediction. The selected model may be used in the model fine-tuning operation 520.

The process 500 may include a model fine-tuning operation 520. This operation may receive inputs from the feature extraction operation 514 and from the model selection operation 518. The model fine-tuning operation 520 may involve adjusting the parameters of a selected AI model using the extracted features or a subset thereof to improve its performance on the specific task or dataset associated with the infrastructure management operation. The fine-tuned model may be assessed in the model evaluation operation 522.

The process 500 may include a model evaluation operation 522. This operation may receive inputs from the feature extraction operation 514 and from the model fine-tuning operation 520. The model evaluation operation 522 may involve assessing the performance of the selected or fine-tuned AI models using metrics relevant to the task, such as accuracy, precision, recall, or F1 score, based on the extracted features and ground truth data. The evaluation results may inform model selection or further tuning and may be presented in the model visualization operation 524.

The process 500 may include a model visualization operation 524. This operation may receive inputs from the feature extraction operation 514 and from the model evaluation operation 522. The model visualization operation 524 may involve generating visual representations of the AI model's outputs or performance, such as overlaying segmentation masks on images, plotting prediction confidence levels, or displaying evaluation metrics. This may aid in understanding and interpreting the model's behavior. The process continues via connection point B, representing an output from the feature extraction operation 514.

Referring now to FIG. 5C, the process 500 continues from connection point B, receiving the output from the feature extraction operation 514. This output, representing identified attribute sets, serves as input to a GIS/GeoJSON creation operation 526. The GIS/GeoJSON creation operation 526 may involve formatting the extracted features and attributes into standard geospatial data formats, such as GeoJSON. This operation may structure the output data in a way that is readily usable by GIS and web mapping applications. The output of the GIS/GeoJSON creation operation 526 may feed into subsequent formatting operations, including a data conversion operation 528, a GeoJSON structuring operation 530, and a metadata inclusion operation 532, and may provide input to the decision support tool 534.

The process 500 may include a data conversion operation 528. Receiving input from the GIS/GeoJSON creation operation 526, this operation may involve transforming the data into different formats as needed, for compatibility with specific software or systems.

The process 500 may include a GeoJSON structuring operation 530. Receiving input from the GIS/GeoJSON creation operation 526, this operation may focus on organizing the features and properties within the GeoJSON files according to a defined schema or standard. This may provide for consistency and interoperability.

The process 500 may include a metadata inclusion operation 532. Receiving input from the GIS/GeoJSON creation operation 526, this operation may involve embedding descriptive information within the GeoJSON files, such as data sources, processing dates, coordinate reference systems, or attribute definitions.

The process 500 may include utilizing a decision support tool 534. This tool may receive the structured geospatial data from the GIS/GeoJSON creation operation 526. The decision support tool 534 may represent functionalities of the infrastructure planning support system 102 or AI system 300, leveraging the generated data for analysis, planning, and management tasks associated with a multi-objective infrastructure management operation. The decision support tool 534 may provide outputs or capabilities used in design/research 536, defining features 538, and prototype and platform selection 540. This tool may facilitate providing output data for display via a graphical user interface.

The process 500 may involve using the decision support tool 534 for design/research 536. This indicates that the outputs and analyses from the tool may inform infrastructure design processes or support research related to transportation networks.

The process 500 may involve using the decision support tool 534 to define features 538. This suggests the tool may assist planners in specifying or identifying required infrastructure features based on the data and analyses.

The process 500 may involve using the decision support tool 534 for prototype and platform selection 540. This indicates the tool's outputs may inform decisions regarding the development of system prototypes or the selection of technology platforms for implementing infrastructure solutions or management systems.

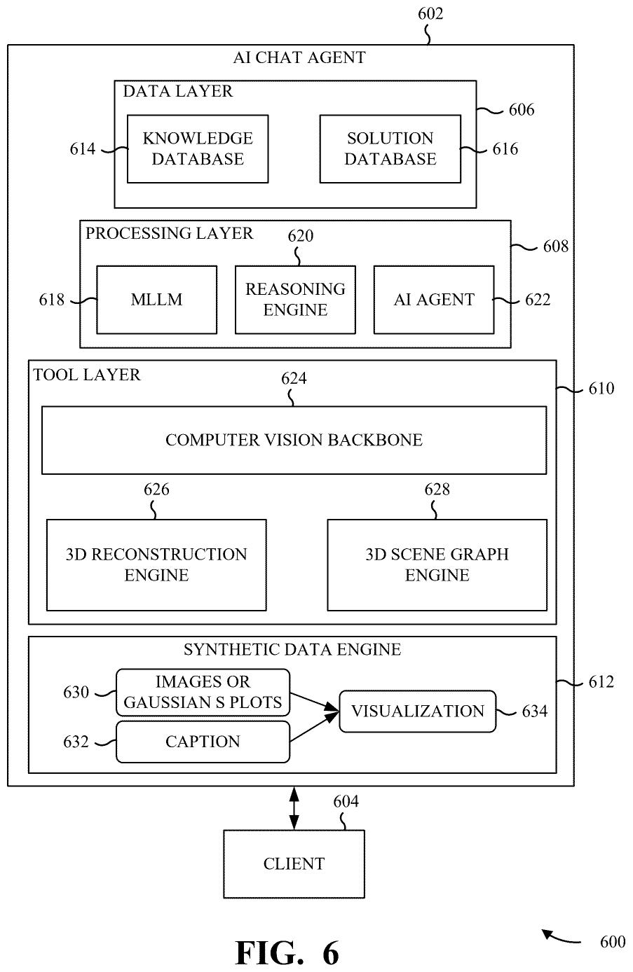

FIG. 6 is a block diagram of another example of an AI system 600 for supporting infrastructure management. The AI system 600 may be, be similar to, include, or be included in the infrastructure planning support system 102 shown in FIG. 1 or the AI system 300 shown in FIG. 3. The AI system 600 includes an AI chat agent 602 and a client 604. These components may interact to provide conversational AI capabilities for infrastructure assessment and planning, leveraging multimodal data analysis and generation tools.

The AI chat agent 602 may be configured as the central conversational and analytical component of the AI system 600. The AI chat agent 602 may be implemented using large language models (LLMs), multimodal large language models (MLLMs), and associated processing logic, running on server infrastructure similar to the computing device 200 shown in FIG. 2. The AI chat agent 602 may be configured to interact with users via natural language, process multimodal inputs, access knowledge bases, utilize various analytical tools, and generate responses, including textual briefings, data visualizations, or recommendations related to infrastructure management. The graphical user interface may include an interactive chatbot configured to receive user queries and provide information based on the output data.

The AI chat agent 602 may interact primarily with the client 604, receiving user queries and sending back generated responses. Internally, the AI chat agent 602 orchestrates interactions between its subcomponents, such as accessing the data layer 606, utilizing models in the processing layer 608, invoking tools in the tool layer 610, and using the synthetic data engine 612. The AI component may include at least one of a VLM, a computer vision (CV) model for segmentation, a CV model for object detection, or a CV model for depth estimation. The graphical user interface may include a conversational AI component configured to receive a natural language query from a user and generate a responsive textual briefing.

In some implementations, the AI chat agent 602 may be configured for transportation planning tasks, incorporating domain-specific knowledge and analytical tools relevant to infrastructure assets such as sidewalks, crosswalks, and bike lanes. For example, the AI chat agent 602 may be trained or prompted to assess ADA compliance based on visual inputs or geometric data. In some implementations, the AI chat agent 602 may utilize a Retrieval-Augmented Generation (RAG) approach to dynamically incorporate information from external documents, such as regulatory standards or best practice guides, into its responses. In some implementations, the AI chat agent 602 may maintain conversation history or user context to provide more personalized and relevant interactions over time.

The client 604 represents the interface through which a user interacts with the AI chat agent 602. The client 604 may be, be similar to, include, or be included in the client 124 shown in FIG. 1 or the client 318 shown in FIG. 3, running on a user device 104. It may be implemented as a web application, a mobile application, a chat interface integrated into other software, or a dedicated hardware device, possibly utilizing resources described for the computing device 200 shown in FIG. 2. The client 604 may be configured to receive user input, such as typed text, voice commands, or uploaded images/videos, transmit this input to the AI chat agent 602, receive responses from the AI chat agent 602, and present these responses to the user in an appropriate format, e.g., text, images, visualizations.

The client 604 may interact directly with the AI chat agent 602, sending queries and receiving responses, via a network connection similar to the network 110 shown in FIG. 1. The client 604 may render the graphical user interface for the conversational interaction. Providing the output data for display via a graphical user interface rendered by a computing device may be part of the process.

In some implementations, the client 604 may include features for managing multimodal input, such as tools for selecting regions of interest in an image or point cloud to query the AI chat agent 602 about. For example, a user may draw a bounding box around a curb ramp in an image and query the AI chat agent 602 to assess its ADA compliance. In some implementations, the client 604 may integrate visualization components to display data generated or retrieved by the AI chat agent 602, such as maps showing asset conditions or charts summarizing analysis results. In some implementations, the client 604 may support voice input and output, facilitating hands-free interaction with the AI chat agent 602.

As shown in FIG. 6, the AI chat agent 602 includes a data layer 606, a processing layer 608, a tool layer 610, and a synthetic data engine 612. In some implementations, two or more of the data layer 606, the processing layer 608, the tool layer 610, and the synthetic data engine 612 may be integrated into a single component. In some implementations, one or more of the data layer 606, the processing layer 608, the tool layer 610, and the synthetic data engine 612 may be implemented using any number of computing devices such as the computing device 200 shown in FIG. 2. For example, one or more of the data layer 606, the processing layer 608, the tool layer 610, and the synthetic data engine 612 may be distributed among a number of computing devices, operating as microservices within the AI chat agent 602 architecture.

The data layer 606 may serve as the repository for information accessed and utilized by the AI chat agent 602. The data layer 606 may be, be similar to, include, or be included in the data layer 116 shown in FIG. 1 or the data layer 306 shown in FIG. 3. It may be implemented using databases, knowledge bases, vector stores, or file systems, distributed across storage resources associated with devices like the computing device 200 shown in FIG. 2. The data layer 606 may store structured and unstructured data relevant to infrastructure management, including domain knowledge, historical data, user interaction logs, or pre-computed analysis results.

The data layer 606 may primarily interact with the processing layer 608, providing data needed for reasoning and response generation, and storing new information or insights derived during processing. It might also store information used by or generated by the tool layer 610 or the synthetic data engine 612.

In some implementations, the data layer 606 may be organized to support efficient retrieval for RAG processes, using vector embeddings or semantic indexing techniques. For example, documents containing regulatory standards could be indexed for rapid lookup based on user query similarity. In some implementations, the knowledge database 614 may be implemented as a component of, or the basis for, a dynamic knowledge graph. This graph-based structure may be utilized by prioritization algorithms within the asset evaluation engine 118 or the optimization engine 310. For example, algorithms such as Edge Betweenness Centrality (EBC) or models such as Graph Neural Networks (GNNs) may operate on the knowledge graph to determine the importance or criticality of road segments within the network. In some implementations, the data layer 606 may include distinct databases optimized for different types of information, such as a graph database for network topology and a relational database for asset attributes. The data layer 606 may implement access control mechanisms to manage data privacy and security.

The processing layer 608 may represent the core reasoning and intelligence components of the AI chat agent 602. The processing layer 608 may include one or more AI models and associated logic for understanding user input, planning responses, interacting with tools, and generating natural language outputs, executing on powerful computing resources such as graphics processing units (GPUs) or tensor processing units (TPUs) within devices similar to the computing device 200 shown in FIG. 2. The processing layer 608 orchestrates the flow of information within the AI chat agent 602 to fulfill user requests.

The processing layer 608 may receive processed user input, including text and references to multimodal data. It may interact with the data layer 606 to retrieve relevant information or context. It may invoke functionalities within the tool layer 610 to perform specific analyses or actions. Based on retrieved data and tool outputs, the processing layer 608 generates a response, which is then sent back to the client 604.

In some implementations, the processing layer 608 may employ a multi-agent architecture, where different AI agents specialize in specific tasks such as query understanding, tool selection, or response generation. For example, one agent might parse a user query while another decides which CV tool to invoke. In some implementations, the processing layer 608 may include mechanisms for managing conversational state and context across multiple turns of interaction. Memory components might store intermediate reasoning steps or conversation history. In some implementations, the processing layer 608 may incorporate explainability features, facilitating it to provide justifications for its reasoning or the information it presents.

The tool layer 610 may include a collection of specialized modules or services that the processing layer 608 may invoke to perform specific tasks, particularly those involving complex computations or interactions with external systems. The tool layer 610 may be, be similar to, include, or be included in the tool layer 120 shown in FIG. 1 or the tool layer 312 shown in FIG. 3. These tools may include CV models, 3D reconstruction algorithms, data analysis functions, or interfaces to external APIs, running on dedicated hardware or software environments similar to the computing device 200 shown in FIG. 2. The tool layer 610 extends the capabilities of the core processing layer 608 by providing access to specialized functionalities.

The tool layer 610 may be invoked by the processing layer 608 based on the user's request or the reasoning process. Tools within the tool layer 610 may receive specific inputs, e.g., an image for analysis, from the processing layer 608 or retrieve data from the data layer 606. The outputs generated by the tools, e.g., segmentation masks, 3D models, analysis results, are returned to the processing layer 608 to be incorporated into the final response.

In some implementations, the tool layer 610 may include APIs for interacting with external services, such as retrieving real-time traffic data, accessing weather information, or querying GIS databases. For example, a tool may fetch current traffic conditions for a specified road segment. In some implementations, the tool layer 610 may provide functions for complex data transformations or simulations, such as running a traffic flow model or performing structural analysis based on 3D data. In some implementations, the tools within the tool layer 610 may be dynamically selectable by the processing layer 608 based on the context of the conversation.

The synthetic data engine 612 may be configured to generate artificial data that may be used for training AI models, augmenting existing datasets, or creating visualizations. The synthetic data engine 612 may employ generative models, simulation techniques, or procedural generation algorithms, running on specialized hardware such as GPUs within devices similar to the computing device 200 shown in FIG. 2. The synthetic data engine 612 may facilitate the creation of diverse and controlled datasets that may be difficult or costly to obtain through real-world collection, aiding model development and evaluation.

The synthetic data engine 612 may receive inputs such as parameters defining desired data characteristics, e.g., specific asset types, environmental conditions, or data formats like images or Gaussian splats 630, along with captions 632 describing the scene. It generates synthetic data, which might include images, 3D models represented as Gaussian splats, or associated question-answering (QA) datasets. This synthetic data could be used internally, e.g., for training models within the AI agent network 314 or computer vision backbone 624, or provided as output, for visualization 634 or external use.

In some implementations, the synthetic data engine 612 may utilize generative adversarial networks (GANs) or diffusion models to create realistic images of street scenes under various conditions. For example, it could generate images depicting different levels of pavement cracking or varying lighting conditions. In some implementations, the synthetic data engine 612 may leverage 3D modeling techniques, including Gaussian splatting or photogrammetry from the 3D reconstruction engine 626, to create novel views or augment existing 3D scenes. In some implementations, the synthetic data engine 612 may automatically generate corresponding annotations or QA pairs along with the synthetic data to facilitate supervised learning or model evaluation.

As shown in FIG. 6, the data layer 606 includes a knowledge database 614 and a solution database 616. In some implementations, two or more of the knowledge database 614 and the solution database 616 may be integrated into a single component. In some implementations, one or more of the knowledge database 614 and the solution database 616 may be implemented using any number of computing devices such as the computing device 200 shown in FIG. 2. For example, one or more of the knowledge database 614 and the solution database 616 may be distributed among a number of computing devices.

The knowledge database 614 may store factual information, domain knowledge, regulations, standards, and other contextual data relevant to infrastructure management. The knowledge database 614 may be implemented as a structured database, an unstructured document store, a graph database, or a vector database optimized for semantic retrieval, residing on storage media associated with the computing device 200 shown in FIG. 2. The knowledge database 614 may provide the foundational information that the processing layer 608 uses for reasoning and grounding its responses, particularly when employing RAG techniques.

The knowledge database 614 may interact primarily with the processing layer 608, serving retrieval requests for relevant information based on user queries or internal reasoning steps. The knowledge database 614 may be updated periodically or continually as new information becomes available.

In some implementations, the knowledge database 614 may store digitized versions of official documents such as the MUTCD, ADA standards, or local design guidelines, indexed for efficient search. For example, relevant sections could be retrieved based on semantic similarity to a user's question about compliance. In some implementations, the knowledge database 614 may store common infrastructure problems and their typical causes or diagnostic procedures. In some implementations, the knowledge database 614 may utilize vector embeddings to represent knowledge chunks, facilitating semantic search capabilities.

The solution database 616 may store information about potential solutions, best practices, intervention strategies, cost estimates, or case studies related to infrastructure management problems. The solution database 616 may complement the knowledge database 614 by providing actionable recommendations or examples based on identified issues, implemented using database technologies on hardware like the computing device 200 shown in FIG. 2. The solution database 616 may aid the AI chat agent 602 in suggesting appropriate next steps or mitigation strategies.

The solution database 616 may interact with the processing layer 608, providing potential solutions or recommendations based on the context identified through user queries and data analysis. The solution database 616 may be linked to the knowledge database 614, associating solutions with specific problems or standards.

In some implementations, the solution database 616 may contain cost models for various types of infrastructure repairs or upgrades, facilitating the AI chat agent 602 to provide budget estimates. For example, it might provide typical costs per linear foot for sidewalk replacement. In some implementations, the solution database 616 may store examples of successful Complete Streets implementations or case studies demonstrating the effectiveness of specific interventions. In some implementations, the solution database 616 may be dynamically updated with new solutions or cost data based on recent projects or industry trends.

As shown in FIG. 6, the processing layer 608 includes an MLLM 618, a reasoning engine 620, and an AI agent 622. In some implementations, two or more of the MLLM 618, the reasoning engine 620, and the AI agent 622 may be integrated into a single component. In some implementations, one or more of the MLLM 618, the reasoning engine 620, and the AI agent 622 may be implemented using any number of computing devices such as the computing device 200 shown in FIG. 2. For example, one or more of the MLLM 618, the reasoning engine 620, and the AI agent 622 may be distributed among a number of computing devices, operating cooperatively within the processing layer 608.

The MLLM 618 represents a Multimodal Large Language Model, which forms the core intelligence for understanding and generating responses involving both text and other modalities such as images. The MLLM 618 may be, be similar to, include, or be included in models such as Gemini, GPT-40, or similar architectures, running on specialized AI hardware within devices like the computing device 200 shown in FIG. 2. The MLLM 618 may be configured for processing user queries, interpreting visual inputs, retrieving information, coordinating tool use via the reasoning engine 620, and generating coherent, contextually relevant multimodal responses.

The MLLM 618 may interact with the reasoning engine 620 to plan actions and invoke tools. It may receive inputs including user queries and multimodal data, and access information retrieved from the data layer 606, orchestrated by the reasoning engine 620. The MLLM 618 generates the final response content, which is then passed back to the client 604.

In some implementations, the MLLM 618 may be optimized for specific tasks through prompt engineering, as discussed in relation to the large vision language model 404. In some implementations, the MLLM 618 may possess capabilities for visual grounding, linking textual descriptions to specific regions within an image. In some implementations, multiple specialized MLLMs might be used within the processing layer 608 for different sub-tasks.

The reasoning engine 620 may be responsible for planning the steps required to address a user's query, selecting appropriate tools, and integrating information from various sources. The reasoning engine 620 may be implemented using planning algorithms, rule-based systems, or integrated within the MLLM 618's architecture, running on hardware like the computing device 200 shown in FIG. 2. The reasoning engine 620 acts as the orchestrator within the processing layer 608, determining how to leverage the available data, knowledge, and tools.

The reasoning engine 620 may receive the interpreted user query from the MLLM 618. It may interact with the data layer 606 to determine needed information and with the tool layer 610 to select and invoke appropriate tools. The reasoning engine 620 provides the results and plan back to the MLLM 618 for synthesizing the final response. It might interact with the AI agent 622 for specific reasoning tasks.

In some implementations, the reasoning engine 620 may employ techniques such as Reasoning and Acting (ReAct) to iteratively refine plans based on tool outputs and retrieved information. In some implementations, the reasoning engine 620 may maintain a belief state about the user's goals and the current context to guide its planning process. In some implementations, the reasoning engine 620 may be capable of decomposing complex queries into simpler sub-tasks that may be addressed by individual tools or information retrieval operations.

The AI agent 622 may represent a specific instantiation or component within the processing layer 608, specializing in certain types of reasoning, interaction, or task execution. The AI agent 622 could be a distinct software module, a configuration of the MLLM 618, or part of a multi-agent system, running on hardware like the computing device 200 shown in FIG. 2. The AI agent 622 may execute specific parts of the plan devised by the reasoning engine 620 or handle particular aspects of the interaction.

The AI agent 622 may interact closely with the MLLM 618 and the reasoning engine 620. It might receive instructions or sub-tasks from the reasoning engine 620 and utilize the MLLM 618's capabilities or access data and tools as needed to complete its assigned function.

In some implementations, the AI agent 622 might specialize in generating specific types of output, such as creating visualizations or summarizing complex data. In some implementations, multiple AI agents might collaborate within the processing layer 608, each handling different facets of the user request. In some implementations, the AI agent 622 could be responsible for managing memory or maintaining conversational context.

As shown in FIG. 6, the tool layer 610 includes a computer vision backbone 624, a 3D reconstruction engine 626, and a 3D scene graph engine 628. In some implementations, two or more of the computer vision backbone 624, the 3D reconstruction engine 626, and the 3D scene graph engine 628 may be integrated into a single component. In some implementations, one or more of the computer vision backbone 624, the 3D reconstruction engine 626, and the 3D scene graph engine 628 may be implemented using any number of computing devices such as the computing device 200 shown in FIG. 2. For example, one or more of the computer vision backbone 624, the 3D reconstruction engine 626, and the 3D scene graph engine 628 may be distributed among a number of computing devices.

The computer vision backbone 624 represents a collection of fundamental CV models and algorithms used for processing visual data. This may include pre-trained models for tasks such as object detection, scene classification, image segmentation, e.g., using Mask2Former, or feature extraction, running on GPUs within devices like the computing device 200 shown in FIG. 2. The computer vision backbone 624 provides foundational visual analysis capabilities that may be invoked by the processing layer 608 or used by other tools in the tool layer 610. Identifying the at least one attribute set may be based on the AI component, which may include a CV model for segmentation or a CV model for object detection.

The computer vision backbone 624 may be invoked by the processing layer 608 or other tools. It receives visual data, e.g., images or video frames, retrieved from the data layer 606, as input. It outputs results such as bounding boxes, segmentation masks, class labels, or feature vectors, which are returned to the calling component, e.g., the processing layer 608, for further use.

In some implementations, the computer vision backbone 624 may include models fine-tuned for transportation infrastructure assets, enhancing their accuracy on domain-specific objects. For example, a model might be fine-tuned to recognize various types of street signs or pavement markings. In some implementations, the computer vision backbone 624 may provide functionalities for visual grounding, facilitating the MLLM 618 to associate textual descriptions with specific image regions. This may be used by the tool layer 312. In some implementations, the computer vision backbone 624 may support processing of different image modalities, including infrared or depth images.

The 3D reconstruction engine 626 may be configured to generate three-dimensional models or representations of scenes based on input data, such as images or LiDAR scans. This engine may employ techniques such as Structure from Motion (SfM), Multi-View Stereo (MVS), photogrammetry, or newer methods such as Neural Radiance Fields (NeRFs) or Gaussian Splatting, leveraging significant computational resources such as GPUs on devices similar to the computing device 200 shown in FIG. 2. The 3D reconstruction engine 626 facilitates the creation of detailed 3D models of infrastructure assets or environments from sensor data.

The 3D reconstruction engine 626 may receive input data, such as sequences of images or 3D data from LiDAR, possibly retrieved from the data layer 606. It outputs 3D representations, which could be point clouds, meshes, volumetric grids, Gaussian splats, or other formats. These outputs might be stored in the data layer 606, used by the 3D scene graph engine 628, or visualized via the synthetic data engine 612 or client 604.

In some implementations, the 3D reconstruction engine 626 may specialize in reconstructing specific types of assets, such as creating detailed models of intersections or building facades from multiple viewpoints. In some implementations, the 3D reconstruction engine 626 may integrate geometric constraints or semantic information, from the computer vision backbone 624, to improve the accuracy and coherence of the reconstructed models. In some implementations, the 3D reconstruction engine 626 may support real-time or near-real-time reconstruction capabilities for dynamic environments.

The 3D scene graph engine 628 may be configured to represent a 3D scene as a hierarchical graph structure, capturing objects, their attributes, and their spatial and semantic relationships. This engine may build upon 3D data, reconstructed by the 3D reconstruction engine 626, and semantic information, possibly derived from the computer vision backbone 624 or MLLM 618, running on hardware like the computing device 200 shown in FIG. 2. The 3D scene graph engine 628 provides a structured, relational understanding of the 3D environment, facilitating complex spatial queries and reasoning.

The 3D scene graph engine 628 may receive as input 3D models or point clouds, from the 3D reconstruction engine 626 or the data layer 606, along with semantic labels or object detections, from the computer vision backbone 624. It outputs a scene graph data structure, which might be stored in the data layer 606 or used directly by the processing layer 608 for spatial reasoning tasks.

In some implementations, the 3D scene graph engine 628 may support open vocabulary object recognition, facilitating it to represent objects described in natural language even if they were not part of a predefined training set. In some implementations, the scene graph may encode relationships such as “above,” “next to,” “part of,” or functional relationships between objects. For example, it might represent a traffic signal as being mounted on a specific pole located next to a crosswalk. In some implementations, the 3D scene graph engine 628 may facilitate efficient querying of the 3D environment based on spatial and semantic criteria.

As shown in FIG. 6, the synthetic data engine 612 includes images or Gaussian splats 630, caption 632, and visualization 634. In some implementations, two or more of the images or Gaussian splats 630, the caption 632, and the visualization 634 may be integrated into a single component. In some implementations, one or more of the images or Gaussian splats 630, the caption 632, and the visualization 634 may be implemented using any number of computing devices such as the computing device 200 shown in FIG. 2. For example, one or more of the images or Gaussian splats 630, the caption 632, and the visualization 634 may be distributed among a number of computing devices.

The images or Gaussian splats 630 represent potential outputs or intermediate representations generated by the synthetic data engine 612 or the 3D reconstruction engine 626. Images are standard 2D visual representations, while Gaussian Splatting is a technique for rendering novel 3D views efficiently from a set of oriented 3D Gaussians learned from images. These may serve as inputs for generating further synthetic data or for direct visualization 634.

The images or Gaussian splats 630 may be generated based on inputs to the synthetic data engine 612 or 3D reconstruction engine 626. They may interact with the caption 632 component, providing the visual basis for generating descriptive text. They may serve as input to the visualization 634 component for rendering.

In some implementations, the synthetic data engine 612 might generate diverse images depicting specific infrastructure assets under varied conditions based on textual prompts or parameters. In some implementations, Gaussian splats might be used to render photorealistic novel views of a reconstructed scene, facilitating virtual inspection or data augmentation.

The caption 632 represents textual descriptions generated to accompany visual data, such as the images or Gaussian splats 630. This component, part of the synthetic data engine 612 or utilizing the MLLM 618, automatically generates natural language captions describing the content of an image or a rendered view. This facilitates data annotation, indexing, or the creation of multimodal datasets. The caption 632 component may receive visual input (e.g., the images or Gaussian splats 630). It outputs textual captions, which might be stored alongside the visual data in the data layer 606 or used in conjunction with the visualization 634.

In some implementations, the caption 632 component may be trained to generate detailed descriptions focused on specific aspects relevant to infrastructure assessment, such as noting the presence and condition of assets. In some implementations, the generated captions might be used to automatically create question-answering pairs for training or evaluating VLMs.

The visualization 634 represents the output rendering generated by the synthetic data engine 612 or other components such as the tool layer 610. This may include displaying generated images, rendering novel views from Gaussian splats, or creating other visual representations of data or analysis results. The visualization 634 may facilitate users understanding complex data or simulated scenarios. The visualization 634 component receives data to be visualized, such as the images or Gaussian splats 630, augmented with captions 632 or analysis results. The output is a visual rendering, which might be displayed within the client 604 interface or saved as an image or video file.

In some implementations, the visualization 634 may involve rendering interactive 3D scenes based on reconstructed models or synthetic data, allowing users to navigate and inspect the environment virtually. In some implementations, the visualization 634 might overlay analytical results, such as heatmaps of LTS scores or highlighted non-compliant assets, onto images or 3D views.

In operation, a user interacting with the client 604 may pose a query, including multimodal input such as an image. The query is processed by the AI chat agent 602. The processing layer 608, using the MLLM 618 and reasoning engine 620, interprets the query, retrieves relevant information from the knowledge database 614 and possibly the solution database 616 in the data layer 606, and determines if specialized tools are required. If visual analysis is required, it might invoke the computer vision backbone 624; if 3D understanding is required, it might use the 3D reconstruction engine 626 or 3D scene graph engine 628 via the tool layer 610. The synthetic data engine 612 might be used to generate examples or visualizations 634 based on images or splats 630 and captions 632. The processing layer 608 integrates the results and generates a response, which is sent back to the client 604 for display.

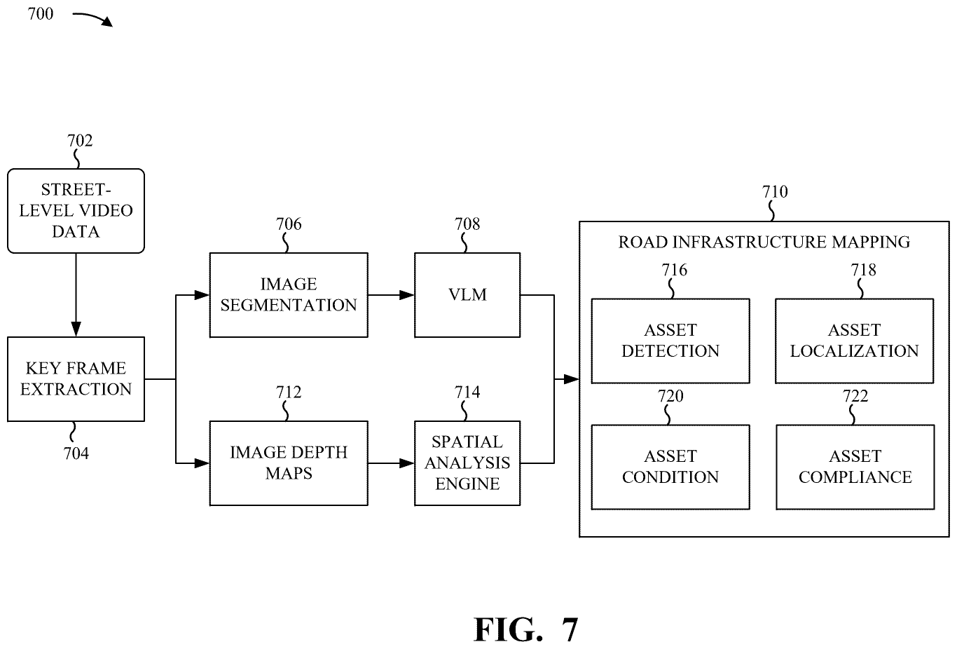

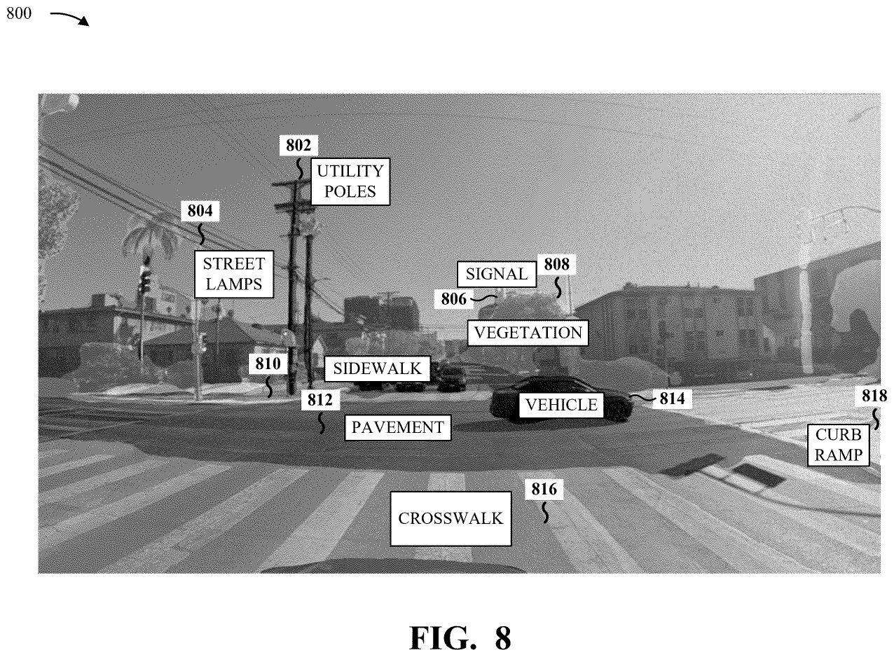

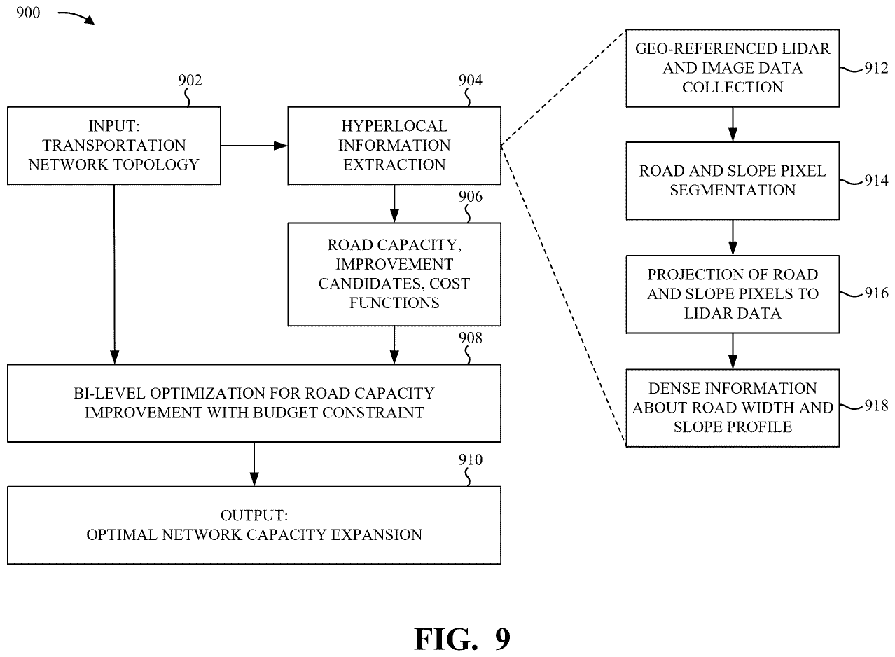

FIG. 7 is a data flow diagram of an example of an AI-based infrastructure mapping process 700 associated with AI-driven support for infrastructure management. The road infrastructure mapping process 700 illustrates a sequence of operations that may be performed, for example, by the infrastructure planning support system 102 shown in FIG. 1, the AI system 300 shown in FIG. 3, or the AI system 600 shown in FIG. 6, to automatically map and assess road infrastructure assets using artificial intelligence techniques applied to street-level video data 702 and image depth maps 712. The road infrastructure mapping process 700 may include operations including a key frame extraction operation 706, an image segmentation operation 710, analysis by a VLM 708, spatial analysis using a spatial analysis engine 714 informed by image depth maps 712, and culminate in outputs related to asset detection 716, asset localization 718, asset condition 720, and asset compliance 722.

The road infrastructure mapping process 700 represents a workflow for transforming raw visual data into structured assessments of infrastructure assets within a transportation network environment. This process may be implemented using software modules, potentially including AI components, executing on one or more computing devices similar to the computing device 200 shown in FIG. 2. The road infrastructure mapping process 700 may be configured to automate parts of the infrastructure inventorying and assessment tasks traditionally performed manually, aiming to improve efficiency, consistency, and coverage. The process may generate output data suitable for multi-objective infrastructure management operations.

The road infrastructure mapping process 700 may interact with various data sources and system components. It receives street-level video data 702 as its primary input. Internally, it processes this data through stages including the key frame extraction operation 706, which feeds into parallel paths including an image segmentation operation 710 and analysis by VLM 708, and spatial analysis by the spatial analysis engine 714, which utilizes image depth maps 712. The final outputs include structured information about detected assets, their locations, conditions, and compliance status.

In some implementations, the road infrastructure mapping process 700 may be tailored to identify and assess assets relevant to Complete Streets initiatives, such as sidewalks, crosswalks, bike lanes, and curb ramps. For example, the VLM 708 and the spatial analysis engine 714 may be configured with criteria based on ADA standards or local design guidelines to determine asset compliance 722. In some implementations, the road infrastructure mapping process 700 may be integrated with a larger infrastructure planning support system, providing automatically generated asset data to update inventories stored in a data layer like 116 or 306. In some implementations, the outputs of the road infrastructure mapping process 700 may feed into subsequent analyses, such as LTS calculation or network importance scoring, performed by an asset evaluation engine like 118 or 308.

The street-level video data 702 serves as the initial input for the road infrastructure mapping process 700. This data may represent video footage captured by cameras mounted on vehicles, such as those used in mobile mapping systems, or potentially from other sources such as autonomous robots or pedestrian-carried devices. The street-level video data 702 provides dynamic, ground-level visual information about the transportation network environment and the infrastructure assets within it. This input may be part of the multimodal input data received by the system.

The street-level video data 702 may be provided to the key frame extraction operation 706. This video data contains the visual information from which individual frames are selected for detailed analysis, including the image segmentation operation 710 and spatial analysis using image depth maps 712. In some implementations, the street-level video data 702 may itself be used to generate the image depth maps 712. An AI component, such as a CV model for depth estimation, may analyze individual frames or sequences of frames from the video to infer the depth of each pixel. This process, which may be referred to as monocular or self-supervised depth estimation, may leverage cues like perspective, occlusion, or texture gradients within the imagery to create a dense map where pixel intensity corresponds to the estimated distance of that point from the camera. This generated depth information provides a 3D understanding of the scene derived solely from 2D image data.

In some implementations, the street-level video data 702 may be captured using GoPro cameras or similar high-resolution video recorders synchronized with GPS/IMU systems for geo-referencing. For example, video might be recorded at 30 frames per second alongside 15 Hz GPS data, requiring downsampling during key frame extraction operation 706. In some implementations, the street-level video data 702 may be pre-processed before key frame extraction operation 706, potentially including stabilization, color correction, or preliminary filtering to enhance quality. In some implementations, multiple video streams, potentially from different camera angles on a mobile mapping system, might constitute the street-level video data 702.

The image depth maps 712 represent spatial information derived from image data, estimating the distance of objects or surfaces from the camera for each pixel. These maps may be generated using AI-based depth estimation models, such as Depth Anything V2 or similar techniques, applied to individual image frames, potentially the key frames selected by the key frame extraction operation 706. The image depth maps 712 provide three-dimensional context that complements the two-dimensional visual information in the images. The AI component may include a CV model for depth estimation.

The image depth maps 712 may be utilized as input by the spatial analysis engine 714. The depth information may facilitate the spatial analysis engine 714 in performing geometric measurements, assessing spatial relationships, or refining localization estimates based on visual data. For example, depth information may aid in estimating the dimensions of assets or assessing slopes. In some implementations, the image depth maps 712 may be generated on-the-fly as needed by the spatial analysis engine 714 or pre-computed and stored alongside the corresponding image frames. In some implementations, the accuracy of the image depth maps 712 may depend on the specific depth estimation model used and the quality of the input imagery. Monocular depth estimation from single images may provide relative depth, while stereo vision or other multi-view techniques might yield metric depth if available. In some implementations, depth information from LiDAR data, if available and aligned with the images, could be used instead of or in combination with image-derived depth maps.

The key frame extraction operation 706 may include selecting specific frames from the input street-level video data 702 for detailed analysis. This operation may be implemented as a software module that analyzes the video stream and applies criteria to choose representative or informative frames, reducing redundancy and computational load compared to processing every single frame. The selection criteria may be based on factors such as time intervals, distance traveled, changes in visual content, or GPS sampling rates. The key frame extraction operation 706 receives the street-level video data 702 as input. It outputs a set of selected key frames, which are then passed to both the image segmentation operation 710 and the spatial analysis engine 714 for further processing. This configuration provides that both semantic and spatial analyses are performed on the same relevant snapshots of the environment.

In some implementations, the key frame extraction operation 706 may synchronize frame selection with available GPS data, so each selected frame has associated geographic coordinates. For example, frames might be extracted only when a new GPS reading is available. In some implementations, the key frame extraction operation 706 may employ content-based analysis to select frames that contain changes or depict infrastructure assets clearly, potentially discarding frames with motion blur or occlusions. In some implementations, the rate of the key frame extraction operation 706 may be adaptive based on the speed of the data collection vehicle or the density of infrastructure features.

The VLM 708 represents an AI component specialized in interpreting visual information using language-based understanding and reasoning. The VLM 708 may be, be similar to, include, or be included in the large vision language model 404, the AI component 122, the AI agent network 314, or the MLLM 618. It may be configured to analyze image content, particularly the outputs of the image segmentation operation 710, to perform tasks such as identifying asset types, assessing qualitative conditions, or interpreting contextual cues based on learned knowledge and potentially guided by prompts or RAG techniques.

The VLM 708 receives input from the image segmentation operation 710, likely in the form of segmented images or masks highlighting specific regions of interest. Based on its analysis, the VLM 708 generates outputs related to asset detection 716 (identifying what assets are present) and asset localization 718 (determining where they are conceptually within the scene, potentially refined later). These outputs constitute part of the identified attribute set for infrastructure assets.

In some implementations, the VLM 708 may be used to classify the type of crosswalk markings, assess the condition of pavement markings based on fading, or identify the presence of specific signage based on the segmented image regions. For example, given a segmented region corresponding to a sign, the VLM 708 might identify it as a “Stop Sign” and assess its visibility. In some implementations, the VLM 708 may leverage prompt engineering to tailor its analysis for specific infrastructure assessment tasks, incorporating domain knowledge or regulatory definitions directly into the query. In some implementations, the VLM 708 may interact with the spatial analysis engine 714 to refine asset localization 718 using geometric information.

The image segmentation operation 710 may include processing the key frames provided by the key frame extraction operation 706 to delineate the boundaries of different objects or regions within each image. This operation may be performed using deep learning-based CV models for segmentation, such as Mask2Former, OCR Net, or similar architectures, potentially part of the AI component 122, the AI agent network 314, or the computer vision backbone 624. The image segmentation operation 710 assigns a class label, e.g., ‘road’, ‘sidewalk’, ‘vehicle’, ‘vegetation’, to each pixel or groups pixels into object instances.

The image segmentation operation 710 receives key frames from the key frame extraction operation 706. The output, typically segmentation masks or labeled images identifying distinct infrastructure assets and background elements, is provided as input to the VLM 708 for semantic interpretation and analysis. In some implementations, the image segmentation operation 710 may perform panoptic segmentation, simultaneously identifying object instances and their semantic categories. For example, it could distinguish between individual parked cars while labeling all road surface pixels as ‘road’. In some implementations, the segmentation models may be specifically trained or fine-tuned on datasets relevant to transportation infrastructure, such as Mapillary Vistas, to improve accuracy on domain-specific objects. In some implementations, the output of the image segmentation operation 710 might be used by the spatial analysis engine 714, for example, to define regions for geometric measurement using the image depth maps 712.

The spatial analysis engine 714 may be configured to perform geometric analysis and assessment based on visual data, incorporating spatial context potentially derived from the image depth maps 712. This engine may include algorithms for estimating dimensions, calculating slopes, assessing spatial relationships, evaluating compliance with geometric standards, and refining localization estimates, potentially implemented as software modules within the tool layer 120, 312, or 610. Identifying the at least one attribute set may include extracting precise geometric measurements.

The spatial analysis engine 714 receives key frames from the key frame extraction operation 706 and corresponding image depth maps 712. Based on these inputs, the spatial analysis engine 714 generates outputs concerning the asset condition 720, focusing on geometric aspects or defects identifiable through spatial analysis, and the asset compliance 722, evaluating adherence to geometric standards such as ADA slope or width requirements. It might contribute refined coordinates for the asset localization 718.

In some implementations, the spatial analysis engine 714 may use depth data to estimate the width of a sidewalk identified in a key frame or calculate the cross-slope based on 3D points derived from the depth map. For example, it could analyze the geometry of a segmented curb ramp region using depth information to assess its running slope and cross-slope for ADA compliance. In some implementations, the spatial analysis engine 714 may integrate GPS data associated with the key frames to provide initial geo-referencing for its analyses. In some implementations, the spatial analysis engine 714 may utilize 3D reconstruction techniques based on sequences of key frames and depth maps to build more detailed local geometric models before performing measurements.

The asset detection 716 represents one category of output from the road infrastructure mapping process 700, specifically identifying the types of infrastructure assets present in the analyzed data. This output is primarily generated by the VLM 708 based on its interpretation of segmented image regions. The asset detection 716 may include classifying observed objects into predefined categories such as ‘crosswalk’, ‘traffic signal’, ‘sidewalk’, ‘curb ramp’, etc.,

The asset detection 716 is derived from the analysis performed by the VLM 708. This information forms part of the attribute set identified for each infrastructure asset. The results of the asset detection 716 contribute to the overall output data generated by the system, which may be used for inventory creation, mapping, and further analysis.

In some implementations, the asset detection 716 output may include confidence scores associated with each classification made by the VLM 708. In some implementations, the taxonomy of detectable assets may be configurable or extensible based on project requirements. In some implementations, the asset detection 716 may include hierarchical classification, e.g., identifying a ‘sign’ and further classifying it as a ‘regulatory sign’ and then a ‘stop sign’.

The asset localization 718 represents another category of output, determining the geographic position or location of the detected infrastructure assets. This output may be initially estimated by the VLM 708 based on image context and potentially refined using information from the spatial analysis engine 714, GPS data associated with key frames, or alignment with base map data such as OpenStreetMap. The asset localization 718 provides the spatial coordinates to map the identified assets.

The asset localization 718 is derived from analyses performed by the VLM 708 and potentially the spatial analysis engine 714. This positional information is a component of the attribute set for each asset and contributes to the final output data, often formatted as GeoJSON features with point, line, or polygon geometries. Providing the output data for display may include rendering an interactive map displaying asset locations.

In some implementations, the asset localization 718 may include projecting the 2D location identified in an image onto a 3D coordinate system using the image depth maps 712 or LiDAR data, and then transforming that to geographic coordinates using GPS/IMU data. For example, the centroid of a segmented crosswalk in an image could be projected using depth information and vehicle pose to estimate its real-world latitude and longitude. In some implementations, techniques such as map matching or conflation may be used to align the estimated asset locations with known features in a base map, improving absolute accuracy. In some implementations, the asset localization 718 may include estimating the extent or boundaries of linear or areal features, such as the length of a sidewalk segment or the polygon defining an intersection.

The asset condition 720 represents assessments of the physical state or quality of the detected infrastructure assets. This output is typically generated by the spatial analysis engine 714, potentially complemented by qualitative assessments from the VLM 708. The asset condition 720 may include quantifying defects such as cracks, potholes, uplifts, fading of markings, or structural damage based on geometric measurements or visual analysis. Identifying the at least one attribute set may include assessing a physical condition of the asset.

The asset condition 720 is derived from analyses performed by the spatial analysis engine 714 and potentially the VLM 708. These condition assessments form part of the attribute set for each asset and contribute to the output data used for maintenance prioritization, LTS calculations, and multi-objective infrastructure management operations.

In some implementations, the asset condition 720 for pavement might be evaluated based on the type, severity, and density of cracks detected using the image segmentation operation 710 and potentially the image depth maps 712 for estimating crack width or depth. For example, a condition rating of ‘Good’, ‘Fair’, or ‘Poor’ might be assigned based on predefined criteria. In some implementations, the asset condition 720 for markings might assess fading based on color intensity or contrast analysis performed by the VLM 708 on segmented marking regions. In some implementations, the asset condition 720 for sidewalks might include quantifying uplift height between adjacent slabs using precise geometric measurements derived from the spatial analysis engine 714 or LiDAR data.

The asset compliance 722 represents evaluations of whether detected infrastructure assets adhere to specific predefined standards or regulations, such as ADA accessibility guidelines or MUTCD requirements for signage and markings. This output is often generated by the spatial analysis engine 714, which compares extracted geometric measurements against standard thresholds, potentially guided by contextual information from the VLM 708. Identifying the at least one attribute set may include assessing compliance of the asset with a predefined standard.

The asset compliance 722 is derived from analyses performed primarily by the spatial analysis engine 714, possibly informed by the VLM 708. Compliance status forms a component of the attribute set and is included in the output data, which is valuable for identifying non-compliant infrastructure needing remediation, prioritizing upgrades, and tracking regulatory adherence.

In some implementations, the asset compliance 722 for a curb ramp might be determined by the spatial analysis engine 714 comparing its measured running slope, cross-slope, width, and landing dimensions against ADA standards. For example, a ramp with a cross-slope exceeding 2.08% would be flagged as non-compliant. In some implementations, the asset compliance 722 for signage might include the VLM 708 checking if the detected sign type and text match MUTCD requirements for its location, while the spatial analysis engine 714 (or LiDAR analysis) verifies mounting height and placement. In some implementations, the asset compliance 722 might be assessed based on a combination of VLM-identified features, e.g., presence of tactile warnings, and spatial analysis measurements, e.g., ramp slopes.

In an example operation, the road infrastructure mapping process 700 takes the street-level video data 702, extracts the key frames using a key frame extraction operation 706, performs the image segmentation operation 710, and generates the image depth maps 712. The segmented images are interpreted by the VLM 708 for the asset detection 716 and initial asset localization 718. Concurrently, the spatial analysis engine 714 uses key frames and the image depth maps 712 to assess geometric aspects related to the asset condition 720 and the asset compliance 722, potentially refining the asset localization 718. The combined outputs provide a structured mapping and assessment of infrastructure assets.

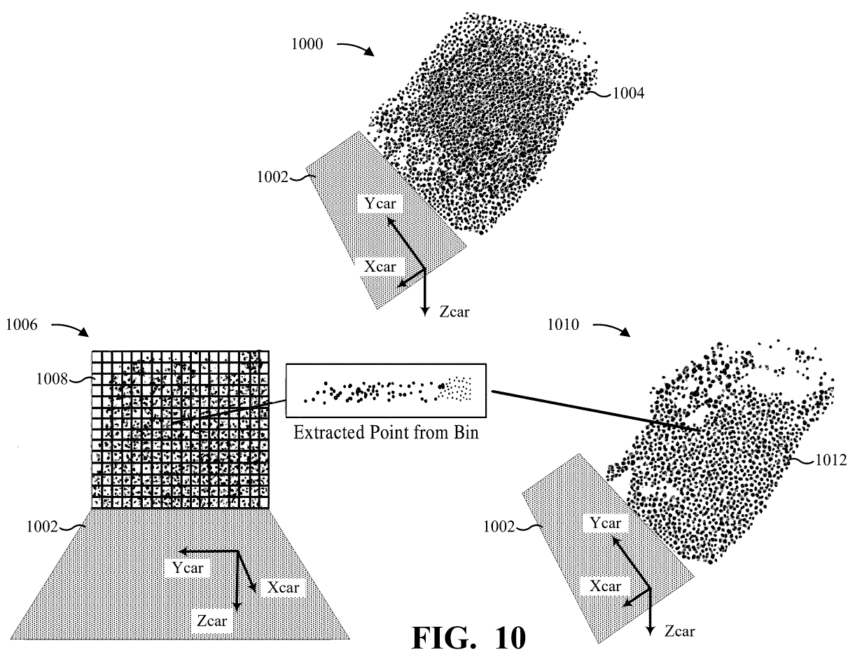

FIG. 8 is a diagram of an example segmentation output 800 associated with AI-driven support for infrastructure management. The segmentation output 800 illustrates how an AI component, similar to the AI component 122, the AI agent network 314, or components within the computer vision backbone 624, may process image data depicting a transportation network environment to identify and delineate various infrastructure assets and environmental features. This visual representation corresponds to the output of operations like the image segmentation operation 710 shown in FIG. 7, providing a basis for identifying attribute sets associated with assets. The segmentation output 800 includes representations of utility poles 802, street lamps 804, a signal 806, vegetation 808, a sidewalk 810, pavement 812, a vehicle 814, a crosswalk 816, and a curb ramp 818.

The segmentation output 800 represents a visual result derived from processing multimodal input data, image data captured within a transportation network environment. An AI component, such as a CV model for segmentation, may analyze the image data to classify pixels or regions corresponding to different objects and surfaces. The distinct labeling or coloring applied to different elements in the segmentation output 800 signifies the identification and classification performed by the AI component. This segmented information may then be used for further analysis, such as extracting attributes for asset evaluation or generating geospatial data. Identifying the at least one attribute set may be based on the AI component.

The segmentation output 800 provides a foundation for identifying various infrastructure assets and their characteristics. For instance, the dimensions, location, and relationships between segmented elements like the sidewalk 810, the crosswalk 816, and the curb ramp 818 may be analyzed to assess accessibility or compliance with standards. The identification of elements like utility poles 802, street lamps 804, the signal 806, and vegetation 808 provides context about the surrounding environment, which may be relevant for safety assessments, maintenance planning, or calculating metrics such as LTS scores. The vehicle 814 represents a dynamic element within the environment.

In some implementations, the generation of the segmentation output 800 may involve sophisticated deep learning models, such as Mask2Former or OCR Net, trained on large datasets containing diverse examples of street scenes and infrastructure assets. These models learn to distinguish between different object classes and accurately delineate their boundaries within the image data. The multimodal input data may include image data. In some implementations, the segmentation process may be combined with depth estimation techniques, using image depth maps 704, to generate 3D segmentations or to extract geometric information directly from the segmented 2D regions. The AI component may include a CV model for segmentation or a CV model for depth estimation.

The utility poles 802 are identified as distinct vertical structures within the segmentation output 800. These represent infrastructure assets commonly found in transportation network environments, often supporting electrical wires, communication cables, or street lighting. Identifying the utility poles 802 may be relevant for asset inventory, maintenance planning, e.g., checking for damage or leaning, and assessing potential obstructions or hazards within pedestrian pathways or vehicle clear zones. The AI component may identify attribute sets associated with these assets.

The utility poles 802 are shown delineated from surrounding elements like the sky, buildings, and vegetation 808. Their location relative to other assets like the sidewalk 810 may be determined from the segmentation output 800. Assessing the physical condition or potential obstruction caused by the utility poles 802 may be part of identifying their attribute set.

In some implementations, the AI component may further classify the type of utility poles 802, e.g., wood, metal, concrete, or identify attached equipment like transformers or communication antennas. In some implementations, geometric measurements, derived from LiDAR data or depth estimation applied to the segmented region, could determine the height or lean angle of the utility poles 802.

The street lamps 804 are identified as specific fixtures, often mounted on the utility poles 802 or dedicated poles, designed to illuminate the roadway and surrounding areas. These represent infrastructure assets whose presence and condition are relevant for assessing nighttime visibility and safety within the transportation network environment. Identifying the street lamps 804 contributes to a comprehensive asset inventory and may inform evaluations related to lighting adequacy or maintenance needs.

The street lamps 804 are shown segmented as distinct objects, associated spatially with the utility poles 802 in the segmentation output 800. Their location and density may be analyzed to assess lighting coverage along the sidewalk 810 or the pavement 812. Evaluating attributes like fixture type, operational status (if discernible), or potential obstructions affecting light distribution might be part of identifying the attribute set for the street lamps 804.

In some implementations, the AI component might assess the type of street lamps 804, e.g., LED, high-pressure sodium, or identify specific fixture models if sufficient visual detail is present. In some implementations, analysis of nighttime imagery, if available as part of the image data, could be used to directly assess the illumination provided by the street lamps 804 and identify non-functional units.

The signal 806 represents a traffic control device, likely a traffic light, identified within the segmentation output 800. This is an infrastructure asset that regulates traffic flow at intersections or pedestrian crossings. Identifying the signal 806, its type, and its state, e.g., red, green, yellow, is relevant for analyzing intersection operations, safety assessments, and inventorying traffic control devices. The AI component may identify attributes associated with the signal 806.

The signal 806 is shown segmented from its supporting structure and the background. Its position relative to the crosswalk 816 and the pavement 812 indicates its role in managing traffic at this location. The identification might include classifying the type of signal head or detecting associated pedestrian signals or APS features. Attributes related to visibility, potential obstructions, or physical condition may be part of the identified attribute set.

In some implementations, the AI component may use Optical Character Recognition (OCR) or symbol recognition to identify associated signage, e.g., turn restrictions, mounted near the signal 806. In some implementations, analysis of video data over time could determine signal phasing and timing, providing input for traffic flow analysis or optimization operations.

The vegetation 808 represents natural elements such as trees, bushes, or grass identified in the scene. While not typically classified as infrastructure assets themselves, the presence and characteristics of vegetation 808 are relevant context within the transportation network environment. The vegetation 808 may impact sight distances, obstruct sidewalks 810 or signs, provide shade, or contribute to the aesthetic quality of the streetscape. Assessing the extent and location of vegetation 808 is useful for maintenance planning, e.g., trimming, and evaluating environmental factors affecting user experience.

The vegetation 808 is shown segmented, distinguishing it from man-made structures and surfaces like buildings, the pavement 812, and the sidewalk 810. Its proximity to infrastructure assets like the utility poles 802, the street lamps 804, the signal 806, and the sidewalk 810 may be analyzed to identify potential encroachments or obstructions. Attributes such as canopy coverage or height might be estimated as part of assessing the impact of the vegetation 808.

In some implementations, the AI component might classify different types of vegetation 808, e.g., trees vs. shrubs, or even attempt species identification if sufficient detail is available. In some implementations, analyzing the vegetation 808 using LiDAR data could provide precise measurements of canopy height, density, and clearances over roadways or pedestrian paths.

The sidewalk 810 is identified as a paved pathway intended for pedestrian use, located alongside the roadway pavement 812. This represents an infrastructure asset whose attributes are relevant for pedestrian safety, accessibility, and mobility. Analyzing the segmented sidewalk 810 facilitates the assessment of its physical condition, dimensions, and compliance with standards such as ADA. Identifying the at least one attribute set may include assessing a physical condition or compliance.

The sidewalk 810 is shown clearly delineated from the adjacent pavement 812, vegetation 808, and utility poles 802. This segmentation facilitates the analysis of its attributes, such as width (distance to curb or property line), presence of obstructions, e.g., from the utility poles 802 or the vegetation 808, surface condition (presence of cracks or defects visible in the image data), and connectivity to other pedestrian facilities like the crosswalk 816 and the curb ramp 818. Extracting precise geometric measurements like cross-slope may require LiDAR data or depth analysis.

In some implementations, the analysis of the segmented sidewalk 810 may involve applying VLM techniques to assess qualitative attributes like perceived roughness or the severity of obstructions. In some implementations, combining the segmentation with LiDAR data may facilitate precise measurement of geometric attributes like width, cross-slope, running slope, and uplift height, which may be used for a rigorous ADA compliance assessment.

The pavement 812 represents the surfaced area of the roadway used by vehicular traffic. This is an infrastructure asset whose condition impacts vehicle operating costs, ride quality, and safety. Identifying and segmenting the pavement 812 facilitates the assessment of its surface condition, e.g., presence of cracks, potholes, rutting, and the analysis of associated features like lane markings or the crosswalk 816.

The pavement 812 is shown segmented from the sidewalk 810, the crosswalk 816, and the vehicle 814. This delineation may be used for a focused analysis of the pavement surface itself. Attributes related to surface distresses, material type (if discernible), and the condition of markings painted on it may be identified as part of its attribute set.

In some implementations, the AI component may classify the severity and type of pavement distresses visible within the segmented pavement 812 area, contributing to a PCI estimation. In some implementations, this estimation may be based on a VLM analysis of image data. The VLM may be configured to evaluate visible Pavement_Distress, such as cracks, gaps, or potholes, and visual Pavement_Roughness. Based on this analysis, the AI component may classify the pavement into a Pavement_Condition descriptor (e.g., ‘Good’, ‘Fair’, or ‘Poor’) and assign an estimated Pavement_Condition_Index category, such as one based on ASTM or MTC ranges. This VLM-based approach, however, may be limited to providing a qualitative assessment rather than a precise quantitative measure for roughness or PCI.

In some implementations, LiDAR data or depth analysis applied to the pavement 812 segment could provide quantitative measures of roughness or rutting depth. In some implementations, future enhancements to the AI component may involve developing and implementing LiDAR-based models to incorporate precise geometric measurements for robust condition assessment. Accurate, quantitative condition assessment may require these geometric measurements, including surface evenness or roughness metrics, such as a standard deviation of elevations that may correlate with an International Roughness Index (IRI). In some implementations, the system may be configured to explore methods of using sensor arrays to assess pavement condition and maintenance deficiencies along pathways or sidewalks, potentially in collaboration with other organizations. This may be complemented by research related to specific distress identification, such as road pothole extraction from mobile mapping sensors and point clouds.

The vehicle 814 represents a dynamic object within the transportation network environment, shown on the pavement 812. While not a fixed infrastructure asset, detecting vehicles is relevant for understanding traffic conditions, assessing potential obstructions or conflicts, and analyzing road usage patterns. The AI component's ability to segment the vehicle 814 demonstrates its capability to distinguish between static infrastructure and dynamic elements.

The vehicle 814 is shown segmented from the pavement 812 and surrounding elements. Its detection might be used in analyses related to traffic density, parking occupancy, or near-miss incident detection if analyzing video data. Attributes like vehicle type might also be identified.

In some implementations, tracking vehicles like the vehicle 814 across multiple frames of video data may facilitate estimation of traffic speeds or flow rates. In some implementations, analyzing the interaction between vehicles and other road users, e.g., pedestrians using the crosswalk 816, could be part of safety analysis or user behavior analysis.

The crosswalk 816 is identified as a designated area for pedestrians to cross the pavement 812, typically marked with paint. This represents an infrastructure asset relevant for pedestrian safety and connectivity. Segmenting the crosswalk 816 facilitates the assessment of its attributes, including marking type, marking condition, surface condition within the crossing, dimensions, and connectivity to sidewalks 810 via features like the curb ramp 818.

The crosswalk 816 is shown segmented on the pavement 812 surface. This configuration may be used for analysis of its specific characteristics as part of its attribute set. The VLM 708, for instance, might classify the marking type, e.g., standard, continental, ladder, and assess the visibility or fading of the markings. The spatial analysis engine 714 might assess the surface condition within the segmented area or, with depth/LiDAR data, measure its dimensions or slope. Assessing compliance may involve checking marking standards or connectivity to accessible curb ramps.

In some implementations, the analysis might include identifying associated traffic control devices, like the signal 806 or pedestrian signals, that govern the crosswalk 816. In some implementations, assessing the presence and condition of APS features associated with the crosswalk 816 may be part of an ADA compliance evaluation.

The curb ramp 818 is identified at the transition point between the sidewalk 810 and the crosswalk 816/pavement 812 level. This is an infrastructure asset designed to provide an accessible route for people using wheelchairs, strollers, or other mobility devices, and its compliance with ADA standards may be assessed. Segmenting the curb ramp 818 facilitates the detailed analysis of its geometric and conditional attributes.

The curb ramp 818 is shown segmented at the edge of the sidewalk 810, adjacent to the crosswalk 816. This identification may be used for a targeted analysis of its attribute set. Attributes may include the ramp type, e.g., perpendicular, parallel, presence and condition of detectable warning surfaces, surface material, surface condition, and geometric measurements like running slope, cross-slope, width, and landing dimensions. Assessing compliance involves comparing these attributes against predefined standards like ADA. Extracting precise geometric measurements may be achieved using LiDAR data or depth analysis.

In some implementations, the VLM 708 might assess qualitative aspects visible in the image data, such as the presence of detectable warnings or apparent obstructions on the landing area. In some implementations, the spatial analysis engine 714, using depth maps 712 or LiDAR data, may calculate the geometric parameters needed to rigorously verify ADA compliance for the curb ramp 818.

FIG. 9 is a data flow diagram of an example of a process 900 associated with AI-driven support for infrastructure management. The process 900 illustrates a workflow for optimal network capacity expansion, executed by systems like the infrastructure planning support system 102 shown in FIG. 1 or the AI system 300 shown in FIG. 3. The process 900 may include receiving input regarding transportation network topology 902, performing hyperlocal information extraction 904, identifying road capacity improvement candidates and cost functions 906, performing bi-level optimization with budget constraints, and generating an output related to optimal network capacity expansion 910. The hyperlocal information extraction 904 operation may itself involve sub-operations including geo-referenced LiDAR and image data collection 912, road and slope pixel segmentation 914, projection 916 of road and slope pixels to LiDAR data, and deriving dense information 918 about road width and slope profile.

The input transportation network topology 902 serves as the foundational structure for the analysis within the process 900. The input transportation network topology 902 may be, be similar to, include, or be included in the network topology 414 shown in FIG. 4. It represents the layout and connectivity of the transportation network environment, defining elements such as road segments and intersections, sourced from GIS databases, OpenStreetMap, or other mapping services. The input transportation network topology 902 provides the framework onto which detailed asset information is mapped and network-level analyses are performed.

The input transportation network topology 902 may provide the initial graph structure used in subsequent operations, particularly the hyperlocal information extraction 904 and the bi-level optimization 908. Network importance scores, used in optimization, may be calculated based on the input transportation network topology 902.

In some implementations, the input transportation network topology 902 may include attributes such as road classifications, speed limits, and lane counts associated with network segments. For example, the topology might distinguish between arterial roads and local streets. In some implementations, multiple network layers representing different modes, e.g., pedestrian, cycling, vehicular, might be included in the input transportation network topology 902.

The hyperlocal information extraction 904 operation may include acquiring and processing detailed, fine-grained data about the infrastructure assets and their immediate surroundings within the transportation network environment defined by the input transportation network topology 902. This operation may be performed by various components of the infrastructure planning support system 102 or AI system 300, leveraging sensor data and AI analysis techniques. The hyperlocal information extraction 904 aims to capture specific attributes relevant for assessing capacity, condition, and potential for improvement, going beyond standard map data. Identifying, based on an AI component and the multimodal input data, at least one attribute set associated with at least one infrastructure asset may be part of this operation.

The hyperlocal information extraction 904 operation receives the input transportation network topology 902 as a framework. It executes a series of sub-operations, detailed as 912 through 918, which involve collecting sensor data (geo-referenced LiDAR and image data collection 912), processing image data (road and slope pixel segmentation 914), fusing image and LiDAR data (projection 916 of road and slope pixels to LiDAR data), and extracting geometric measurements (dense information 918 about road width and slope profile). The output of the hyperlocal information extraction 904 operation, representing the detailed attribute sets, feeds into the operation for identifying road capacity improvement candidates and cost functions 906.

In some implementations, the hyperlocal information extraction 904 operation may focus on assets relevant to Complete Streets or ADA compliance, such as sidewalks, curb ramps, and bike lanes. For example, extracting precise sidewalk width and cross-slope measurements would be part of this operation. In some implementations, the hyperlocal information extraction 904 may utilize autonomous robots operating within the transportation network environment to capture data at ground level, particularly for pedestrian infrastructure. Analyzing sensor data received from the one or more autonomous robots to assess sidewalk surface condition or pedestrian clearway obstruction may occur here.

The road capacity improvement candidates and cost functions 906 operation may include identifying potential infrastructure upgrades based on the extracted hyperlocal information and associating costs with these potential improvements. This operation may involve analyzing the attribute sets from the hyperlocal information extraction 904 operation to pinpoint deficiencies, e.g., narrow road sections, poor pavement condition, non-compliant slopes, or high LTS scores, and determining feasible upgrade options, e.g., widening, resurfacing, slope stabilization. Cost functions may be developed based on the type and extent of the required work, using parameters like excavation volume or required embankment height derived from the hyperlocal information.

The road capacity improvement candidates and cost functions 906 operation receives the detailed asset information from the hyperlocal information extraction 904 operation. It identifies specific locations and types of potential improvements and estimates their associated costs. This information, including the candidate projects and their cost functions, is then provided as input to the bi-level optimization 908 operation.

In some implementations, the identification of candidates may involve comparing extracted asset attributes against predefined standards or desired performance levels. For example, road segments with a width below a certain threshold might be identified as candidates for widening. In some implementations, cost functions may be derived from historical project data or engineering estimation models, considering factors like material costs, labor, and the geometric parameters extracted in the hyperlocal information extraction 904 operation.

The bi-level optimization 908 operation may include performing an optimization analysis to select a beneficial set of road capacity improvements subject to budgetary limitations. This operation may utilize mathematical optimization techniques, such as the MILP formulation described previously or other suitable methods, implemented by the optimization engine 310. The bi-level nature may refer to optimizing at different levels, e.g., selecting projects within regions and allocating budget across regions, incorporating feedback as discussed in the sequential optimization approach. The optimization aims to maximize overall network benefit, based on composite prioritization scores integrating importance and LTS, while respecting the available budget constraint.

The bi-level optimization 908 operation receives the list of improvement candidates and associated cost functions from the road capacity improvement candidates and cost functions 906 operation, along with overall budget constraints. It may also utilize network importance scores derived from the input transportation network topology 902. The output of the bi-level optimization 908 operation is the final plan for optimal network capacity expansion 910, such as a ranked list of recommended capital improvements or a selected set of projects.

In some implementations, the bi-level optimization 908 operation may explicitly model dependencies between projects or consider network effects where improving one segment impacts flow on others. For example, widening consecutive segments might yield synergistic benefits. In some implementations, the bi-level optimization 908 may incorporate multiple objectives, such as maximizing capacity, improving safety (e.g., reducing predicted crash rates), enhancing accessibility (e.g., prioritizing ADA compliance), and promoting equity, using multi-objective optimization techniques.

The optimal network capacity expansion 910 represents the final output data generated by the process 900. The optimal network capacity expansion 910 may be, be similar to, include, or be included in the output 422 shown in FIG. 4. This output details the selected set of infrastructure improvements determined by the bi-level optimization 908 operation to provide a benefit within the given budget. The optimal network capacity expansion 910 provides actionable recommendations for capital improvement planning.

The optimal network capacity expansion 910 is the result generated by the bi-level optimization 908 operation. This output data may be provided for display via a graphical user interface rendered by a computing device, showing the selected projects on an interactive map or as a prioritized list.

In some implementations, the optimal network capacity expansion 910 output may include details such as the specific segments selected for improvement, the type of upgrade recommended, e.g., widening dimensions, estimated costs, and projected benefits or impacts on metrics like capacity, LTS, or safety. In some implementations, the output may be formatted for integration into asset management systems or financial planning tools.

The geo-referenced LiDAR and image data collection 912 represents the initial data acquisition sub-operation within the hyperlocal information extraction 904 operation. This involves capturing sensor data from the transportation network environment using a mobile mapping system equipped with LiDAR sensors, cameras, and positioning systems like GNSS and an IMU. Receiving the multimodal input data comprises receiving data captured by a mobile mapping system including at least one LiDAR sensor and at least one camera. The goal is to obtain synchronized, spatially accurate LiDAR point clouds and corresponding imagery covering the infrastructure assets of interest.

The geo-referenced LiDAR and image data collection 912 operation provides the raw multimodal input data used in subsequent sub-operations. The image data is passed to the road and slope pixel segmentation 914 operation, and both image and LiDAR data are used in the projection 916 of road and slope pixels to LiDAR data and implicitly in deriving the dense information 918.

In some implementations, the geo-referenced LiDAR and image data collection 912 may utilize high-resolution panoramic cameras and multi-beam LiDAR sensors to capture detailed information. For example, a system might use a Velodyne VLP-32C LiDAR and four 8-megapixel cameras. In some implementations, techniques like RTK corrections are used to achieve centimeter-level geo-referencing accuracy.

The road and slope pixel segmentation 914 represents the image processing sub-operation within the hyperlocal information extraction 904 operation. This involves applying AI-based image segmentation models, from the AI component 122 or computer vision backbone 624, to the collected image data. The goal is to classify pixels in the images corresponding to the road surface versus adjacent slopes or other background elements. The AI component may include a CV model for segmentation.

The road and slope pixel segmentation 914 operation receives image data from the geo-referenced LiDAR and image data collection 912 operation. The output, such as segmentation masks identifying road and slope regions within the images, may be used in the projection 916 of road and slope pixels to LiDAR data.

In some implementations, deep learning models like Mask2Former or U-Net architectures, fine-tuned on relevant datasets, may be used for the road and slope pixel segmentation 914. For example, models trained on datasets like Mapillary Vistas might be adapted. In some implementations, the segmentation may distinguish between different types of surfaces, e.g., paved road, unpaved shoulder, vegetated slope.

The projection 916 of road and slope pixels to LiDAR data represents the data fusion sub-operation within the hyperlocal information extraction 904 operation. This involves combining the 2D segmentation results with the 3D LiDAR data using sensor calibration parameters that relate the camera image plane to the LiDAR coordinate system. Each pixel identified as ‘road’ or ‘slope’ in the segmentation mask is projected onto the corresponding 3D points in the LiDAR point cloud, effectively transferring the semantic labels from 2D to 3D.

The projection 916 of road and slope pixels to LiDAR data includes receiving the segmentation masks from the road and slope pixel segmentation 914 operation and the geo-referenced LiDAR data from the geo-referenced LiDAR and image data collection 912 operation. The output is a semantically labeled point cloud where points are tagged as belonging to the road surface or the slope, which feeds into the dense information 918 about road width and slope profile.

In some implementations, the projection may involve handling occlusions or areas where LiDAR points do not correspond directly to image pixels. For example, interpolation or nearest-neighbor assignment might be used. In some implementations, projections from multiple cameras covering different viewpoints may be fused to create a more complete and robust 3D semantic labeling.

The dense information 918 about road width and slope profile may be created during a sub-operation within the hyperlocal information extraction 904 operation, focusing on extracting specific geometric measurements from the labeled LiDAR data. This involves applying algorithms to the semantically tagged point cloud to calculate the width of the road surface at frequent intervals and to characterize the profile or gradient of the adjacent slopes. Extracting, from the LiDAR data, at least one precise geometric measurement may be performed here. Techniques may include horizontal binning and robust edge fitting for width estimation, and grid-based denoising followed by curve or plane fitting for slope profiling.

The dense information 918 about road width and slope profile may be created by receiving the semantically labeled LiDAR data resulting from the projection 916 of road and slope pixels to LiDAR data. It outputs the detailed geometric measurements, which constitute a part of the attribute sets provided by the hyperlocal information extraction 904 operation to the road capacity improvement candidates and cost functions 906 operation.

In some implementations, the road width may be calculated as the perpendicular distance between robustly fitted lines representing the left and right edges of the ‘road’ labeled points within localized sub-maps or bins. For example, width might be measured every meter along the road segment. In some implementations, the slope profile may be represented by polynomial curves fitted to the ‘slope’ labeled points after denoising, providing parameters like gradient and curvature.

In an example operational flow of process 900, the system starts with the input transportation network topology 902. The hyperlocal information extraction 904 operation is initiated, beginning with the geo-referenced LiDAR and image data collection 912 using a mobile mapping system. The collected image data is processed via the road and slope pixel segmentation 914 using AI models. These 2D segmentations are then combined with the 3D LiDAR data in the projection 916 of road and slope pixels to LiDAR data. From the resulting semantically labeled point cloud, the dense information 918 about road width and slope profile may include extracted precise geometric measurements. This hyperlocal information feeds into the road capacity improvement candidates and cost functions 906 operation, identifying potential upgrades and their costs. Finally, the bi-level optimization 908 operation uses this information, along with budget constraints, to determine the optimal network capacity expansion 910 plan.

FIG. 10 is a diagram of an example 1000 associated with processing multimodal data associated with AI-driven support for infrastructure management. The diagram illustrates conceptual operations involved in processing LiDAR data within a localized vehicle coordinate system 1002, as part of operations performed by the infrastructure planning support system 102, the AI system 300, or within the data integration pipeline 114 or 302 or the tool layer 120, 312, or 610. The example 1000 includes an initial point cloud view, a binned point cloud view 1006, and a processed point cloud view 1010, showing transformations applied to LiDAR data represented by an initial point cloud 1004, bins 1008, and a processed point cloud 1012, all relative to the vehicle coordinate system 1002.

The vehicle coordinate system 1002 defines a local frame of reference associated with the mobile mapping system or vehicle capturing the sensor data. The vehicle coordinate system 1002 may be established based on the vehicle's position and orientation at a specific time or location, derived from GNSS and IMU data processed by a data integration pipeline like 114 or 302. As depicted with axes labeled Xcar, Ycar, and Zcar, the vehicle coordinate system 1002 provides a consistent reference for analyzing sensor data in the immediate vicinity of the vehicle, which may facilitate localized processing operations such as feature extraction or denoising. Transforming global LiDAR data into the vehicle coordinate system 1002 may be a precursor operation performed, for example, by the 3D reconstruction engine 626 or within the data integration pipeline 114 or 302.

The vehicle coordinate system 1002 may facilitate localized analysis by simplifying geometric calculations relative to the sensor platform. Operations such as identifying road edges, calculating sidewalk cross-slopes, or detecting obstructions may be more readily performed within this local frame before transforming results back into a global coordinate system for storage in the data layer 116 or 306. The axes Xcar, Ycar, and Zcar may represent directions relative to the vehicle, such as forward, sideways, and vertical, respectively.

In some implementations, the specific orientation of the vehicle coordinate system 1002 axes, including Xcar, Ycar, and Zcar, may follow standard conventions used in robotics or automotive engineering, such as SAE J670. For example, Xcar might point forward, Ycar might point left, and Zcar might point up. In some implementations, multiple local coordinate systems might be used, such as separate frames for the LiDAR sensor itself and the vehicle body, which would involve transformations between them based on known calibration parameters. The transformation from a global coordinate system, such as latitude, longitude, and altitude, to the vehicle coordinate system 1002 may involve rotation and translation based on the vehicle's pose, including position and orientation, obtained from the navigation sensors.

The initial point cloud 1004 represents a collection of 3D points captured by a LiDAR sensor, corresponding to a localized sub-map or segment of data transformed into the vehicle coordinate system 1002. This data may be part of the multimodal input data received by the system, the LiDAR data. The initial point cloud 1004 depicts the raw or partially processed geometric structure of the scanned environment, including infrastructure assets and noise or unwanted returns.

The initial point cloud 1004 may serve as the input for further processing operations illustrated in the binned point cloud view 1006. The initial point cloud 1004 contains the spatial information from which attributes or features are extracted. For example, points corresponding to road surfaces, slopes, or specific assets may be present within the initial point cloud 1004. This data may reside temporarily in memory during processing or be retrieved from the data layer 116 or 306.

In some implementations, the initial point cloud 1004 may already have undergone some pre-processing, such as filtering or downsampling, performed by the data integration pipeline 114 or 302. The density and accuracy of the initial point cloud 1004 depend on the specifications of the LiDAR sensor used during the geo-referenced LiDAR and image data collection 912. In some implementations, the initial point cloud 1004 may be colorized using corresponding image data, although color is not explicitly shown in this simplified depiction.

The binned point cloud view 1006 illustrates a spatial partitioning technique applied to the initial point cloud 1004. The space occupied by the point cloud is divided into a grid of discrete cells or bins 1008, shown here as a 2D grid projected onto the Xcar-Ycar plane relative to the vehicle coordinate system 1002. This binning may facilitate structured processing, such as analyzing points within each bin 1008 individually, for tasks like denoising or feature extraction. The label “Extracted Point from Bin” suggests that specific points are selected or processed from within these bins 1008. This technique may be part of algorithms used by the AI component 122 or the tool layer 120 for extracting precise geometric measurements or identifying attribute sets.

The bins 1008 spatially organize the points from the initial point cloud 1004. Algorithms may iterate through each bin 1008 to perform operations. For example, in grid-based denoising for slope profile extraction, only points with extreme coordinates within each bin 1008 might be retained, which would filter out noise while preserving the underlying surface structure. This operation contributes to deriving dense information 918 about road width and slope profile. The size and dimensionality, such as 2D or 3D, of the bins 1008 are parameters that may be adjusted based on the specific processing goal and data characteristics.

In some implementations, the bins 1008 may represent voxels in a 3D grid rather than the 2D grid shown. Voxelization is a common technique for regularizing and processing point cloud data. In some implementations, statistical analysis may be performed on the points within each bin 1008, such as calculating the mean elevation or fitting a local surface patch. In some implementations, the binning process shown might be applied to points identified as belonging to a particular class, for example, ‘slope’ points obtained after semantic segmentation and projection 916 of road and slope pixels to LiDAR data, to extract features relevant only to that class.

The processed point cloud view 1010 depicts the result after applying the processing technique involving the bins 1008 to the initial point cloud 1004, again shown relative to the vehicle coordinate system 1002. The processed point cloud 1012 represents a cleaner, sparser, or feature-enhanced version of the original data. For instance, if the process was grid-based denoising, the processed point cloud 1012 would primarily contain points representing the underlying surfaces with noise removed, suitable for subsequent analysis like slope profile fitting.

The processed point cloud 1012 is the output of the binning and extraction or filtering process applied in the binned point cloud view 1006. This refined data may then be used for subsequent operations in the overall workflow, such as calculating precise geometric measurements, for example, slope parameters by fitting curves or planes to the points in the processed point cloud 1012, identifying specific features, or generating the output 422. This data might be passed to the asset evaluation engine 118 or 308 or stored in the data layer 116 or 306.

In some implementations, the processed point cloud 1012 might represent extracted feature points, such as edge points identified along road boundaries within each bin 1008, which are then used for robust line fitting, for example, using a RANSAC algorithm, to determine road width. In some implementations, the transformation from the initial point cloud 1004 to the processed point cloud 1012 might involve statistical filtering within bins, such as keeping only points close to the mean or median within each bin 1008 to remove outliers. The nature of the processed point cloud 1012 depends directly on the algorithm applied using the bin structure.

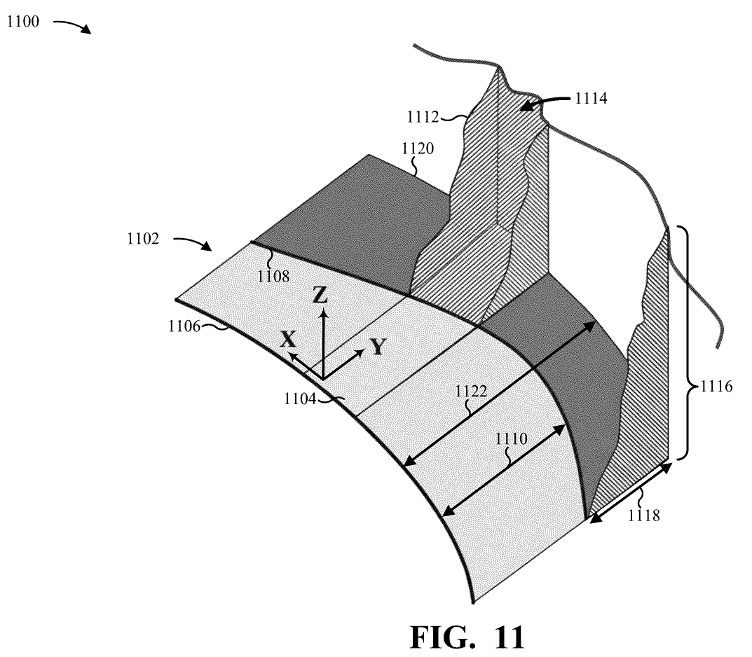

FIG. 11 is a diagram of an example 1100 associated with AI-driven support for infrastructure management. The example 1100 illustrates geometric parameters that may be derived from processed sensor data, such as LiDAR data, and used in multi-objective infrastructure management operations, for planning and estimating costs associated with road capacity expansion or widening projects. The example 1100 includes representations of a road segment 1102, a local coordinate system 1104, a left edge 1106, a right edge before widening 1108, an initial width 1110, an existing side slope 1112, a side slope excavation volume 1114, a right edge after widening 1116, an extended road width 1118, an embankment wall height 1120, and a final width 1122. These parameters may be calculated by components such as the asset evaluation engine 118 or the asset evaluation engine 308 or within the tool layer 120, the tool layer 312, or the tool layer 610 based on attribute sets identified by the AI component 122 or the AI agent network 314.

The road segment 1102 represents a section of roadway within the transportation network environment that is being considered for capacity enhancement or widening. The road segment 1102 may be identified based on analysis performed by the AI system, flagged due to factors like high traffic volume, low LTS scores, or identified network bottlenecks. The geometry of the road segment 1102, including its initial dimensions and surrounding terrain, serves as the baseline for planning improvements. This may correspond to an edge in the network topology 414 or the input transportation network topology 902.

The road segment 1102 provides the context for deriving the various geometric parameters shown. Its initial geometry, defined by the left edge 1106 and the right edge before widening 1108, forms the basis for calculating the initial width 1110. The analysis of the road segment 1102 and its adjacent side slope 1112 informs the calculation of the side slope excavation volume 1114 and the embankment wall height 1120 required for the planned expansion defined by the right edge after widening 1116.

In some implementations, the road segment 1102 may represent a specific edge in a graph representation of the transportation network, retrieved from the data layer 116 or the data layer 306. For example, the road segment 1102 could be a section of a hillside street identified as a candidate for improvement based on prioritization scores generated by the asset evaluation engine 118 or the asset evaluation engine 308. In some implementations, the analysis may consider variable widening along the length of the road segment 1102 based on localized constraints or requirements. In some implementations, the properties of the road segment 1102, such as pavement condition, part of its attribute set, may be considered alongside geometric expansion in the planning process.

The local coordinate system 1104, depicted with X, Y, and Z axes, provides a frame of reference for defining and measuring the geometric parameters associated with the road segment 1102. The local coordinate system 1104 may be, be similar to, include, or be included in the vehicle coordinate system 1002 shown in FIG. 10, established relative to the road segment 1102 itself or the path of a mobile mapping system. The local coordinate system 1104 may facilitate precise calculations of dimensions, slopes, and volumes within the context of the specific road section being analyzed.

The local coordinate system 1104 serves as the reference frame for defining the positions of the left edge 1106, the right edge before widening 1108, and the right edge after widening 1116, as well as the profile of the side slope 1112. Measurements such as the initial width 1110, the final width 1122, the extended road width 1118, the side slope excavation volume 1114, and the embankment wall height 1120 are calculated based on coordinates defined within this local coordinate system 1104.

In some implementations, the local coordinate system 1104 may be aligned with the centerline or an edge of the road segment 1102, with axes representing longitudinal, transverse, and vertical directions. For example, the Y-axis might represent the direction along the road, X the transverse direction, and Z the vertical direction. In some implementations, transformations between the local coordinate system 1104 and a global coordinate system, e.g., State Plane or UTM, may be maintained to geo-reference the calculated parameters.

The left edge 1106 represents one of the boundaries defining the initial extent of the road segment 1102 before any widening. This edge may correspond to a physical feature such as a curb line, the edge of the paved surface, or a painted line, identified from the multimodal input data, using the AI component 122 or the AI agent network 314 for segmentation or edge detection. The left edge 1106, along with the right edge before widening 1108, defines the baseline geometry from which expansion is measured.

The left edge 1106, together with the right edge before widening 1108, determines the initial width 1110 of the road segment 1102. Its position within the local coordinate system 1104 serves as a reference point for calculating the final width 1122 and the extended road width 1118.

In some implementations, the left edge 1106 may be identified from LiDAR data using robust line fitting algorithms applied to points segmented as ‘road edge’ or ‘curb’. For example, a RANSAC algorithm might identify the line representing the left edge 1106 even with gaps caused by parked cars or driveways. In some implementations, the definition of the left edge 1106 might vary depending on context, e.g., edge of travel lane versus edge of pavement including shoulder.

The right edge before widening 1108 represents the boundary opposite the left edge 1106, defining the other side of the road segment 1102's initial extent. Similar to the left edge 1106, the right edge before widening 1108 may correspond to a physical feature identified from sensor data using AI-driven analysis. It serves as a reference for calculating the amount of widening required.

The right edge before widening 1108, in conjunction with the left edge 1106, defines the initial width 1110. Its position relative to the planned right edge after widening 1116 determines the extended road width 1118. The location of the right edge before widening 1108 influences the calculation of the side slope excavation volume 1114 needed to reach the profile of the side slope 1112.

In some implementations, identifying the right edge before widening 1108 may involve similar techniques as identifying the left edge 1106, using segmentation and line fitting on LiDAR data. In some implementations, the accuracy of locating the right edge before widening 1108 is relevant for precise estimation of construction quantities and costs.

The initial width 1110, labeled as w (x) a, represents the original width of the road segment 1102 before the proposed capacity expansion. This measurement is derived from the positions of the left edge 1106 and the right edge before widening 1108 within the local coordinate system 1104. The initial width 1110 is a parameter in the attribute set of the road segment 1102 and serves as the baseline for calculating the extent of widening and associated costs. Extracting precise geometric measurements like the initial width 1110 may be performed using LiDAR data.

The initial width 1110 is determined by the distance between the left edge 1106 and the right edge before widening 1108. It is used, along with the final width 1122, to calculate the extended road width 1118. The initial width 1110 may be a factor considered by the asset evaluation engine 118 or the asset evaluation engine 308 when assessing the existing capacity or level of service of the road segment 1102.

In some implementations, the initial width 1110 may vary along the length of the road segment 1102, represented by the notation w (x) a indicating width as a function of longitudinal position x. This variation might be captured by calculating width at multiple cross-sections. In some implementations, the initial width 1110 might refer to the travel lane width, excluding shoulders or parking lanes, depending on the analysis context.

The side slope 1112 represents the profile of the existing terrain adjacent to the right edge before widening 1108. This profile may be extracted from the 3D data 410, such as LiDAR point clouds, after processing steps like the road and slope pixel segmentation 914, the projection 916 of road and slope pixels to LiDAR data, and denoising as illustrated in FIG. 10, resulting in the dense information 918 about road width and slope profile. The geometry of the side slope 1112 is a factor for determining the amount of earthwork required for widening.

The side slope 1112 defines the existing ground surface that should be modified to accommodate the road widening. Its shape and extent influence the calculation of the side slope excavation volume 1114 to cut back the slope to accommodate the extended road width 1118 and the embankment wall height 1120 if stabilization is advised.

In some implementations, the side slope 1112 profile may be represented mathematically, e.g., using polynomial curve fitting applied to denoised LiDAR points corresponding to the slope. For example, algorithms might extract a smooth, continuous profile from points remaining after grid-based denoising. In some implementations, the analysis might consider the material composition or stability of the side slope 1112, using additional data sources, when calculating excavation difficulty or stabilization requirements.

The side slope excavation volume 1114 represents the calculated volume of earth or rock that must be removed from the existing side slope 1112 to create space for the widened road section, up to the right edge after widening 1116. This volume is a factor in estimating the cost and duration of the construction project and is derived based on the geometric difference between the existing side slope 1112 profile and the planned final cross-section of the widened road, including any required stable slope angles or retaining structures. This may be part of the cost functions 906 used in the bi-level optimization 908.

The side slope excavation volume 1114 is calculated based on the geometry of the side slope 1112, the position of the right edge before widening 1108, the position of the right edge after widening 1116, and the design parameters for the final slope or retaining structure, represented by the embankment wall height 1120. This calculation provides an input for cost estimation within the road capacity improvement candidates and cost functions 906 operation.

In some implementations, the calculation of the side slope excavation volume 1114 may use standard civil engineering methods, such as the average end area method or digital terrain model differencing, applied to the 3D data representing the existing and proposed geometries. For example, volume could be calculated by integrating the cross-sectional area of excavation along the length of the road segment 1102. In some implementations, the calculation might differentiate between different material types, e.g., soil vs. rock, which have different excavation costs.

The right edge after widening 1116 represents the planned new boundary of the road segment 1102 on the right side after the capacity expansion project is completed. This defines the target extent of the widened roadway and is determined based on design requirements, such as desired lane widths, shoulder widths, or the addition of facilities like bike lanes or sidewalks.

The right edge after widening 1116 defines the outer limit for calculating the extended road width 1118 and the final width 1122. Its position relative to the existing side slope 1112 dictates the necessary side slope excavation volume 1114 and the required embankment wall height 1120. The definition of the right edge after widening 1116 is an input for the scenario modeling or optimization operations within the tool layer 120 or the tool layer 312.

In some implementations, the location of the right edge after widening 1116 may be determined through an optimization process that balances capacity gains with construction costs and environmental impacts. For example, the optimization engine 310 might determine the optimal degree of widening. In some implementations, the design may include variable widening, meaning the position of the right edge after widening 1116 changes along the length of the road segment 1102.

The extended road width 1118 represents the additional width added to the road segment 1102 during the widening project. The extended road width 1118 is calculated as the difference between the final width 1122 and the initial width 1110, or equivalently, the distance between the right edge before widening 1108 and the right edge after widening 1116. This parameter, referred to as “road extension magnitude” in some contexts, quantifies the scale of the expansion.

The extended road width 1118 is directly related to the planned capacity increase and influences the required earthwork, including the side slope excavation volume 1114, and the need for structures like retaining walls indicated by the embankment wall height 1120. It is an output of the design process or input to the cost estimation within the road capacity improvement candidates and cost functions 906 operation.

In some implementations, the extended road width 1118 may be determined based on specific objectives, such as adding a standard-width travel lane, a bike lane, or a sidewalk. For example, extending the width by 12 feet might accommodate an additional travel lane. In some implementations, constraints such as right-of-way limits or environmental sensitivities might limit the maximum feasible extended road width 1118.

The embankment wall height 1120 represents the vertical height of a retaining structure that may be required to support the widened road segment 1102 or to stabilize the cut slope resulting from the excavation. This parameter is determined by the difference in elevation between the right edge after widening 1116 and the stable angle of repose of the excavated side slope 1112, or the base of the required fill embankment. The embankment wall height 1120 is a design parameter and a factor in the construction cost, included in cost functions 906.

The embankment wall height 1120 depends on the extended road width 1118, the geometry of the existing side slope 1112, and the geotechnical properties of the soil or rock. Its calculation informs the structural design of the retaining wall and contributes to the overall estimated project cost.

In some implementations, the need for and height of an embankment wall, the embankment wall height 1120, might be determined based on predefined slope stability criteria or minimum setback requirements. For example, if a stable cut slope cannot be achieved within the available right-of-way, a retaining wall becomes a consideration. In some implementations, different types of retaining structures, e.g., gravity walls, cantilever walls, mechanically stabilized earth (MSE) walls, might be considered, each with different cost implications related to the embankment wall height 1120.

The final width 1122, labeled Wfinal, represents the total width of the road segment 1102 after the planned widening is completed. The final width 1122 is the sum of the initial width 1110 and the extended road width 1118, determined by the distance between the left edge 1106 and the right edge after widening 1116. This parameter defines the resulting capacity or functionality of the improved road segment.

The final width 1122 is a design parameter determined by the objectives of the capacity expansion project, such as accommodating projected traffic volumes or incorporating specific Complete Streets features. It dictates the required extended road width 1118 and consequently influences the associated construction costs, including the side slope excavation volume 1114 and the embankment wall height 1120. The final width 1122 may be used by the asset evaluation engine 118 or the asset evaluation engine 308 to estimate the improved capacity or LTS score of the road segment 1102.

In some implementations, the target final width 1122 may be based on standard design guidelines for the road's classification and expected usage. For example, design manuals might specify minimum lane and shoulder widths based on traffic volume and speed. In some implementations, the final width 1122 might be optimized as part of the bi-level optimization 908 to achieve a balance between capacity improvement and budget constraints.

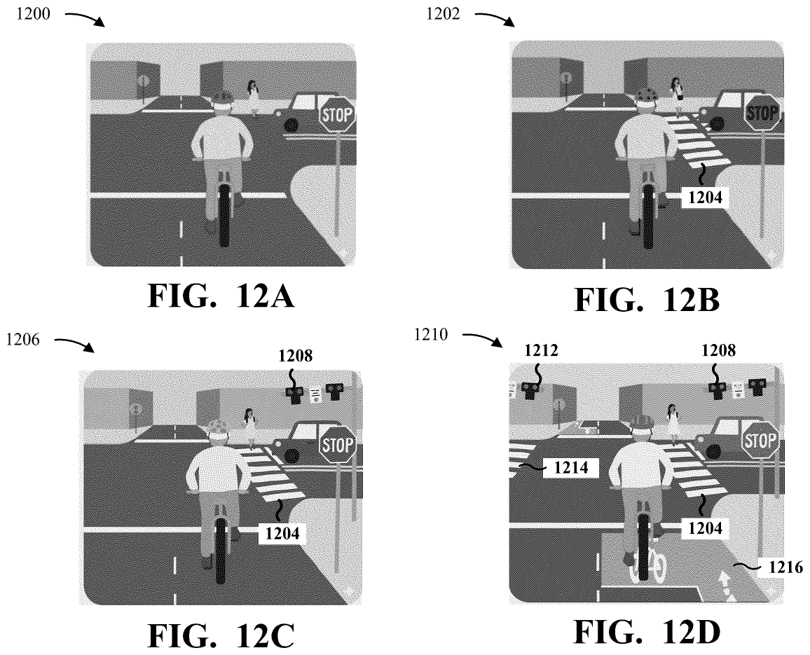

FIG. 12A through FIG. 12D are diagrams showing examples of stress scenarios associated with AI-driven support for infrastructure management. These diagrams illustrate different levels of perceived stress for cyclists or pedestrians at intersections based on the presence and type of infrastructure, corresponding to LTS scores that may be determined by the asset evaluation engine 118 or 308 as part of generating output data associated with a multi-objective infrastructure management operation. Determining an LTS score may be based on the attribute sets identified by the AI component 122.

In some implementations, the asset evaluation engine 118 may be configured to determine enhanced LTS scores that account for asset-specific indicators. For Sidewalk LTS, the asset evaluation engine 118 may separately evaluate left and right sidewalks along a network segment. This evaluation may be based on multiple indicators, including, but not limited to, obstruction presence, cracking or gaps, sidewalk width, surface integrity, adjacent lane count, and vehicular speed. The final Sidewalk LTS score for the segment may be determined as the maximum value among these core indicators.

For Bicyclist LTS, the scoring may combine infrastructure-based attributes, such as bikeway type, speed limit, and lane count, with perceptual stress factors, including lighting, visibility, and lane obstructions. The final Bicyclist LTS score may be determined as the maximum score among the infrastructure factors and the perceptual factors. For Crosswalk LTS, the asset evaluation engine 118 may integrate standard logic, such as logic based on control type, lane count, and speed, with supplementary contextual attributes. These supplementary attributes may include, but are not limited to, marking condition, the number of connected streets, or the presence of control points.

FIG. 12A shows an example intersection scenario 1200 representing LTS 2, classified as “Less Stressful”. This scenario may depict a marked crossing, with assistive signals or warnings, contributing to a moderate level of comfort for users such as cyclists or pedestrians. The asset evaluation engine 118 or 308 may calculate this LTS score based on attributes identified from multimodal input data characterizing the intersection's features.

FIG. 12B shows an example intersection scenario 1202 representing LTS 4, classified as “Most Stressful”. This scenario illustrates a situation with minimal or no accommodations for vulnerable road users, such as a cyclist crossing a busy street with a basic crosswalk 1204 and high vehicle speeds or volumes, leading to a high stress level. The system may identify the lack of specific safety features, leading the asset evaluation engine 118 or 308 to assign a high LTS score.

FIG. 12C shows an example intersection scenario 1206 representing LTS 1, classified as “Stress Free”. This scenario illustrates conditions with specific accommodations for both walking and bicycling, such as a clearly marked crosswalk 1204, dedicated bike signals 1208, and traffic calming measures, resulting in a low stress level suitable for users of various ages and abilities. The presence of these attributes, identified by the AI component 122, may lead the asset evaluation engine 118 or 308 to determine a low LTS score.

FIG. 12D shows an example intersection scenario 1210 representing LTS 3, classified as “Medium Stressful”. This scenario may depict a marked crosswalk 1204, possibly only on one side or lacking a dedicated crossing signal 1212, alongside other features such as bike signals 1208, markings 1214, and guidance elements 1216, but still presenting challenges that increase stress for some users. The asset evaluation engine 118 or 308 may evaluate the combination of existing features, identified from attribute sets, to assign this intermediate LTS score.

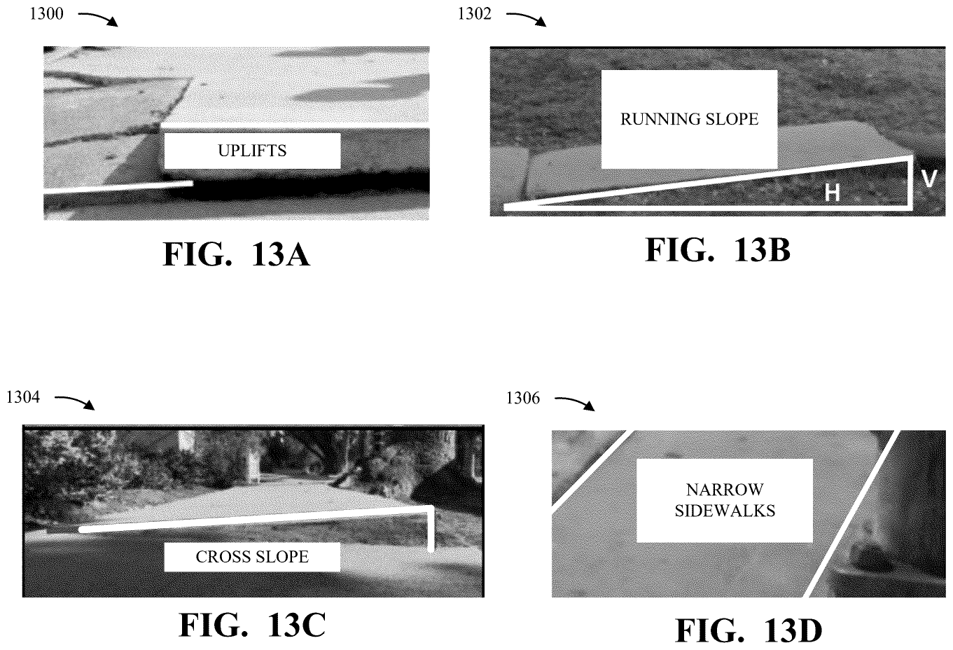

FIG. 13A through FIG. 13D are diagrams showing examples of asset evaluation associated with AI-driven support for infrastructure management. These diagrams visually represent specific types of sidewalk defects or conditions that may be identified and assessed by an AI component, such as the AI component 122 or the AI agent network 314, based on multimodal input data, particularly image data. Identifying these features is part of determining the attribute set associated with sidewalk infrastructure assets, which informs the assessment of physical condition and compliance with predefined standards such as ADA, ultimately contributing to the output data generated for multi-objective infrastructure management operations.

FIG. 13A shows an example 1300 depicting sidewalk “Uplifts”. Uplifts represent vertical displacement between adjacent sidewalk slabs, creating potential tripping hazards and accessibility barriers. The AI component may identify and quantify uplifts based on visual analysis of image data or, more precisely, using geometric measurements extracted from LiDAR data or depth maps. The severity of the uplift is an attribute used in assessing the physical condition and compliance of the sidewalk asset. For example, scoring criteria may assign points based on the height of the uplift, with displacements over a certain threshold indicating non-compliance and requiring remediation. Identifying the at least one attribute set may include extracting precise geometric measurements from LiDAR data.

FIG. 13B shows an example 1302 depicting sidewalk “Running Slope”. Running slope refers to the grade of the sidewalk parallel to the direction of pedestrian travel. The AI component may estimate the running slope from image data or calculate it precisely using geometric measurements derived from LiDAR data or depth maps, represented by the horizontal ‘H’ and vertical ‘V’ components indicated. Assessing the running slope is part of identifying the attribute set and is relevant for determining ADA compliance, as standards may limit the running slope to facilitate accessibility for individuals using mobility devices.

FIG. 13C shows an example 1304 depicting sidewalk “Cross Slope”. Cross slope refers to the grade of the sidewalk perpendicular to the direction of pedestrian travel, primarily for drainage but also impacting user effort and stability. The AI component may estimate the cross slope visually or measure it precisely using geometric analysis of LiDAR data or depth maps. The cross slope is an attribute in the attribute set used to assess compliance with standards such as ADA, which may mandate a maximum cross slope to prevent difficulties for wheelchair users and provide for proper drainage without creating excessive side slope.

FIG. 13D shows an example 1306 depicting “Narrow Sidewalks”. Sidewalk width is an attribute related to pedestrian capacity, comfort, and accessibility. The AI component may estimate sidewalk width from image data or measure it precisely using LiDAR data by identifying the edges of the sidewalk. Assessing sidewalk width is part of identifying the attribute set and determining compliance with accessibility standards, which may specify minimum clear widths to accommodate wheelchair passage and facilitate pedestrians passing one another. The identification of narrow sidewalks may contribute to prioritizing segments for widening or other improvements in a multi-objective infrastructure management operation. The output data provided for display via a graphical user interface may indicate areas with non-compliant sidewalk widths.

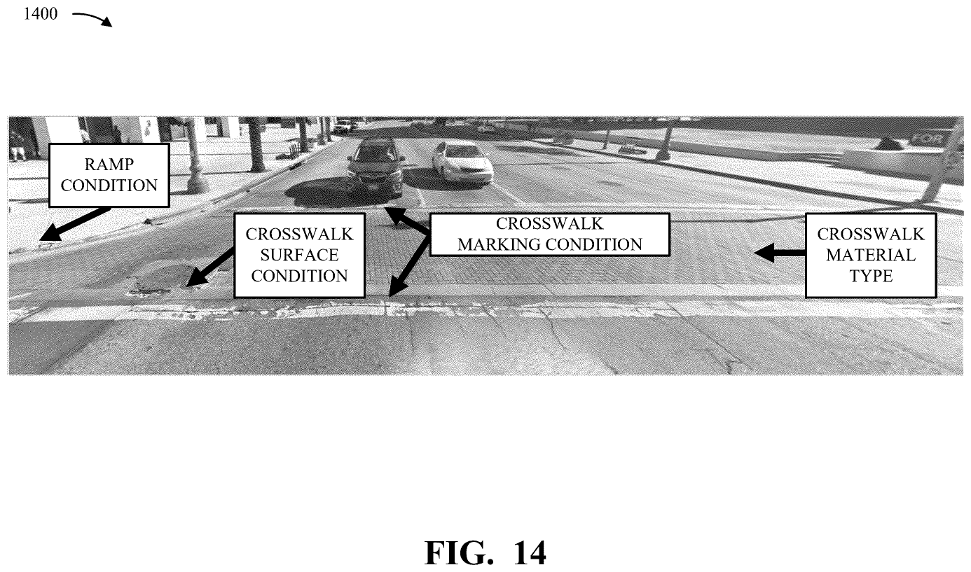

FIG. 14 is a diagram showing another example 1400 of asset evaluation associated with AI-driven support for infrastructure management. The example 1400 visually identifies specific features or attributes of a crosswalk and its surrounding context that may be assessed by an artificial intelligence component, the AI component 122 or the AI agent network 314, when processing multimodal input data, such as image data. Identifying these attributes may be part of identifying at least one attribute set associated with the crosswalk infrastructure asset, which is then used for generating output data associated with a multi-objective infrastructure management operation. The labeled features include “RAMP CONDITION,” “CROSSWALK SURFACE CONDITION,” “CROSSWALK MARKING CONDITION,” and “CROSSWALK MATERIAL TYPE.”

The example 1400 illustrates the application of asset evaluation techniques, performed by the asset evaluation engine 118 or the asset evaluation engine 308, to a specific type of infrastructure asset, the crosswalk. The system may analyze image data depicting the crosswalk to determine the status of various attributes relevant to safety, accessibility, and maintenance requirements. This detailed assessment may facilitate decision-making within infrastructure planning and management workflows.

The “RAMP CONDITION” label points towards the curb ramp connecting the sidewalk to the crosswalk level. Assessing the condition of this ramp is relevant for pedestrian accessibility and determining compliance with predefined standards such as ADA. The AI component may analyze the visual appearance of the ramp in the image data to identify defects such as cracking, spalling, or obstructions. Geometric attributes like running slope and cross-slope, which may be determined from LiDAR data or depth analysis for precise measurement, may be part of a comprehensive condition and compliance assessment. Identifying the at least one attribute set for the associated curb ramp may include evaluating its condition.

The “CROSSWALK SURFACE CONDITION” label refers to the physical state of the pavement within the boundaries of the crosswalk itself. Assessing this condition may include identifying surface distresses such as cracks, potholes, or unevenness that could pose tripping hazards or indicate structural deterioration. The AI component, a VLM or CV model for segmentation, may analyze the texture and appearance of the pavement surface within the segmented crosswalk area in the image data to classify its condition. This assessment may contribute to the attribute set used for maintenance prioritization and safety evaluations.

The “CROSSWALK MARKING CONDITION” label pertains to the visibility and integrity of the painted or thermoplastic markings that delineate the crosswalk. The condition of these markings may affect their conspicuity to drivers, which is relevant for pedestrian safety. The AI component, such as a VLM, may assess the marking condition based on factors such as fading, wear, chipping, or retroreflectivity as inferred from the image data. The condition may be classified, forming part of the attribute set used in maintenance planning and influencing LTS score calculations.

The “CROSSWALK MATERIAL TYPE” label indicates the primary material used for the crosswalk surface or markings. Crosswalks may use materials including standard paint or thermoplastic on asphalt or concrete pavement, or decorative materials like pavers or colored asphalt. The AI component may identify the material type based on visual characteristics such as color, texture, and pattern recognition from the image data. This information, included in the attribute set, may be relevant for understanding maintenance requirements, durability, or aesthetic considerations within the transportation network environment.

The assessment of these attributes, facilitated by the AI component analyzing multimodal input data, may provide a detailed characterization of the crosswalk asset. This information, structured as an attribute set and stored in the data layer 116 or the data layer 306, may serve as input for generating output data, such as condition reports, compliance summaries, prioritized maintenance lists, or updated asset inventories, which are ultimately provided for display via a graphical user interface rendered by a computing device.

FIG. 15A through FIG. 15D are examples of a GUI 1500 provided by an AI system for supporting infrastructure management. The GUI 1500 may be, be similar to, include, or be included in the UI 126 rendered by the client 124 on the user device 104, or the interface provided via the client 318 and server 316 interacting with the AI system 300. The GUI 1500 provides a visual means for users, such as transportation planners or engineers, to interact with the system, view output data associated with multi-objective infrastructure management operations, and manage infrastructure assets. Providing the output data for display via a graphical user interface rendered by a computing device is a function of the system.

Referring to FIG. 15A, an example dashboard view within the GUI 1500 is shown. This view may serve as an entry point or overview screen for the user, presenting summary information and metrics related to the infrastructure assets being managed. The dashboard view may include a dashboard button 1502, an asset management button 1504, and a scenario mode button 1506, summary cards or widgets (collectively 1522, 1524, 1526, 1528), a graphical summary 1520, and an asset table 1530 displaying recent or prioritized assets. Rendering a dashboard summarizing metrics may be part of providing the output data for display.

Additional controls such as a Search bar 1508, an Export Layers function 1510, and Settings 1512 may be present. Further sub-navigation or filtering options, such as Crosswalk 1514, Stop sign 1516, and Sidewalk 1518, may facilitate users focusing the displayed information on specific asset types.

The graphical summary 1520, depicted here as a donut chart, may provide a visual breakdown of assets, for example, by type or condition. In this example, it shows a total of “452 Assets” distributed across different categories represented by colored segments. The summary cards may display performance indicators (KPIs) or counts, such as Total Asset count 1522 (showing “2,300”), Assets Due For Maintenance count 1524 (showing “431”), Tasks count 1526 (showing “801”), and the date of the Last Maintenance 1528 (showing “24/12/2024”). These cards provide an overview of the current state and workload.

The asset table 1530, labeled “Your Assets,” may display a list of specific infrastructure assets with attributes. Columns may include Asset ID, Asset Type, Condition, Last Inspection Date, and Location. This table may show recently inspected assets, assets requiring attention, or assets matching current filter criteria, providing direct access to detailed information. The data displayed in this dashboard view represents output data generated by the system based on the analysis of attribute sets identified by the AI component from multimodal input data.

In some implementations, the dashboard view may be customizable, which may facilitate users selecting which metrics or widgets are displayed. For example, a user might add widgets showing budget expenditure versus progress or recent compliance alerts. In some implementations, the graphical summary 1520 could be a bar chart, pie chart, or a map indicating asset distribution. In some implementations, the asset table 1530 might include sorting, filtering, or pagination controls for easier navigation of large asset lists. The specific metrics displayed may be configured based on the objectives of the multi-objective infrastructure management operation being supported.

Referring now to FIG. 15B, an example task management view 1532 within the GUI 1500 is shown. This view, which may be part of an Asset Management section activated by selecting an asset management button 1504, focuses on organizing, assigning, and tracking maintenance or inspection tasks related to infrastructure assets. It may include navigation elements like a Map View toggle 1534 and a Table view toggle 1536, search functionality, a tasks toggle 1538, task-specific controls like Filter 1542 and Create Task 1540, and a main task list 1544 displayed in a tabular format. Rendering an asset management interface may be part of providing the output data for display.

The task list 1544, labeled “Your Task,” presents information about ongoing or pending tasks. Columns may include Task Name, Linked Asset (ID), Priority (e.g., High, Medium, Low), Due Date, Assigned Crew (or person), and Status (e.g., Under construction, In progress, Pending, Completed). Each row represents a distinct task associated with maintaining or inspecting an infrastructure asset identified by the system. This interface facilitates workflow management for maintenance teams.

The controls provided, such as Filter 1542 and Create Task 1540, may facilitate users managing the task list. Filtering might facilitate users viewing tasks based on status, priority, assigned crew, or asset type. The Create Task function may facilitate initiating new work orders, linking them directly to assets identified as needing attention based on the AI component's analysis of their attribute sets. Toggling between Map View toggle 1534 and Table view toggle 1536 may offer different perspectives for visualizing task locations or managing task details.

In some implementations, the task management view might utilize a Kanban board layout in addition to a table view, which may facilitate visualization of tasks progressing through different stages. For example, columns could represent ‘To Do’, ‘In Progress’, and ‘Completed’. In some implementations, tasks might be automatically generated by the system based on predefined rules, such as creating an inspection task when an asset's condition falls below a certain threshold determined by the asset evaluation engine 118 or 308. In some implementations, the interface may integrate with external work order management systems used by the organization.

Referring now to FIG. 15C, an example asset detail view 1550 within the GUI 1500 is shown. This view provides comprehensive information about a specific selected infrastructure asset, identified here as “48239 Asset”. It may be accessed by selecting an asset from the asset table 1530 or the task list 1544, or from an interactive map. This view consolidates various details pertinent to managing the individual asset.

The asset detail view 1550 may be organized using tabs or sections, such as Basic Info 1552, Maintenance History 1554, Documents 1556, and Tasks 1558. The Basic Info section may display attributes like Asset ID (“48239”), Asset Type (“Sidewalk”), Condition (“Fair”), Last Inspection Date (“Mar. 14, 2023”), and Location (“Sunset Boulevard”), along with an image or 3D visualization of the asset. The Maintenance History 1554 section might list past work orders or inspections, while Documents 1556 could provide access to related files, and Tasks 1558 would show pending or completed tasks specific to this asset. An option to Export Asset Report 1560 may facilitate generating documentation. The asset list 1548 shows other assets, and thumbnails 1546 may show historical images or related views.

This view centralizes information derived from the identified attribute set for the specific asset, including its assessed physical condition and compliance status, making it readily accessible for review and management. The displayed information represents output data generated by the system's analysis and stored within the data layer 116 or 306.

In some implementations, the asset detail view 1550 may include interactive elements, which may facilitate users updating condition information, adding notes, or scheduling new tasks directly from this interface. For example, an inspector might update the ‘Condition’ field after a site visit. In some implementations, the view might integrate with external systems, such as linking to maintenance records in a separate database or displaying real-time sensor data if applicable. In some implementations, historical trend analysis, derived from comparing attribute sets over time, might be visualized within this view, showing how the asset's condition has changed.

Referring now to FIG. 15D, an example interactive map and chat view 1562 within the GUI 1500 is shown. This view integrates a geospatial display with a conversational AI interface, which may facilitate users exploring infrastructure data spatially and interacting with the AI system using natural language. The main area may include an interactive map 1564 displaying asset layers, alongside filter controls 1566, an asset detail pop-up 1568, and a chat panel 1570 featuring an interactive chatbot. Rendering an interactive map displaying asset locations and attributes, and including a conversational AI component, are potential features of the graphical user interface.

In some implementations, the interactive map 1564 or dashboard views may be configured to output results of the reasoning operations performed by the tool layer 120 on the knowledge graph. These results may be presented as ranked recommendations, such as a prioritized list of high-impact intervention targets, or as visual network analytics. For example, systemic vulnerabilities or inferred asset interdependencies identified from the knowledge graph may be visualized on the map 1564 as highlighted corridors or critical nodes.

The interactive map 1564 may visualize infrastructure assets retrieved from the data layer 116 or 306, color-coded based on attributes like condition or LTS score determined by the asset evaluation engine 118 or 308. Users may pan, zoom, and select assets on the map. The filter controls 1566 may facilitate users toggling the visibility of different asset types (e.g., Sidewalk, Crosswalk, Curb Ramps, Bike Lanes) or filtering assets based on rating (Good, Fair, Poor), standards compliance (e.g., ADA compliant), or heatmap data (e.g., Pedestrian volume, Crash frequency, Socioeconomic data). Selecting an asset may trigger the asset detail pop-up 1568, displaying attributes (e.g., “Sidewalk”, “Non-ADA compliant”, Width, Slope, Condition, dates, trends, maintenance logs) derived from its identified attribute set.

The chat panel 1570 showcases the interactive chatbot, which may be named “City GPT” or similar, which acts as a conversational AI component. Users may input natural language queries (e.g., “Help me assess the impact of adding a bike lane to Wilshere Boulevard”). The chatbot, powered by the AI agent network 314 or AI component 122, processes the query, accessing data from the data layer 116 or 606 (including knowledge database 614 and solution database 616) and utilizing reasoning capabilities (reasoning engine 620), and generates a responsive textual briefing or engages in a dialogue to refine the query or provide information (e.g., discussing impacts on traffic, suggesting next analysis steps). This may facilitate users exploring data and performing analyses conversationally.

In some implementations, the interactive map 1564 may support various base map layers and facilitate overlaying different analytical outputs, such as heatmaps or prioritized project locations derived from the optimization engine 310. For example, areas with high pedestrian volume and poor sidewalk conditions could be visually highlighted. In some implementations, the chatbot may be configured to perform actions based on user requests, such as generating a report for a specific area or initiating a scenario simulation via the tool layer 120 or 312. In some implementations, the asset detail pop-up 1568 may facilitate direct editing of asset attributes or initiating maintenance tasks.

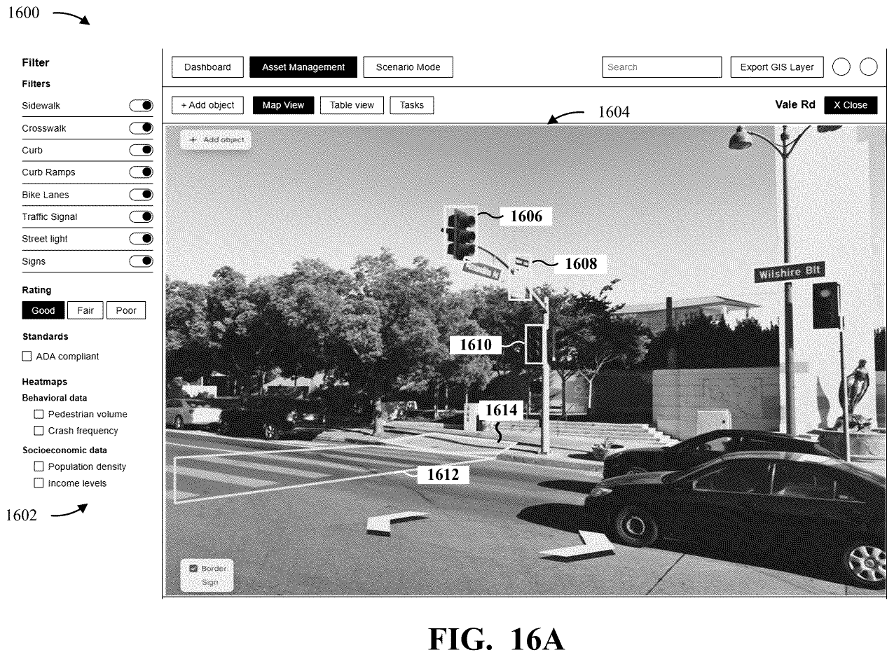

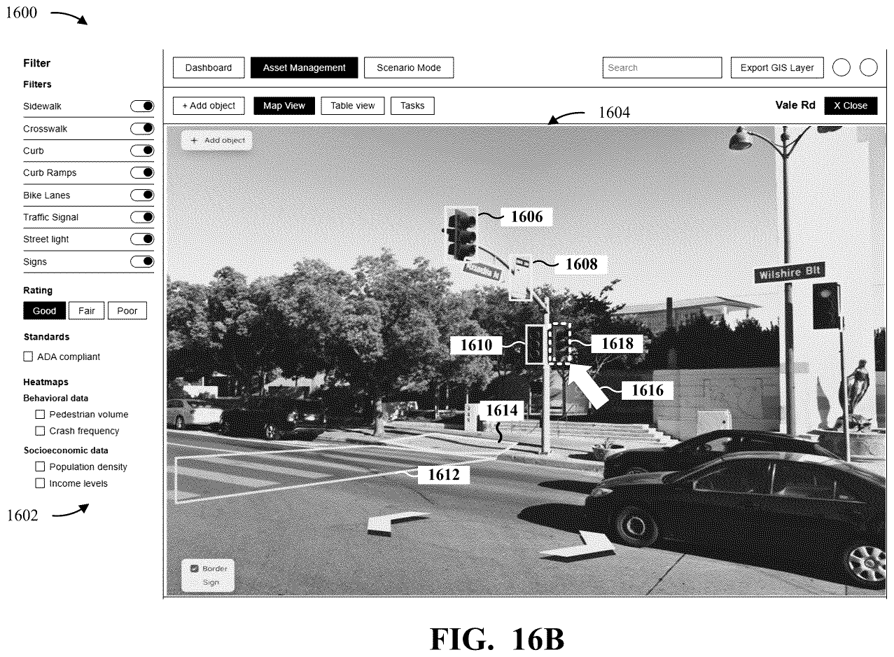

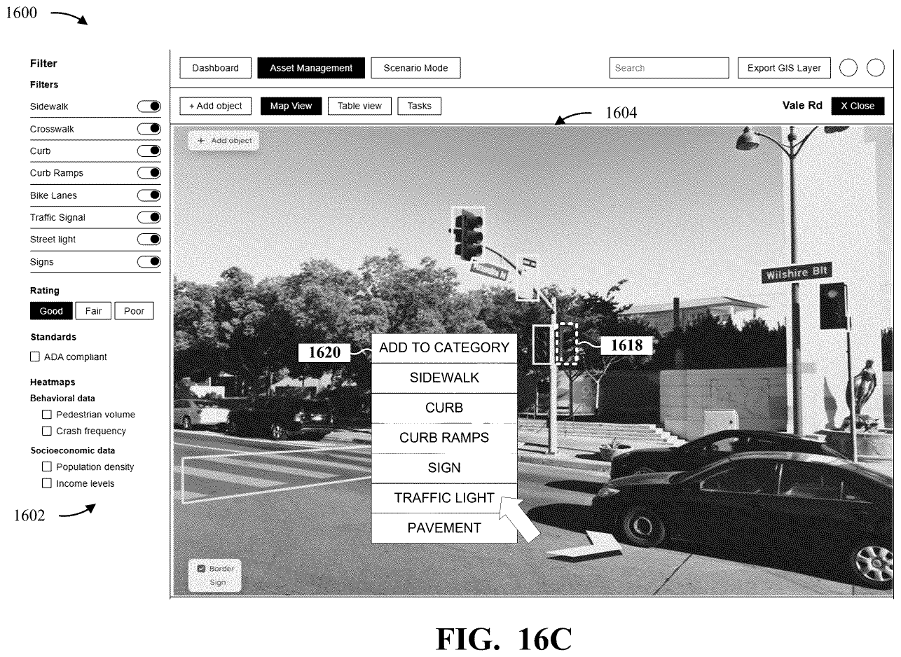

FIG. 16A through FIG. 16C are examples of another GUI provided by an AI system for supporting infrastructure management. These figures illustrate a detailed, street-level view within the GUI 1500, which may be part of the Asset Management section, which may facilitate users visually inspecting and interacting with infrastructure assets identified by the AI system. Providing the output data for display via a graphical user interface rendered by a computing device may include rendering such detailed views.

Referring to FIG. 16A, an example detailed street-level asset view 1600 is shown within the GUI 1500. This view provides a ground-level perspective, derived from panoramic or other street-level image data captured by a mobile mapping system, corresponding to a specific location within the transportation network environment. The view includes filter controls 1602 on the left, similar to those in FIG. 15D, which may facilitate users selecting which asset types or attributes are displayed or analyzed. Overlaid on the image are visual indicators, such as bounding boxes or highlighted regions, representing infrastructure assets identified by the AI component based on the multimodal input data. These identified assets may include a traffic signal 1606, various signs 1608 and 1610, a crosswalk 1612, and a pole or post 1614. Navigation controls 1604, such as search and export, may be present. This view may facilitate users visually verifying the assets detected by the AI system and understanding their context.

In some implementations, the detailed street-level asset view 1600 may be linked to the interactive map 1564 shown in FIG. 15D, which may facilitate a user selecting a location on the map and transitioning to this ground-level perspective. For example, clicking on an asset icon on the map might open this detailed view centered on that asset. In some implementations, this view might integrate 3D data, which may facilitate users navigating a point cloud representation synchronized with the image view. The visual indicators for detected assets might take different forms, such as segmentation masks, outlines, or icons, depending on the configuration.

Referring now to FIG. 16B, the detailed street-level asset view 1600 is shown again, illustrating an interaction or editing state. An arrow 1616 points towards the base of the pole supporting the traffic signal 1606 and the sign 1610, suggesting user interaction or system focus on this specific location or asset. Additionally, a highlighted region 1618 near the traffic signal 1606 might indicate an area selected for adding a new object or editing an existing detected asset. Controls such as “+Add object” may facilitate users manually adding assets missed by the AI detection or correcting inaccuracies in the identified attribute sets. This functionality may facilitate human-in-the-loop refinement of the AI-generated output data.

In some implementations, a user might initiate editing by clicking the “+Add object” button and then drawing a bounding box or polygon, like the region 1618, around the asset of interest in the image. For example, if a sign was not detected by the AI component, the user could manually delineate it. In some implementations, selecting an existing detected asset, indicated perhaps by the arrow 1616, might open an editing panel which may facilitate a user modifying its attributes, such as condition or type, or adjusting its detected boundaries. The system may store user edits, triggering retraining or validation processes for the AI component.

Referring now to FIG. 16C, the detailed street-level asset view 1600 is shown during an asset classification or editing process. Following the selection or delineation of an asset, corresponding to the region 1618, a context menu or panel 1620 labeled “ADD TO CATEGORY” appears. This menu lists various predefined types of infrastructure assets, including SIDEWALK, CURB, CURB RAMPS, SIGN, TRAFFIC LIGHT, and PAVEMENT. An arrow indicates the user is assigning or confirming the category for the selected asset, e.g., 1618, from this list. This operation directly modifies or defines the ‘type’ attribute within the attribute set associated with the infrastructure asset.

In some implementations, the list of categories in the panel 1620 may be hierarchical, which may facilitate users selecting more specific asset types, e.g., selecting ‘SIGN’ then ‘Regulatory Sign’ then ‘Stop Sign’. For example, after drawing a box around a stop sign, the user would select ‘SIGN’ from the primary list and may refine the classification further. In some implementations, the AI component might suggest a likely category based on the visual appearance of the selected region 1618, which the user can then confirm or correct. The ability to accurately categorize assets is related to inventory management and applying appropriate evaluation criteria, e.g., using specific compliance standards for curb ramps versus sidewalks.

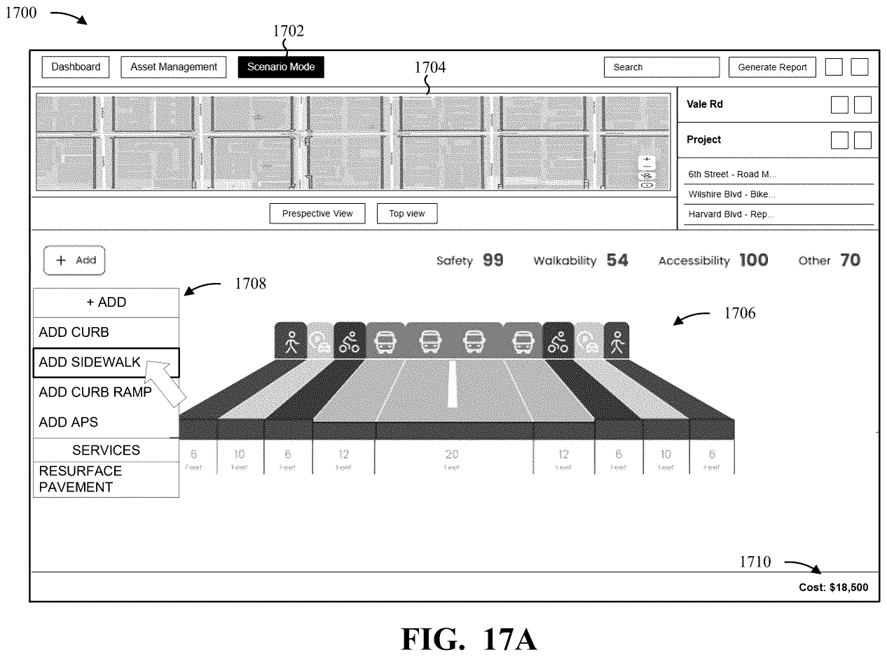

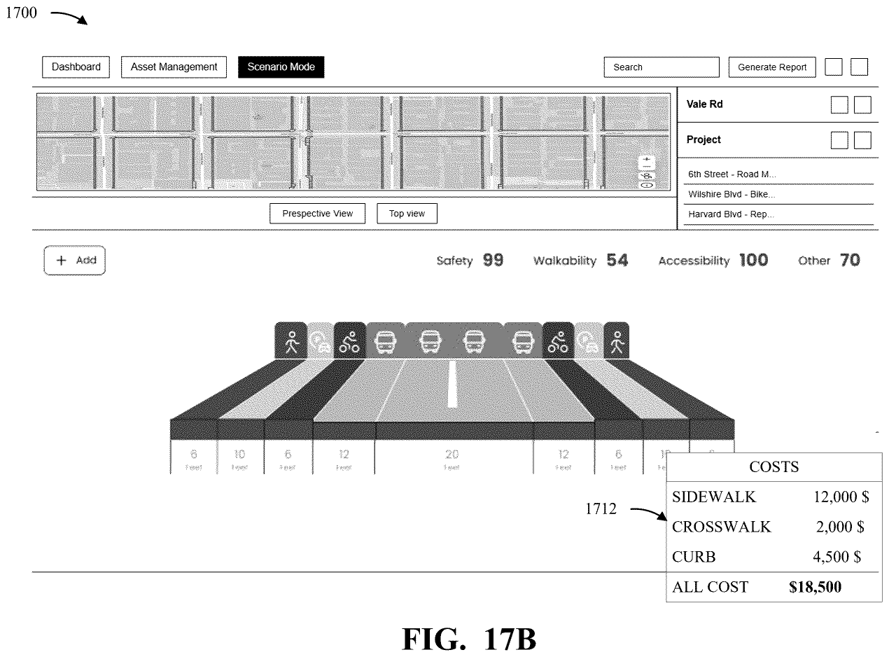

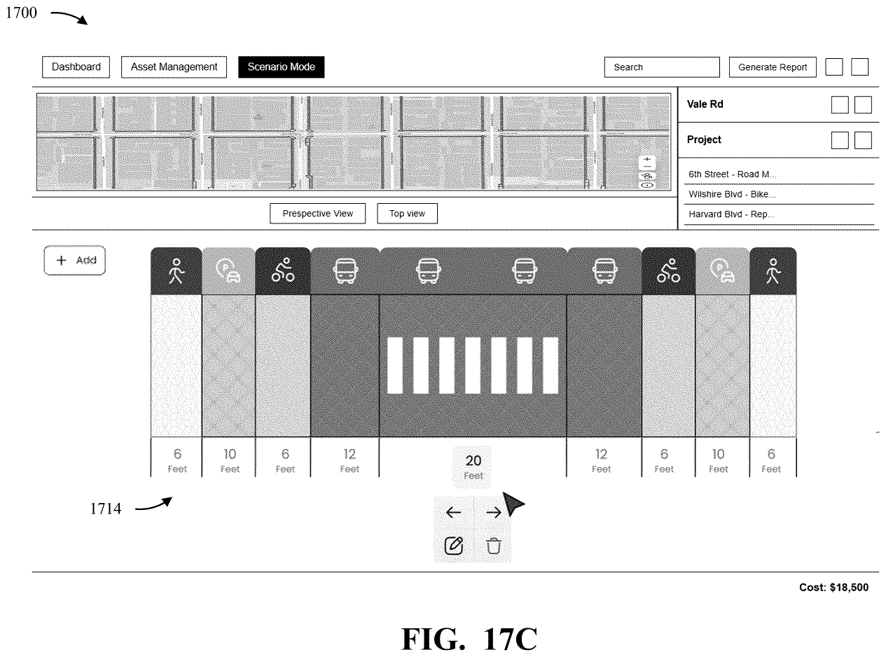

FIG. 17A through FIG. 17C are examples of another GUI provided by an AI system for supporting infrastructure management. These figures illustrate a scenario modeling interface 1700 within the GUI 1500, corresponding to the Scenario Mode, which may be activated by selecting a scenario mode button 1702. This interface may facilitate users, such as transportation planners, to design hypothetical changes to the transportation network environment, simulate their effects, and evaluate impacts on various metrics, thereby generating data for scenario modeling as part of a multi-objective infrastructure management operation. Providing the output data for display may include rendering such a scenario modeling interface.

Referring to FIG. 17A, an example of the scenario modeling interface 1700 is shown. This view may include a top-down map view 1704, similar to the interactive map 1564, displaying a portion of the transportation network. A control panel 1708, which may include an “+Add” button, may facilitate users initiating modifications. A component is the cross-section view 1706, which provides a schematic representation of the street's profile at a selected location, showing the allocation of space to different elements such as sidewalks, bike lanes, vehicle lanes, and medians or furnishing zones. Below or alongside the cross-section view 1706, performance metrics such as Safety, Walkability, Accessibility, and Other factors may be displayed with corresponding scores, e.g., 99, 54, 100, 70, reflecting the simulated impact of the current design. A cost estimate 1710, e.g., “$18,500,” associated with implementing the displayed scenario may be shown. This interface facilitates users to visually design and assess potential street configurations. Generating data for simulating at least one scenario representing potential changes and determining an impact may be performed using this interface.

In some implementations, users may select a road segment on the map view 1704 to load its current configuration into the cross-section view 1706. For example, selecting a street might display its existing lanes and sidewalks in the cross-section view 1706. In some implementations, the control panel 1708 may provide options to add specific elements like sidewalks (“ADD SIDEWALK”), curbs (“ADD CURB”), curb ramps (“ADD CURB RAMP”), accessible pedestrian signals (“ADD APS”), or perform services like pavement resurfacing (“RESURFACE PAVEMENT”). In some implementations, the metrics displayed, including Safety, Walkability, and Accessibility, may be dynamically updated by the asset evaluation engine 118 or 308 or the tool layer 120, 312, or 610 as the user modifies the design in the cross-section view 1706, providing real-time feedback on the potential impacts, including changes to LTS scores.

Referring now to FIG. 17B, another state of the scenario modeling interface 1700 is shown, highlighting a cost breakdown panel 1712. While retaining the elements like the map view, cross-section view, and metrics display, this state adds a detailed itemization of the estimated costs associated with the proposed scenario shown in the cross-section view. The cost breakdown panel 1712 lists different categories of work, such as SIDEWALK, CROSSWALK, and CURB, along with their respective estimated costs, e.g., $12,000, $2,000, $4,500, culminating in the total cost previously displayed, e.g., $18,500. This feature provides transparency into the cost drivers of a proposed design.

The cost estimates displayed in the cost breakdown panel 1712 may be derived from cost functions, managed within the tool layer 120 or 312 or the optimization engine 310. These functions may consider the type and quantity of materials, labor rates, and geometric parameters associated with the proposed changes. Providing this breakdown facilitates users in understanding the financial implications of different design choices and aligning proposals with available budget constraints, which is relevant for optimization analysis generating recommended capital improvements.

In some implementations, the cost breakdown panel 1712 may be interactive, facilitating users to click on categories to see more detailed cost components or adjust unit costs based on local data. For example, clicking “SIDEWALK” might show costs broken down by excavation, concrete, and finishing. In some implementations, the system might facilitate comparison of cost breakdowns for multiple scenarios side-by-side. In some implementations, the cost estimates may be linked to specific geographic areas to account for regional variations in construction costs.

Referring now to FIG. 17C, a further state of the scenario modeling interface 1700 is shown, focusing on the interactive cross-section editor 1714. This view emphasizes the cross-section representation, which may be enlarged or highlighted, providing tools for direct manipulation of the street layout. Users may interact with graphical elements representing lanes or zones to modify their widths, add new elements from a palette, or remove existing ones. Interactive controls, such as arrows or handles, and buttons for editing, copying, or deleting elements may be provided to facilitate the design process. This interactive editor is a mechanism through which users define the scenarios whose impacts are simulated and evaluated by the system.

The cross-section editor 1714 facilitates users to visually construct and modify street designs, translating planning concepts into specific geometric configurations. Changes made in the cross-section editor 1714 trigger updates in the displayed metrics, including Safety, Walkability, and Accessibility, and the estimated cost, providing immediate feedback. The defined scenario serves as input for simulation or analysis performed by the tool layer 120 or 312 to determine impacts.

In some implementations, the cross-section editor 1714 may offer a library of predefined street elements or templates compliant with standards like NACTO design guides or local regulations. For example, users could drag and drop standard protected bike lane configurations into the cross-section. In some implementations, the editor may provide visual warnings or feedback if a user attempts to create a configuration that violates minimum width requirements or other design constraints. In some implementations, changes made in the cross-section editor 1714 might be simultaneously reflected in the top-down map view 1704, visualizing the spatial extent of the proposed modification along the selected road segment.

To further describe some implementations in greater detail, reference is next made to examples of techniques which may be performed by or using the AI system for supporting infrastructure management as described herein. FIG. 18 is a flowchart of an example of a technique 1800 associated with AI-driven support for infrastructure management. The technique 1800 may be executed using computing devices, such as the systems, hardware, and software described with respect to FIGS. 1-17C. The technique 1800 may be performed, for example, by executing a machine-readable program or other computer-executable instructions, such as routines, instructions, programs, or other code. The operations of the technique 1800, or another technique, method, process, or algorithm described in connection with the implementations disclosed herein may be implemented directly in hardware, firmware, software executed by hardware, circuitry, or a combination thereof. For simplicity of explanation, the technique 1800 is depicted and described herein as a series of operations. However, the operations of the technique 1800 may occur in various orders and/or concurrently. Additionally, other operations not presented and described herein may be used. Furthermore, not all illustrated operations may be required to implement a technique in accordance with the disclosed subject matter.

At 1802, the technique 1800 includes receiving, by a processor set, multimodal input data associated with a transportation network environment, the multimodal input data comprising at least one of image data and LiDAR data. For example, the processor set 204 within the infrastructure planning support system 102 or the AI system 300 may receive these data streams via the interface component 112 or the server 316 from data sources like the data source 106, the data source 108, or the data source 304. Receiving the multimodal input data may include receiving data captured by a mobile mapping system including at least one LiDAR sensor and at least one camera. In some implementations, receiving the multimodal input data may include receiving sensor data captured by one or more autonomous robots operating within the transportation network environment, the one or more autonomous robots comprising at least one of a delivery robot or a sidewalk inspection robot. The multimodal input data may include at least one of aerial imagery data or traffic camera data.

At 1804, the technique 1800 includes identifying, by the processor set and based on an AI component and the multimodal input data, at least one attribute set associated with at least one infrastructure asset within the transportation network environment. For example, the processor set 204, executing instructions associated with the AI component 122 or the AI agent network 314, may analyze the received image data and/or LiDAR data to detect assets like sidewalks, signs, or crosswalks and determine their characteristics. The AI component may include at least one of a VLM, a CV model for segmentation, a CV model for object detection, or a CV model for depth estimation. Identifying the at least one attribute set may include assessing a physical condition of the at least one infrastructure asset. Identifying the at least one attribute set may include assessing compliance of the at least one infrastructure asset with a predefined standard. Where the multimodal input data includes LiDAR data, identifying the at least one attribute set may include extracting, from the LiDAR data, at least one precise geometric measurement associated with the at least one infrastructure asset by applying at least one of a spatial clustering algorithm to group points associated with the asset, a plane fitting algorithm to determine surface orientation, or a random-sample-consensus-based line fitting algorithm to identify edges. If sensor data is received from autonomous robots, identifying the at least one attribute set may include analyzing the sensor data received from the one or more autonomous robots to assess at least one of sidewalk surface condition, pedestrian clearway obstruction, or accessibility feature presence at a hyperlocal resolution.

At 1806, the technique 1800 includes generating, by the processor set and based on the at least one attribute set, output data associated with a multi-objective infrastructure management operation. For example, the processor set 204, executing instructions associated with the asset evaluation engine 118 or 308, the optimization engine 310, or the tool layer 120 or 312, may use the identified asset attributes to calculate scores, run simulations, or perform optimizations related to infrastructure planning. Generating the output data associated with the multi-objective infrastructure management operation may include determining an LTS score for at least one segment of the transportation network based on the at least one attribute set. The process may include generating a composite prioritization score based on integrating the at least one attribute set with at least one of an LTS score or a network importance score. The network importance score may be based on a betweenness centrality associated with one or more road segments of the transportation network. Generating the output data may include generating, by performing an optimization analysis, a ranked list of recommended capital improvements based on the at least one attribute set and at least one budget constraint. The process may include generating data for simulating at least one scenario representing potential changes to the transportation network environment; and determining an impact of the potential changes. Generating the output data may include generating data related to at least one of user behavior analysis, near-miss incident detection, emergency response enhancement, or resilience modeling. The output data may be formatted as at least one GeoJSON file.

At 1808, the technique 1800 includes providing, by the processor set, the output data for display via a graphical user interface rendered by a computing device. For example, the processor set 204, via the interface component 112 or the server 316, may transmit the generated output data over the network 110 to the user device 104 or the client 318, where it is rendered by the client 124 or 318 within the UI 126. Providing the output data for display via the graphical user interface may include rendering at least one of an interactive map displaying asset locations and attributes, a dashboard summarizing key metrics, an asset management interface, or a scenario modeling interface. The graphical user interface may include a conversational artificial intelligence component configured to receive a natural language query from a user and generate a responsive textual briefing.

Some implementations include a method, comprising: receiving, by a processor set, multimodal input data associated with a transportation network environment, the multimodal input data comprising at least one of image data or light detection and ranging (LiDAR) data; identifying, by the processor set and based on an artificial intelligence (AI) component and the multimodal input data, at least one attribute set associated with at least one infrastructure asset within the transportation network environment; generating, by the processor set and based on the at least one attribute set, output data associated with a multi-objective infrastructure management operation; and providing, by the processor set, the output data for display via a graphical user interface rendered by a computing device.

In some implementations, receiving the multimodal input data comprises: receiving data captured by a mobile mapping system including at least one of a LiDAR sensor or a camera.

In some implementations, receiving the multimodal input data comprises: receiving sensor data captured by one or more autonomous robots operating within the transportation network environment, the one or more autonomous robots comprising at least one of a delivery robot or a sidewalk inspection robot.

In some implementations, identifying the at least one attribute set comprises:

analyzing the sensor data received from the one or more autonomous robots to assess at least one of sidewalk surface condition, pedestrian clearway obstruction, or accessibility feature presence at a hyperlocal resolution.

In some implementations, identifying the at least one attribute set comprises: assessing a physical condition of the at least one infrastructure asset.

In some implementations, identifying the at least one attribute set comprises: assessing compliance of the at least one infrastructure asset with a predefined standard.

In some implementations, identifying the at least one attribute set comprises: extracting, from the LiDAR data, at least one precise geometric measurement associated with the at least one infrastructure asset by applying at least one of a spatial clustering algorithm to group points associated with the asset, a plane fitting algorithm to determine surface orientation, or a random-sample-consensus-based line fitting algorithm to identify edges.

In some implementations, generating the output data associated with the multi-objective infrastructure management operation comprises at least one of: determining a Level of Traffic Stress (LTS) score for at least one segment of the transportation network based on the at least one attribute set; or generating a composite prioritization score based on integrating the at least one attribute set with at least one of the LTS score or a network importance score.

In some implementations, the network importance score is based on a betweenness centrality associated with one or more road segments of the transportation network.

In some implementations, generating the output data associated with the multi-objective infrastructure management operation comprises: generating, by performing an optimization analysis, a ranked list of recommended capital improvements based on the at least one attribute set and at least one budget constraint.

In some implementations, generating the output data associated with the multi-objective infrastructure management operation comprises: generating data for simulating at least one scenario representing potential changes to the transportation network environment; and determining an impact of the potential changes.

In some implementations, generating the output data associated with the multi-objective infrastructure management operation comprises: generating data related to at least one of user behavior analysis, near-miss incident detection, emergency response enhancement, or resilience modeling.

In some implementations, providing the output data for display via the graphical user interface comprises: rendering at least one of an interactive map displaying asset locations and attributes, a dashboard summarizing key metrics, an asset management interface, or a scenario modeling interface.

In some implementations, generating the output data associated with the multi-objective infrastructure management operation further comprises: constructing a knowledge graph that semantically links the at least one infrastructure asset, the at least one associated attribute set, and at least one derived performance metric; and identifying, based on performing a relational reasoning operation associated with the knowledge graph, one or more interdependencies among at least two of a roadway element, a sidewalk element, or a crosswalk element.

Some implementations include a system, comprising: a memory storing instructions; and a processor set communicatively coupled to the memory and configured to execute the instructions to cause the system to: receive multimodal input data associated with a transportation network environment, the multimodal input data comprising at least one of image data and light detection and ranging (LiDAR) data; identify, based on an artificial intelligence (AI) component and the multimodal input data, at least one attribute set associated with at least one infrastructure asset within the transportation network environment; generate, based on the at least one attribute set, output data associated with a multi-objective infrastructure management operation; and provide the output data for display via a graphical user interface rendered by a computing device.

In some implementations, the AI component comprises at least one of a Vision Language Model (VLM), a computer vision (CV) model for segmentation, a CV model for object detection, a CV model for depth estimation, a three-dimensional (3D) reconstruction model, a motion analysis model, a geospatial alignment model, an anomaly assessment model, a multi-modal fusion model, an action-event recognition model, a surface defect model, a texture analysis model, an optical character recognition model, a sign text recognition model, a symbol recognition model, a 3D point cloud segmentation model, a topological graph understanding model, or a scene graph understanding model.

In some implementations, the processor set is further configured to construct a knowledge graph database that semantically represents relationships among the at least one infrastructure asset, the at least one associated attribute set, and at least one derived performance metric, and wherein the processor set is configured to: continually update the knowledge graph with new multimodal data inputs; perform graph-based inference to identify related asset conditions across the transportation network; and query the knowledge graph to generate a context-aware recommendation for at least one of infrastructure maintenance, hazard mitigation, or capital investment prioritization.

Some implementations include one or more computer-readable media comprising instructions configured to be executed by a processor set to cause the processor set to perform operations comprising: receiving multimodal input data associated with a transportation network environment, the multimodal input data comprising at least one of image data and light detection and ranging (LiDAR) data; identifying, based on an artificial intelligence (AI) component and the multimodal input data, at least one attribute set associated with at least one infrastructure asset within the transportation network environment; generating, based on the at least one attribute set, output data associated with a multi-objective infrastructure management operation; and providing the output data for display via a graphical user interface rendered by a computing device.

In some implementations, the graphical user interface comprises a conversational artificial intelligence component configured to receive a natural language query from a user and generate a responsive textual briefing.

In some implementations, the operations further comprise: constructing a knowledge graph that encodes entities representing infrastructure assets, associated attribute sets, and derived performance metrics; semantically linking the entities within the knowledge graph based on at least one of spatial proximity, functional connectivity, or causal relationships learned from multimodal data; executing a graph-based reasoning operation to infer at least one of a hidden relationship, a systemic vulnerability, or a high-impact intervention target; and outputting, via the graphical user interface, a result of the reasoning operation as at least one of a ranked recommendation or a visual network analytic.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The adjectives “first,” “second,” “third,” and so on are used for contextual distinction between two or more of the modified nouns in connection with a discussion and are not meant to be absolute modifiers that apply only to a certain respective node throughout the entire document. For example, a component may be referred to as a “first component” in connection with one discussion and may be referred to as a “second component” in connection with another discussion, or vice versa. Reference to a component, a computing device, a server, a client, an application, an apparatus, a device, a system, a computing system, or the like may include disclosure of the computing device, server, client, application, apparatus, device, system, computing system, or the like, respectively, being a node. For example, disclosure that a computing device is configured to receive information from a server also discloses that a first node is configured to receive information from a second node. Consistent with this disclosure, once a specific example is broadened in accordance with this disclosure (e.g., a computing device is configured to receive information from a server also discloses that a first node is configured to receive information from a second node), the broader example of the narrower example may be interpreted in the reverse, but in a broad open-ended way. In the example above where a computing device being configured to receive information from a server also discloses a first node being configured to receive information from a second node, “first node” may refer to a first computing device, a first server, a first client, a first application, a first apparatus, a first device, a first system, a first computing system, or the like, configured to receive the information from a second node; and “second node” may refer to a second computing device, a second server, a second client, a second application, a second apparatus, a second device, a second system, a second computing system, or the like.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a processor set, multimodal input data associated with a transportation network environment, the multimodal input data comprising at least one of image data or light detection and ranging (LiDAR) data;
identifying, by the processor set and based on an artificial intelligence (AI) component and the multimodal input data, at least one attribute set associated with at least one infrastructure asset within the transportation network environment;
generating, by the processor set and based on the at least one attribute set, output data associated with a multi-objective infrastructure management operation; and
providing, by the processor set, the output data for display via a graphical user interface rendered by a computing device.

2. The method of claim 1, wherein receiving the multimodal input data comprises:
receiving data captured by a mobile mapping system including at least one of a LiDAR sensor or a camera.

3. The method of claim 1, wherein receiving the multimodal input data comprises:
receiving sensor data captured by one or more autonomous robots operating within the transportation network environment, the one or more autonomous robots comprising at least one of a delivery robot or a sidewalk inspection robot.

4. The method of claim 3, wherein identifying the at least one attribute set comprises:
analyzing the sensor data received from the one or more autonomous robots to assess at least one of sidewalk surface condition, pedestrian clearway obstruction, or accessibility feature presence at a hyperlocal resolution.

5. The method of claim 1, wherein identifying the at least one attribute set comprises:
assessing a physical condition of the at least one infrastructure asset.

6. The method of claim 1, wherein identifying the at least one attribute set comprises:
assessing compliance of the at least one infrastructure asset with a predefined standard.

7. The method of claim 1, wherein identifying the at least one attribute set comprises:
extracting, from the LiDAR data, at least one precise geometric measurement associated with the at least one infrastructure asset by applying at least one of a spatial clustering algorithm to group points associated with the asset, a plane fitting algorithm to determine surface orientation, or a random-sample-consensus-based line fitting algorithm to identify edges.

8. The method of claim 1, wherein generating the output data associated with the multi-objective infrastructure management operation comprises at least one of:
determining a Level of Traffic Stress (LTS) score for at least one segment of the transportation network based on the at least one attribute set; or
generating a composite prioritization score based on integrating the at least one attribute set with at least one of the LTS score or a network importance score.

9. The method of claim 8, wherein the network importance score is based on a betweenness centrality associated with one or more road segments of the transportation network.

10. The method of claim 1, wherein generating the output data associated with the multi-objective infrastructure management operation comprises:
generating, by performing an optimization analysis, a ranked list of recommended capital improvements based on the at least one attribute set and at least one budget constraint.

11. The method of claim 1, wherein generating the output data associated with the multi-objective infrastructure management operation comprises:
generating data for simulating at least one scenario representing potential changes to the transportation network environment; and
determining an impact of the potential changes.

12. The method of claim 1, wherein generating the output data associated with the multi-objective infrastructure management operation comprises:
generating data related to at least one of user behavior analysis, near-miss incident detection, emergency response enhancement, or resilience modeling.

13. The method of claim 1, wherein providing the output data for display via the graphical user interface comprises:
rendering at least one of an interactive map displaying asset locations and attributes, a dashboard summarizing key metrics, an asset management interface, or a scenario modeling interface.

14. The method of claim 1, wherein generating the output data associated with the multi-objective infrastructure management operation further comprises:
constructing a knowledge graph that semantically links the at least one infrastructure asset, the at least one associated attribute set, and at least one derived performance metric; and
identifying, based on performing a relational reasoning operation associated with the knowledge graph, one or more interdependencies among at least two of a roadway element, a sidewalk element, or a crosswalk element.

15. A system, comprising:
a memory storing instructions; and
a processor set communicatively coupled to the memory and configured to execute the instructions to cause the system to:
receive multimodal input data associated with a transportation network environment, the multimodal input data comprising at least one of image data and light detection and ranging (LiDAR) data;
identify, based on an artificial intelligence (AI) component and the multimodal input data, at least one attribute set associated with at least one infrastructure asset within the transportation network environment;
generate, based on the at least one attribute set, output data associated with a multi-objective infrastructure management operation; and
provide the output data for display via a graphical user interface rendered by a computing device.

16. The system of claim 15, wherein the AI component comprises at least one of a Vision Language Model (VLM), a computer vision (CV) model for segmentation, a CV model for object detection, a CV model for depth estimation, a three-dimensional (3D) reconstruction model, a motion analysis model, a geospatial alignment model, an anomaly assessment model, a multi-modal fusion model, an action-event recognition model, a surface defect model, a texture analysis model, an optical character recognition model, a sign text recognition model, a symbol recognition model, a 3D point cloud segmentation model, a topological graph understanding model, or a scene graph understanding model.

17. The system of claim 15, wherein the processor set is further configured to construct a knowledge graph database that semantically represents relationships among the at least one infrastructure asset, the at least one associated attribute set, and at least one derived performance metric, and wherein the processor set is configured to:
continually update the knowledge graph with new multimodal data inputs;
perform graph-based inference to identify related asset conditions across the transportation network; and
query the knowledge graph to generate a context-aware recommendation for at least one of infrastructure maintenance, hazard mitigation, or capital investment prioritization.

18. One or more computer-readable media comprising instructions configured to be executed by a processor set to cause the processor set to perform operations comprising:
receiving multimodal input data associated with a transportation network environment, the multimodal input data comprising at least one of image data and light detection and ranging (LiDAR) data;
identifying, based on an artificial intelligence (AI) component and the multimodal input data, at least one attribute set associated with at least one infrastructure asset within the transportation network environment;
generating, based on the at least one attribute set, output data associated with a multi-objective infrastructure management operation; and
providing the output data for display via a graphical user interface rendered by a computing device.

19. The one or more computer-readable media of claim 18, wherein the graphical user interface comprises a conversational artificial intelligence component configured to receive a natural language query from a user and generate a responsive textual briefing.

20. The one or more computer-readable media of claim 18, the operations further comprising:
constructing a knowledge graph that encodes entities representing infrastructure assets, associated attribute sets, and derived performance metrics;
semantically linking the entities within the knowledge graph based on at least one of spatial proximity, functional connectivity, or causal relationships learned from multimodal data;
executing a graph-based reasoning operation to infer at least one of a hidden relationship, a systemic vulnerability, or a high-impact intervention target; and
outputting, via the graphical user interface, a result of the reasoning operation as at least one of a ranked recommendation or a visual network analytic.
